(19) United States
(12) Patent Application Publication
(10) Pub. No.: US 2006/0036114 A1
(43) Pub. Date: Feb. 16, 2006

(54) Organoboron luminescent compounds and methods of making and using same

(76) Inventors: Suning Wang, Kingston (CA); Wen-Li Jia, Mississauga (CA); Zheng-Hong Lu, Toronto (CA); Xiaodong Feng, Toronto (CA)

Correspondence Address: Carol Miernicki Steeg;PARTEQ Innovations, Room 1625, Biosciences Complex, Queen's University at Kingston, Kingston, ON, K7L 3N6, CA

(21) Appl. No.: 11/203,424

(22) Filed: Aug. 15, 2005

Related U.S. Application Data
(60) Provisional application No. 60/601,185, filed on Aug. 13, 2004.

(30) Foreign Application Priority Data
Aug. 16, 2004 (CA) 2,478,041

(51) Int. Cl. C07F 5/02; H05B 33/12; C09K 11/00

(52) U.S. Cl. 568/1; 564/429; 546/13; 546/113; 313/504; 313/506; 428/704; 428/917

(57) ABSTRACT

The invention provides three-coordinated organoboron compounds that are useful for photoluminescence and electroluminescence. Compounds of the invention include light emitters, preferably emitting intense blue light, electron transporters, hole transporters and hole injectors. A particularly preferred such compound is p-(1-naphthylphenylamino)-4,4′-biphenyldimesitylborane (BNPB), which demonstrates all of these properties. The invention further provides methods of synthesizing such three-coordinated boron compounds, methods of producing photoluminescence and electroluminescence, methods for charge transports, methods for hole injection, methods of applying the compounds in thin films, and uses of the compounds of the invention in luminescent probes, and electroluminescent displays.

### RELATED APPLICATIONS

This application claims the benefit of U.S. Patent Application Ser. No. 60/601,185 filed Aug. 13, 2004, the contents of which are hereby incorporated by reference.

### FIELD OF THE INVENTION

The invention relates to compounds having luminescent properties, and to methods of synthesizing and using such compounds. The invention more particularly relates to compounds having photoluminescent and/or electroluminescent (EL) properties, and to synthesis and uses of same. The invention further relates to compounds with the ability to act as hole transporters, electron transporters and/or hole injectors. The invention also relates to compounds having photo-receptor properties due to their ability to separate charges. The invention also relates to compounds having photon harvesting properties. The invention also relates to compounds that visibly display detection of metal ions, organic molecules or acid. The invention further relates to compounds that can provide a molecular switch.

### BACKGROUND OF THE INVENTION

Production of devices based on electroluminescent display is a rapidly growing, billion dollar industry. One such device is an organic light-emitting diode, or OLED. Generally speaking, an OLED is a display device that sandwiches carbon-based films between two charged electrodes, a metallic cathode and a transparent anode. A common type of OLED has a hole injection layer, a hole transport layer, an emission layer and an electron transport layer. When a potential is applied across an OLED, holes are said to be injected from the anode into the hole transporting layer (HTL) while electrons are injected from the cathode into the electron transporting layer (ETL). Materials for these charge transporting layers are chosen so that holes are preferentially transported by the HTL, and electrons are preferentially transported by the ETL. The holes and electrons migrate to an ETUHTL interface located in the emission layer, where they recombine. The energy produced by this recombination excites the emitter molecules in the emission layer and then they radiatively relax producing an EL emission that can range from blue to near-infrared (Koene et al., 1998).

Light emission from an OLED is due to emissive transitions from a neutral excited state to the ground state, which occurs when the luminescent materials are subjected to an external electric field (“electroluminescence”). Functioning OLEDs are under dynamic charge equilibrium which involves charge recombination, production of excitons and emission. Generally speaking, molecules in OLEDs are insulators with resistivity of the order 10¹⁵-10²⁰ Ω cm. Thus, the operation of OLEDs depends on charge injection and migration.

Typical OLEDs include a hole injection layer and an electron injection layer to inject the charges and to enhance the physical contact between the thin film layers and the metal or indium tin oxide (ITO) electrodes. Poor contact at the indium tin oxide surface is a particular problem in the OLED industry and can lead to formation of voids or pinholes where a film has pulled away from the surface of the electrode. Such voids impede the efficiency of the device and its thermal stability. A hole injection layer (HIL) can lengthen the lifetime of an OLED device and increase its efficiency by helping to transport holes to the anode and facilitating the binding of the hole transport layer with the ITO layer. Currently in the EL field, copper (II) phthalocyanine (CuPc) is the only effective and available material for use as a HIL in OLEDs (Mori et al., 2002, Lee et al., 2003). A serious disadvantage of CuPc is its absorption band in the red spectrum which limits its use.

Bright and efficient OLED devices and electroluminescent (EL) devices have attracted considerable interest due to their potential application for flat panel displays (e.g., television and computer monitors). OLED based displays offer advantages over traditional liquid crystal displays, such as: wide viewing angle, fast response time, lighter weight, greater durability, broader operating temperature ranges, lower power consumption, increased brightness, and lower cost. However, several challenges still must be addressed before OLEDs become truly affordable and attractive replacements for liquid crystal based displays. To realize full colour display applications, it is essential to have the three fundamental colours of red, green, and blue provided by emitters with sufficient colour purity and sufficiently high emission efficiency.

OLED devices typically comprise three layers—an electron transport layer, an emitter, and a hole transport layer (see FIG. 1A). The three layer approach facilitates charge transport and charge recombination, and enhances the overall efficiency of the device (Tsutsui 1997, Thompson et al., 1999, Rothberg et al., 1996). A commonly used strategy to enhance OLED efficiency is to dope emitters into a hosting layer to create a multi-layer device (Chen et al., 1998). Host compounds are used to stabilize the emitter compounds and prevent them from self-quenching. Some organoboron compounds have been used previously in OLEDs as non-emitting, non-charge transporting hosting layers (Matsuura et al., 2003).

Although bright and efficient OLEDs have been achieved by the doping strategy, these multi-layer devices are difficult to manufacture and may have problems with interfacial diffusion. By using strategies to reduce the number of layers and therefore minimize interfacial problems such as diffusion between the layers, long term stability of the device is enhanced. One such strategy is the use of bifunctional or multifunctional molecules in OLEDs. For example, a bifunctional molecule may be an efficient emitter that is also a charge transport material. Such bifunctional, or mutifunctional, molecules are desirable because they simplify the fabrication process, allow better control of the uniformity of the device, and minimize the problems of interfacial diffusion. Such bifunctional or multifunctional molecules allow for enhanced long-term stability of the OLED and prevent degradation of the OLED.

As illustrated in FIG. 1B, when a potential is applied across an OLED, holes are said to be injected from an anode into a hole transport layer (HTL) while electrons are injected from a cathode into an electron transport layer (ETL). Stability at both the anode and cathode interfaces is often poor in currently available devices due to lack of covalent bonds cross-linking typically hydrophobic OLED molecules and the hydrophilic inorganic electrodes. Weak non-covalent forces exist, however, which determine the thermal durability and long-term stability of such devices. During device operation, current-induced heat at these interfaces leads to delamination, interfacial diffusion, phase segregation, and ultimately failure of the device.

In providing one of the key colour components for electroluminescent display devices, blue luminescent compounds are among the most sought-after materials by industry around the world. Two alternative ways in which blue luminescence can be achieved are: (i) providing a molecule which emits blue colour (emitter), and (ii) doping an emitter such that the combination yields blue luminescence. Conveniently, the emitter can be an inorganic metal ion such as, for example, lanthanide, which emits blue light via d to f or f to f electronic transitions, or an organic molecule which has conjugated π bonds and emits blue light via π to π orπ to n electronic transitions.

A common problem with blue emitters is their lack of long term stability in OLEDs. OLEDs generally suffer from a gradual intensity decrease of the blue hue, which results in gradual deterioration of the colour purity of the display, and ultimately failure of the device. Television and computer monitors must perform consistently for at least five years in order to be commercially feasible. Even this modest expectation is a big challenge for currently available OLEDs.

There are several blue luminescent compounds known (Wang et al., U.S. Pat. No. 6,500,569, Wang et al., U.S. Pat. No. 6,312,835, Yang et al., 2001, Jia et al., 2003, Shirota, 2000, Wu et al., 2001, and Liu et al., 2000). Difficulties with some known blue emitters include: a propensity for oxidation and/or hydrolysis reactions (i.e., the compounds are not very stable in solution), poor luminescence efficiency, poor stability and poor suitability for application as a film using chemical vapor deposition (CVD) or vacuum deposition (processes known to produce superior films for electroluminescent displays). Thus, blue luminescent materials with increased stability, solubility and ability to form thin films are desirable. Also, bifunctional or multifunctional blue emitters that are capable of transporting electrons and/or holes remain rare and desirable.

Tri-coordinated boron compounds have emerged recently as promising materials for OLEDs (Noda et al., 1998, Noda et al., 1999, Shirota, 2000, Noda et al., 2000, Kinoshita et al., 2002, Doi et al., 2003, Jia et al., 2004). Some known luminescent tri-coordinated boron compounds are crystalline at ambient temperature. This property may lead to difficulty in creating a film since such compounds may form a powder or microcrystalline particles on a surface when deposited directly from solution.

Even the best blue emitters currently available do not have the long term stability desired for commercial devices. The limitations discussed above could restrict the market for OLED products, despite their many superior aspects as compared with liquid crystal displays. Therefore, in order for OLEDs to become truly commercially feasible, there is a need for stable emitters that form thin films. Moreover, there is a need for an improved hole injector, which does not have an absorption band(s) that limits its use. Preferably, an improved hole injector would be transparent across the entire visible spectrum. In addition, an improved hole injector should be stable and form thin films well.

### BRIEF STATEMENT OF THE INVENTION

In a first aspect the invention provides a compound having a general formula (1A): 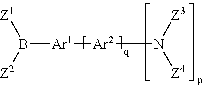
(1A)
where
p is 1, 2, 3, 4 or 5;
q is 0, 1, 2, 3, 4 or 5;
Ar¹, Ar², Z¹, Z², Z³ and Z⁴ are each independently a substituted or unsubstituted aryl moiety selected from the group consisting of phenyl, biphenyl, naphthyl, anthryl, phenanthryl, pyrenyl, pyridyl, bipyridyl, xylyl, mesityl, duryl, indolyl, thienyl, and quinolinyl such that at least three of the six ortho positions relative to the boron-aryl bonds bear a non-hydrogen substituent and such that (i) Z³ and Z⁴ are not identical or (ii) at least one of Z³ and Z⁴ is heteroaromatic;
wherein a substituent of Ar¹, Z¹ or Z² is selected from the group consisting of an aryl group, F, NR₂, a nitrile group, —CF₃, OR, and R, where R is a substituted or unsubstituted aliphatic group having 1-24 carbon atoms which may be straight, branched or cyclic; and
wherein a substituent of Z³, Z⁴ or Ar² is selected from the group consisting of an aryl group, a hydroxy group, nitro, amino, NR₂, OR, a nitrile group, —CF₃ and R, where R is a substituted or unsubstituted aliphatic group having 1-24 carbon atoms which may be straight, branched or cyclic.

In preferred embodiments of compounds of the general formula (1A), Z¹ and Z² are xylyl, mesityl or duryl, and Z³ and Z⁴ are different from each other. In still more preferred embodiments, both Z¹ and Z² are mesityl. In further preferred embodiments, Z³ is an aryl group containing a different number of conjugated aromatic rings than the number of conjugated aromatic rings of Z⁴.

In a particularly preferred embodiment, the invention provides p-(1-naphthylphenylamino)-4,4′-biphenyldimesitylborane (BNPB). In another preferred embodiment, the invention provides BNPB, an organic polymer and a solvent. In a further preferred embodiment, the invention provides an element for an electroluminescent device which contains the BNPB.

In a second aspect the invention provides a compound having a general formula (1B): 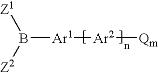
(1B)
where
n is 0, 1, 2, 3, 4 or 5;
m is 1, 2, 3, 4 or 5;
Ar¹, Ar², Z¹ and Z² are each independently a substituted or unsubstituted aryl moiety selected from the group consisting of phenyl, biphenyl, naphthyl, anthryl, phenanthryl, pyrenyl, pyridyl, bipyridyl, xylyl, mesityl, duryl, indolyl, thienyl, and quinolinyl such that at least three of the six ortho positions relative to the the boron-aryl bonds bear a non-hydrogen substituent;
Q is a substituted or unsubstituted heteroaryl moiety selected from the group consisting of pyridyl, quinolinyl, indolyl, 7-azaindolyl (“azain”) and benzimidazolyl such that Q does not have a two-fold axis of symmetry along the Q-Ar¹ bond and the atom of Q that is bonded to Ar² is a heteroatom;
wherein a substituent of Ar¹, Z¹ or Z² is selected from the group consisting of an aryl group, F, NR₂, a nitrile group, —CF₃, OR, and R, where R is a substituted or unsubstituted aliphatic group having 1-24 carbon atoms which may be straight, branched or cyclic; and
wherein a substituent of Q is selected from the group consisting of an aryl group, a hydroxy group, nitro, halo, amino, NR₂, OR, a nitrile group, —CF₃ and R, where R is a substituted or unsubstituted aliphatic group having 1-24 carbon atoms which may be straight, branched or cyclic.

In a third aspect, the invention provides a compound having a general formula (1C): 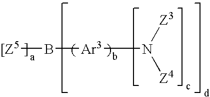
(1C)
where
a is 0, 1 or 2;
b is 1, 2, 3, 4, 5 or 6;
c is 1, 2, 3, 4 or 5;
d is 1, 2 or 3;
wherein the sum of a plus d equals three;
wherein when a is 0, Z³ does not equal Z⁴;
Ar¹, Z³, Z⁴ and Z¹ are each independently a substituted or unsubstituted aryl moiety selected from the group consisting of phenyl, biphenyl, naphthyl, anthryl, phenanthryl, pyrenyl, pyridyl, bipyridyl, xylyl, mesityl, duryl, indolyl, thienyl, and quinolinyl such that at least three of the six ortho positions relative to the boron-aryl bonds bear a non-hydrogen substituent and such that (i) Z³ and Z⁴ are not identical or (ii) at least one of Z³ and Z⁴ is heteroaromatic;
wherein a substituent of Ar³ or Z⁵ is selected from the group consisting of an aryl group, F, NR₂, a nitrile group, —CF₃, OR, and R, where R is a substituted or unsubstituted aliphatic group having 1-24 carbon atoms which may be straight, branched or cyclic; and
wherein a substituent of Z³ or Z⁴ is selected from the group consisting of an aryl group, a hydroxy group, nitro, halo, amino, NR₂, OR, a nitrile group, —CF₃ and R, where R is a substituted or unsubstituted aliphatic group having 1-24 carbon atoms which may be straight, branched or cyclic.

In a fourth aspect, the invention provides a compound having a general formula (1D): 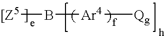
(1D)
where
e is 0, 1 or 2;
f is 1, 2, 3, 4, 5 or 6;
g is 1, 2, 3, 4 or 5;
h is 1, 2 or 3;
Ar⁴ and Z⁵ are each independently a substituted or unsubstituted aryl moiety selected from the group consisting of phenyl, biphenyl, naphthyl, anthryl, phenanthryl, pyrenyl, pyridyl, bipyridyl, xylyl, mesityl, duryl, indolyl, thienyl, and quinolinyl such that at least three of the six ortho positions relative to the boron-aryl bonds bear a non-hydrogen substituent; and
Q is a substituted or unsubstituted heteroaryl moiety selected from the group consisting of pyridyl, quinolinyl, indolyl, 7-azaindolyl and benzimidazolyl such that Q does not have a two-fold axis of symmetry along the Q-Ar⁴ bond and the atom of Q that is bonded to Ar⁴ is a heteroatom;
wherein the sum of e and h equals three;
wherein a substituent of Ar⁴ or Z⁵ is selected from the group consisting of an aryl group, F, NR₂, a nitrile group, —CF₃, OR, and R, where R is a substituted or unsubstituted aliphatic group having 1-24 carbon atoms which may be straight, branched or cyclic; and
wherein a substituent of Q is selected from the group consisting of an aryl group, a hydroxy group, nitro, halo, amino, NR₂, OR, a nitrile group, —CF₃ and R, where R is a substituted or unsubstituted aliphatic group having 1-24 carbon atoms which may be straight, branched or cyclic.

In a fifth aspect, the invention provides a compound having a general formula (1E): 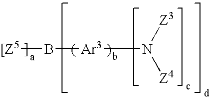
(1E)
where
a is 0, 1 or 2;
b is 1, 2, 3, 4, 5 or 6;
c is 1, 2, 3, 4 or 5;
d is 1, 2 or 3;
wherein the sum of a plus d equals three;
Ar³, Z³, Z⁴ and Z⁵ are each independently a substituted or unsubstituted aryl moiety selected from the group consisting of phenyl, biphenyl, naphthyl, anthryl, phenanthryl, pyrenyl, xylyl, mesityl, duryl, indolyl, thienyl, and quinolinyl such that at least three of the six ortho positions relative to the boron-aryl bonds bear a non-hydrogen substituent and such that in at least one instance (i) Z³ and Z⁴ are not identical or (ii) at least one of Z³ and Z⁴ is heteroaromatic;
wherein a substituent of Ar³ or Z⁵ is selected from the group consisting of an aryl group, F, NR₂, a nitrile group, —CF₃, OR, and R, where R is a substituted or unsubstituted aliphatic group having 1-24 carbon atoms which may be straight, branched or cyclic; and
wherein a substituent of Z³ or Z⁴ is selected from the group consisting of an aryl group, a hydroxy group, nitro, halo, amino, NR₂, OR, a nitrile group, —CF₃ and R, where R is a substituted or unsubstituted aliphatic group having 1-24 carbon atoms which may be straight, branched or cyclic.

Compounds according to the invention may be photoluminescent or electroluminescent or both. They may act as emitters (preferably emitting blue light), charge (electron or hole) transporters, or electron or hole injectors. Preferred compounds are emitters and charge transporters. Particularly preferred compounds are emitters, charge transporters and charge (preferably hole) injectors. Uses of such compounds as emitters, and/or as electron or hole transporters, and/or as electron or hole injectors are also provided by further aspects of the invention. Methods of producing electroluminescence, transporting electrons, transporting holes, injecting electrons and injecting holes which employ a compound of the invention are also provided by still further aspects of the invention.

According to yet another aspect of the invention, electroluminescent devices employing compounds of the invention as emitters, and/or as electron or hole transporters, and/or as electron or hole injectors are also provided. In some embodiments, the devices are flat panel display devices. In other embodiments the devices are luminescent probes. Preferably, an electroluminescent device comprising a compound of the invention is an OLED. Three layer, two layer and one layer devices, as described hereinbelow are provided by the invention. According to a preferred embodiment, the compound of the invention employed in the electroluminescent device or OLED is BNPB or an equivalent thereof.

In other aspects, the invention provides a compound having a formula selected from the group consisting of p-(2,2′-dipyridylamino)phenyldimesitylborane (101); p-(2,2′-dipyridylamino)biphenyldimesitylborane (102); p-(7-azaindolyl)phenyldimesitylborane (103); p (7-azaindolyl)biphenyldimesitylborane (104); 3,5-bis(2,2′-dipyridylamino)phenyldimesitylborane (105); 3,5-bis(7-azaindolyl)phenyldimesitylborane (106); p-[3,5-bis(2,2′-dipyridylamino)phenyl]phenyldimesitylborane (107); 5-[p-(2,2′-dipyridylamino)phenyl]-2-thienyldimesitylborane (108); 4-(1-naphthylphenylamino)-4′-biphenylduryldimesitylborane (201); Tris[p-(1-naphthylphenylamino)phenylduryl]borane (202); and Tris[p-(1-naphthylphenylamino)biphenylduryl]borane (203).

In further aspects, the invention provides compositions comprising compounds of the invention.

In another aspect, the invention provides a method of synthesizing BNPB, comprising a step selected from the group consisting of:
4,4′-diodobiphenyl+1-naphtylphenylamine→4-Iodo-4′-(1-naphthylphenylamino)biphenyl 4-Iodo-4′-(1-naphthylphenylamino)biphenyl+n-BuLi+dimesitylboron fluoride→BNPB

In other aspects, the invention provides methods of harvesting photons employing a compound of the invention. Charges separated according to such methods may recombine to provide light, or may recombine to produce a potential difference.

In other aspects, the invention provides methods of separating charges employing a compound of the invention. Charges separated according to such methods may recombine to provide light, or may recombine to produce a potential difference.

In further aspects, the invention respectively provides photocopiers, photovoltaic devices, photoreceptors, solar cells, semiconductors, and molecular switches employing a said method of harvesting photons or separating charges.

In other aspects, the invention respectively provides methods of detecting metal ions or organic molecules employing a compound of the invention.

In another aspect, the invention provides novel intermediates as described in the syntheses set forth herein.

### BRIEF DESCRIPTION OF THE DRAWINGS

In some of the figures described below, there are two curves presented on a single FIGURE. In such cases, an arrow indicates the y-axis to which each curve belongs. For a better understanding of the present invention and to show more dearly how it may be carried into effect, reference will now be made by way of example to the accompanying drawings, which illustrate aspects and features according to preferred embodiments of the present invention, and in which:

FIG. 1A shows a preferred embodiment of a three layer electroluminescent (EL) display device according to the invention.

FIG. 1B shows the functional layers of a multi layer electroluminescent (EL) display device including the ITO anode, hole injection layer (HIL), hole transport layer (HTL), the emitting layer (EML), the electron transport layer (ETL), the electron injection layer (EIL) and the cathode.

FIG. 2 is a synthetic scheme (Scheme 1) which shows the synthesis of BNPB.

FIG. 3A is a cyclic voltametry diagram showing the oxidation of BNPB in CH₂Cl₂. This figure provides information about the Highest Occupied Molecular Orbital (HOMO) of the molecule and indicates promising hole transport properties of the molecule.

FIG. 3B is a cyclic voltametry diagram showing the reduction of BNPB in THF. This figure provides information about the Lowest Unoccupied Molecular Orbital (LUMO) of the molecule and indicates promising electron transport properties of the molecule.

FIG. 4 shows the emission spectrum of BNPB in the solvents hexane (C₆H₁₄), toluene (Tol.), tetrahydrofuran (THF), dichloromethane (DCM) and acetonitrile (CH₃CN) at a concentration of 10⁻⁵ M.

FIG. 5 shows the energy levels and the role of BNPB in EL devices A, B, C and D.

FIG. 6 shows the (−) photoluminescence (PL) spectrum of BNPB and the (−) electroluminescence spectrum of BNPB in device A, a one layer EL device of the following configuration: ITO/BNPB (90 nm)/LiF (0.5 nm)/Al and B, a two layer device of the following configuration: ITO/NPB (60 nm)/BNPB (90 nm)/Ag (the spectra are essentially identical).

FIG. 7 shows the dependence of Current Density (J) and Luminance (L) on Voltage (V) of a film of BNPB in device A, a one layer EL device of the following configuration: ITO/BNPB (90 nm)/LiF (0.5 nm)/Al, where BNPB is the hole transport layer, the emitter and the electron transport layer and LiF was added to improve contact between the electron transport layer and the cathode.

FIG. 8 shows the dependence of Current Density (J) and Luminance (L) on Voltage (V) of a film of BNPB in device B, a two layer EL device of the following configuration: ITO/NPB (60 nm)/BNPB (90 nm)/Ag, where NPB is the hole transport layer and perhaps an electron blocking layer, and BNPB is the emitter and the electron transport layer.

FIG. 9 shows the dependence of Current Density (J) and Luminance (L) on Voltage (V) of a film of BNPB in device C, a two layer EL device of the following configuration: ITO/BNPB (60 nm)/Alq₃ (45 nm)/LiF (0.5 nm)/Al, where BNPB is the hole transport layer, Alq₃ is the emitter and electron transport layer and LiF was added to improve contact between the electron transport layer and the cathode.

FIG. 10 shows the dependence of Current Density (J) and Luminance (L) on Voltage (V) of a film of BNPB in device D, a three layer EL device of the following configuration: ITO/NPB (60 nm)/BNPB (60 nm)/Alq₃ (45 nm)/LiF (0.5 nm)/Al, where NPB is the hole transport layer, BNPB is the emitter, Alq₃ is the electron transport layer and LiF was added to improve contact between the electron transport layer and the cathode.

FIG. 11 shows an electroluminescence spectrum produced by devices B ( . . . ), a two layer EL device of the following configuration: ITO/NPB (60 nm)/BNPB (90 nm)/Ag, C ( - - - ), a two layer EL device of the following configuration: ITO/BNPB (60 nm)/Alq₃ (45 nm)/LiF (0.5 nm)/Al, and D (−), a three layer EL device of the following configuration: ITO/NPB (60 nm)/BNPB (60 nm)Alq₃ (45 nm)/LiF (0.5 nm)/Al.

FIG. 12 shows three synthetic schemes (Scheme 2-4) which show the synthesis of compounds 101-107.

FIG. 13 shows a synthetic scheme (Scheme 5) which shows the synthesis of compound 108.

FIG. 14 shows the crystal structure of compound 101.

FIG. 15 shows the crystal structure of compound 103.

FIG. 16A shows the crystal structure of compound 105.

FIG. 16B shows a side view of the crystal structure of compound 105.

FIG. 17 shows the crystal structure of compound 106.

FIG. 18 shows the crystal structure of compound 107.

FIG. 19 shows the absorption (lower wavelength) and emission (higher wavelength) photoluminescence spectra of compound 102 in tetrahydrofuran (THF) and dimethylformamide (DMF).

FIG. 20A shows the crystal structure of compound 110.

FIG. 20B shows the crystal structure of a unit cell of compound 110 with solvent channels in the crystal lattice.

FIG. 20C shows the crystal structure of compound 111.

FIG. 20D shows the crystal structure of a unit cell of compound 111 with solvent channels in the crystal lattice.

FIG. 20E shows the structure of compound 110 and compound 111.

FIG. 21 shows the (−) photoluminescence (PL) spectrum of compound 102 and the electroluminescence spectrum of devices:
1 (▴): ITO/NPB (40 nm)/102 (40 nm)/LiF (2 nm)/Al where NPB functions as a hole transport layer;
2 (●): ITO/NPB (40 nm)/bicarbazole (20 nm)/102 (40 nm)/LiF (1 nm)/Al where bicarbazole was inserted between the NPB layer and compound 102 to act as a hole blocking layer (Liu, S. F. et al., 2000); and
3 (□): ITO/NPB (40 nm)/bicarbazole (20 nm)/102 (40 nm)/PBD (20 nm)/LiF (1 nm)/Al where bicarbazole was a hole blocking layer and PBD was an electron transport layer.

FIG. 22 shows the dependence of current (I) on Voltage (V) of devices:
1 (▴): ITO/NPB (40 nm)/102 (40 nm)/LiF (2 nm)/Al where NPB functions as a hole transport layer;
2 (●): ITO/NPB (40 nm)/bicarbazole (20 nm)/102 (40 nm)/LiF (1 nm)/Al where bicarbazole was inserted between the NPB layer and compound 102 to act as a hole blocking layer (Liu, S. F. et al., 2000); and
3 (□): ITO/NPB (40 nm)/bicarbazole (20 nm)/102 (40 nm)/PBD (20 nm)/LiF (1 nm)/Al where bicarbazole was a hole blocking layer and PBD was an electron transport layer.

FIG. 23 shows the dependence of Luminance (L) on Voltage (V) of devices:
1 (▴): ITO/NPB (40 nm)/102 (40 nm)/LiF (2 nm)/Al where NPB functions as a hole transport layer;
2 (●): ITO/NPB (40 nm)/bicarbazole (20 nm)/102 (40 nm)/LiF (1 nm)/Al where bicarbazole was inserted between the NPB layer and compound 102 to act as a hole blocking layer (Liu, S. F. et al., 2000); and
3 (□): ITO/NPB (40 nm)/bicarbazole (20 nm)/102 (40 nm)/PBD (20 nm)/LiF (1 nm)/Al where bicarbazole was a hole blocking layer and PBD was an electron transport layer.

FIG. 24 shows the (−) photoluminescence (PL) spectrum of compound 108 and the electroluminescence spectrum of device 4: ITO/NPB (40 nm)/bicarbazole (20 nm)/108 (40 nm)/LiF (1 nm)/Al.

FIG. 25 shows the dependence of current (I) on Voltage (V) of device 4: ITO/NPB (40 nm)/bicarbazole (20 nm)/108 (40 nm)/LiF (1 nm)/Al.

FIG. 26 shows the dependence of luminance (L) on Voltage (V) of device 4: ITO/NPB (40 nm)/bicarbazole (20 nm)/108 (40 nm)/LiF (1 nm)/Al.

FIG. 27 shows the change in the emission spectrum of compound 102 in THF in the presence of various amounts of Zn(O₂CCF₃)₂.

FIG. 28 shows the dependence of Luminance (Cd/m²) on Voltage (V) of two-layer device E of the following configuration: ITO/BNPB (20 nm)/NPB(45 nm)/Alq₃(50 nm)/LiF(1.5 nm)/Al (BNPB, □). Also shown is the dependence of Luminance (Cd/m²) on Voltage (V) of a device of the following configuration: ITO/CuPc (20 nm)/NPB (45 nm)/Alq₃ (50 nm)/LiF (1.5 nm)/Al (CuPc, ▪). This figure provides a comparison of the hole injector properties of BNPB to the current industry standard, CuPc.

FIG. 29 shows the dependence of Current efficiency (Cd/A) on Luminance (Cd/m²) of two-layer device E of the following configuration: ITO/BNPB (20 nm)/NPB(45 nm)/Alq₃(50 nm)/LiF(1.5 nm)/Al (BNPB, 0). Also shown is the dependence of Current efficiency (Cd/A) on Luminance (Cd/m²) of a device of the following configuration: ITO/CuPc (20 nm)/NPB (45 nm)/Alq₃ (50 nm)/LiF (1.5 nm)/Al (CuPc, ▪). This figure also provides a comparison of the hole injector properties of BNPB to the current industry standard, CuPc.

FIG. 30 shows two synthetic schemes (Schemes 6A and 6B) which show the synthesis of compounds 201 and 203, respectively.

FIG. 31 shows a synthetic scheme (Scheme 7) which shows the synthesis of compound 202.

FIG. 32 shows the emission spectra of compound 201 in the solvents toluene, THF, dichloromethane (CH₂Cl₂) and acetonitrile (MeCN) at a concentration of 10⁻⁵ M.

FIG. 33 shows the dependence of Luminance on Voltage of films of compounds 201-203 and NPB in devices L, M, N, and P, respectively, with the device structure for devices L, M, and N of ITO/boron compound (60 nm)/AJq₃ (40 nm)/LiF (1 nm)/Al (120 nm) and for device P of ITO/NPB (60 nm)/Alq₃ (40 nm)/LiF (1 nm)/Al (120 nm), where the boron compound or NPB is the hole transport layer and Alq₃ is the emitter and electron transport layer and LiF was added to improve contact between the electron transport layer and the cathode.

FIG. 34 shows the dependence of Current efficiency on Luminance of films of compounds 201-203 and NPB in devices L, M, N, and P, respectively, with the device structure for devices L, M, and N of ITO/boron compound (60 nm)/Alq₃ (40 nm)/LiF (1 nm)/Al (120 nm) and for device P of ITO/NPB (60 nm)/Alq₃ (40 nm)/LiF (1 nm)/Al (120 nm), where the boron compound or NPB is the hole transport layer and Alq₃ is the emitter and electron transport layer and LiF was added to improve contact between the electron transport layer and the cathode.

FIG. 35 shows the dependence of Luminance on Voltage of films of compounds 202, 203, and CuPc in devices Q, R, and S, respectively, with the device structure for devices Q and R of ITO/boron compound (25 nm)/NPB (45 nm)/Alq₃ (40 nm)/LiF (1 nm)/Al (150 nm) and for device S of ITO/CuPc (25 nm)/NPB (45 nm)/Alq₃ (40 nm)/LiF (1 nm)/Al (150 nm), where the boron compound or CuPc is the hole injection layer.

FIG. 36 shows the dependence of Current efficiency on Luminance of films of one of compounds 202, 203, and CuPc in devices Q, R, and S, respectively, with the device structure for devices Q and R of ITO/boron compound (25 nm)/NPB (45 nm)/Alq₃ (40 nm)/LiF (1 nm)/Al (150 nm) and for device S of ITO/CuPc (25 nm)/NPB (45 nm)/Alq₃ (40 nm)/LiF (1 nm)/Al (150 nm), where the boron compound or CuPc is the hole injection layer.

### DETAILED DESCRIPTION OF THE INVENTION

In a first aspect, the invention provides a compound having a general formula (1A): 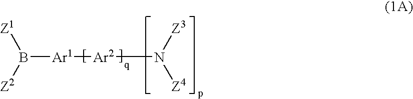
where
p is 1, 2, 3, 4 or 5;
q is 0, 1, 2, 3, 4 or 5;
Ar¹, Ar², Z¹, Z², Z³ and Z⁴ are each independently a substituted or unsubstituted aryl moiety selected from the group consisting of phenyl, biphenyl, naphthyl, anthryl, phenanthryl, pyrenyl, pyridyl, bipyridyl, xylyl, mesityl, duryl, indolyl, thienyl, and quinolinyl (preferred aryl moieties 1a to 10 are pictured below);
wherein a substituent of Ar¹, Z¹ or Z² is selected from the group consisting of an aryl group, F, NR₂, a nitrile group, —CF₃, OR, and R, where R is a substituted or unsubstituted aliphatic group having 1-24 carbon atoms which may be straight, branched or cyclic; and
wherein a substituent of Z³, Z⁴ or Ar² is selected from the group consisting of an aryl group, a hydroxy group, nitro, halo, amino, NR₂, OR, a nitrile group, —CF₃ and R, where R is a substituted or unsubstituted aliphatic group having 1-24 carbon atoms which may be straight, branched or cyclic.

Preferably a compound of general formula (1A) exhibits intense luminescence, which may be photoluminescence and/or electroluminescence.

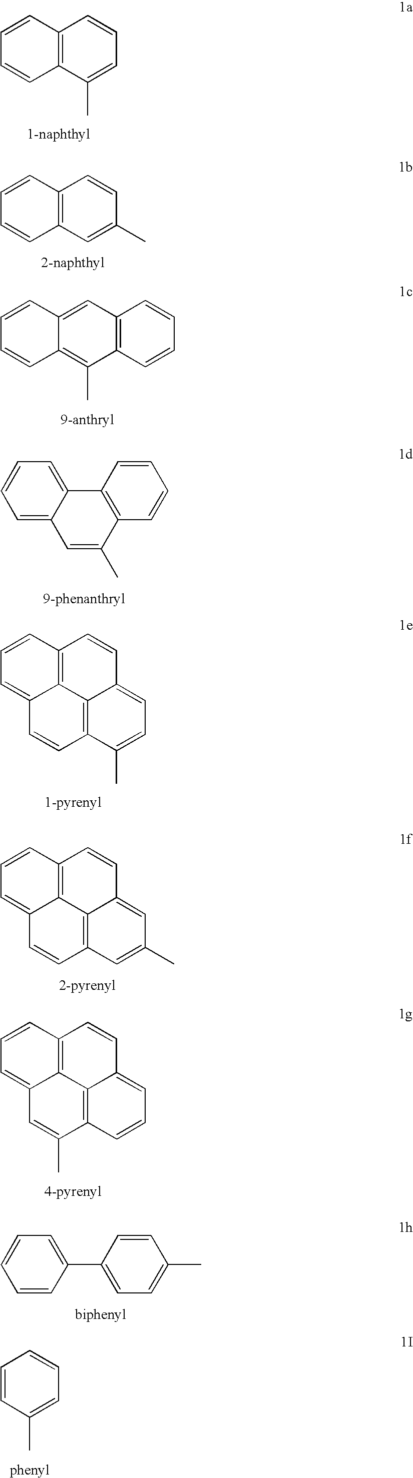

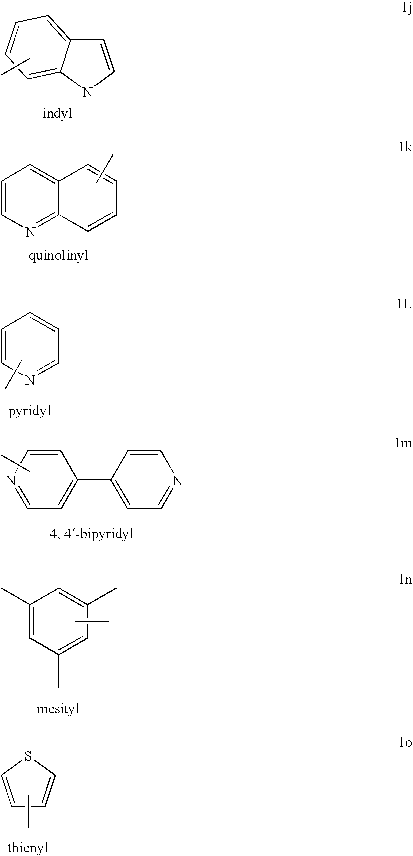

Compounds of the general formula (1A) have three aryl moieties bonded to the boron, namely, Z¹, Z², and Ar¹. In each case, a compound of the general formula (1A) has six atoms that are located two bonds away from the boron. Substituents of these six atoms are termed “ortho” substituents; one skilled in the art will recognize that a substituent which is bonded to an atom that is two atoms away from the boron of general formula (1A), and thus is located three bonds away from the boron, is in the ortho position relative to the boron-carbon (or boron-heteroatom) bond.

Preferred embodiments of compounds of the general formula (1A) have at least three non-hydrogen substituents in the six ortho positions relative to the boron-carbon (or boron-heteroatom) bonds. Certain preferred embodiments of compounds of the general formula (1A) have three of the six ortho positions substituted with non-hydrogen substituents. More preferred embodiments have four of the six ortho positions substituted with non-hydrogen substituents. Still other embodiments have five of the six ortho positions substituted with non-hydrogen substituents. Other embodiments have six of these six atoms substituted with non-hydrogen substituents. In some preferred embodiments, Z¹ and Z² are xylyl, mesityl (shown above as 1n) or duryl. In more preferred embodiments, both Z¹ and Z² are mesityl.

Mesityl is a phenyl ring with three methyl groups attached. The first methyl group is located at the 4-position relative to the ring carbon that is bonded to the boron and is known as the methyl in the para position or the para methyl. The second and third methyl groups are located at the 2- and 6-positions relative to the ring carbon that is bonded to the boron and are known as the methyls in the ortho position or the ortho methyls, as discussed above. The ortho methyls, which are located three bonds away from the boron, act as protecting groups since their location and size make them suitable as blocking groups that hinder the boron from being attacked at its unoccupied fourth coordination site.

Since boron is stable when it has four bonds in a tetrahedral geometry, tri-coordinated boron compounds are susceptible to attack at the unoccupied fourth coordination site of the boron by an electron-donating group such as, for example, an oxygen of a water molecule. Such attack would quench luminescence (and potentially adversely affect other properties) and lead to decomposition of the molecule. It is believed that when the boron is protected from attack by at least three ortho substituents the compound is more stable. These substituents would sterically block the boron's fourth coordination site, making such compounds less susceptible to attack. For example, compound BNPB has a boron that is surrounded by four methyl groups, two on each of Z¹ and Z². Methyl groups are particularly preferred as substituents on the aryl groups bonded to the boron; however, other substituents that may also be suitable for sterically blocking the boron from attack include: aryl, F, NR₂, nitrile, CF₃, OR, and R, where R is an aliphatic group having 1-24 carbon atoms which may be straight, branched or cyclic.

In certain preferred embodiments of compounds of the general formula (1A), Z³ and Z⁴ are different from each other. In other preferred embodiments, at least one of Z³ and Z⁴ is heteroaromatic. In further embodiments, Z³ and Z⁴ are different from each other and at least one of Z³ and Z⁴ is heteroaromatic. As discussed above, some known luminescent tri-coordinated boron compounds are crystalline at ambient temperature. Such compounds do not readily form films on an electrode since such compounds may form a powder or microcrystalline particles on a surface when deposited either directly from solution or in the vapour phase. When Z³ and Z⁴ are not identical, compounds of the general formula (1A) are preferred since they may more readily form films when deposited directly from solution. In certain preferred embodiments, Z³ is an aryl group containing a different number of conjugated aromatic rings than the number of conjugated aromatic rings of Z⁴. A particularly preferred embodiment is p (1-naphthylphenylamino)-4,4′-biphenyldimesitylborane (BNPB), wherein both Z¹ and Z² are mesityl, Z³ is phenyl and Z⁴ is naphthyl.

Not wishing to be bound by theory, but in order to further clarify the preferred structures, the inventors suggest that when a substituent acting as a blocking group is small, its preferred position is within four bonds of the boron. Further, substituents on the aryl groups that protect boron by blocking attack of electron-donating moieties are also preferred for compounds of the general formulas (1B) to (1E) set forth below.

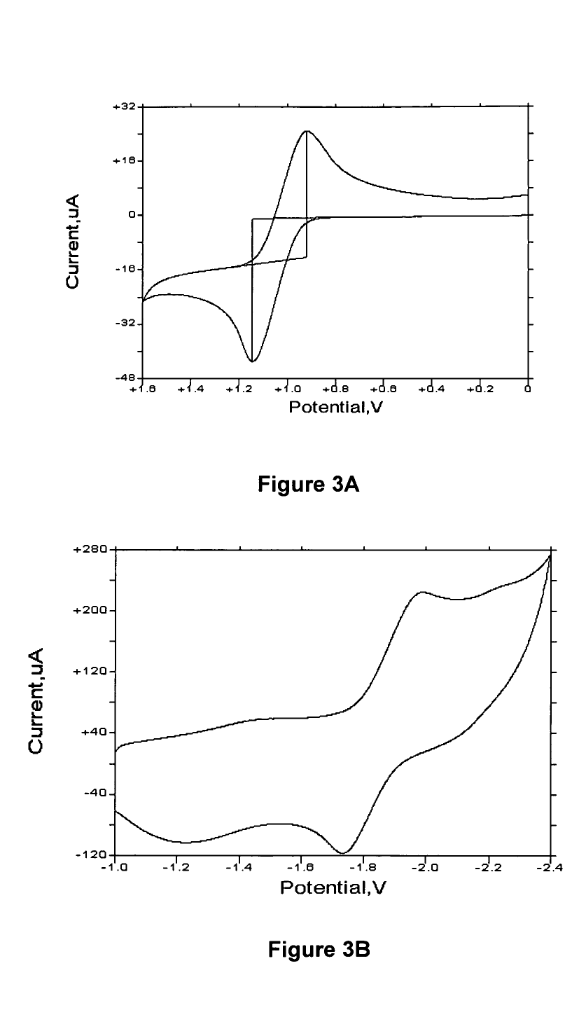

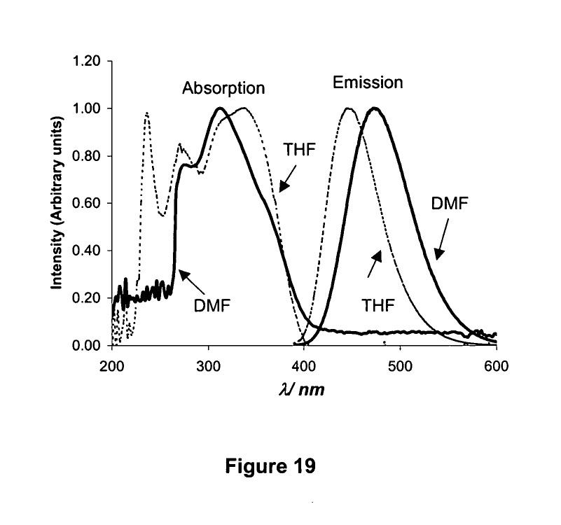

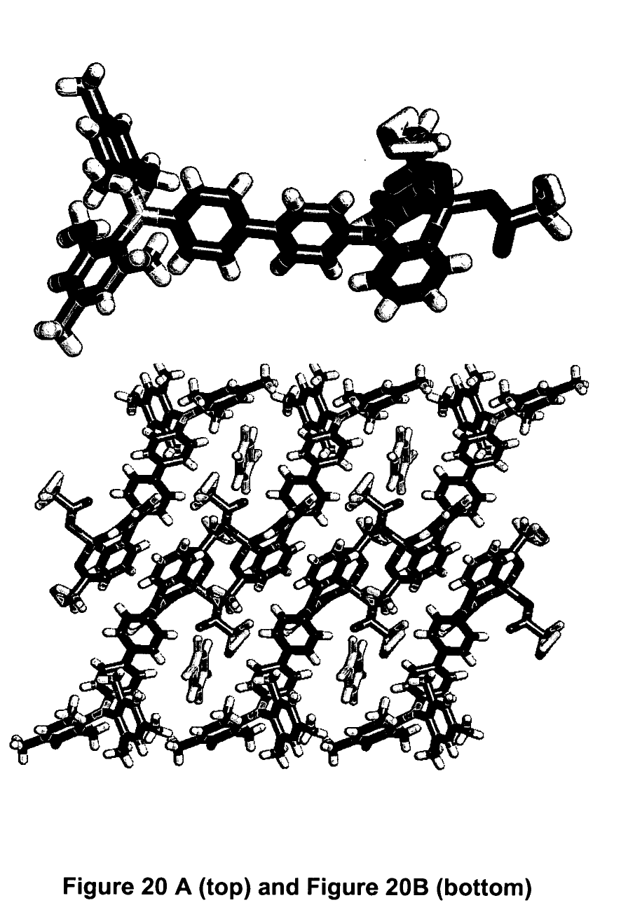

A synthetic scheme depicting the preparation of p-(1-naphthylphenylamino)-4,4′-biphenyldimesitylborane (BNPB), is pictured in FIG. 2, Scheme 1. A working example of a detailed synthetic procedure for the synthesis of BNPB is presented in Example 1. Synthetic schemes depicting the preparation of compounds 101, 102, 105, 107, 108, and 201, compounds which are also of the general formula 1A, are pictured in FIGS. 12, 13, and 30. Working examples of detailed synthetic procedures for the synthesis of compounds 101, 102, 105, 107, 108, and 201 are provided in Examples 4, 5, 8, 9, 10, and 15, respectively.

In another aspect of the invention, a stable organic compound of the general formula (1B) is provided: 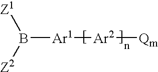
(1B)
where
n is 0, 1, 2, 3, 4 or 5;
m is 1, 2, 3, 4 or 5;
Ar¹, Ar², Z¹ and Z² are each independently a substituted or unsubstituted aryl moiety selected from the group consisting of phenyl, biphenyl, naphthyl, anthryl, phenanthryl, pyrenyl, pyridyl, bipyridyl, xylyl, mesityl, duryl, indolyl, thienyl, and quinolinyl (preferred aryl moieties 1a to 1o are pictured above);
Q is a substituted or unsubstituted heteroaryl moiety, for example, pyridyl, quinolinyl, indolyl, 7-azaindolyl (“azain”) and benzimidazolyl (preferred Q groups 2a to 2d are pictured below);
wherein a substituent of Ar¹, Z¹ or Z² is selected from the group consisting of an aryl group, F, NR², a nitrile group, —CF₃, OR, and R, where R is a substituted or unsubstituted aliphatic group having 1-24 carbon atoms which may be straight, branched or cyclic; and
wherein a substituent of Q is selected from the group consisting of an aryl group, a hydroxy group, nitro, halo, amino, NR₂, OR, a nitrile group, —CF₃ and R, where R is a substituted or unsubstituted aliphatic group having 1-24 carbon atoms which may be straight, branched or cyclic.

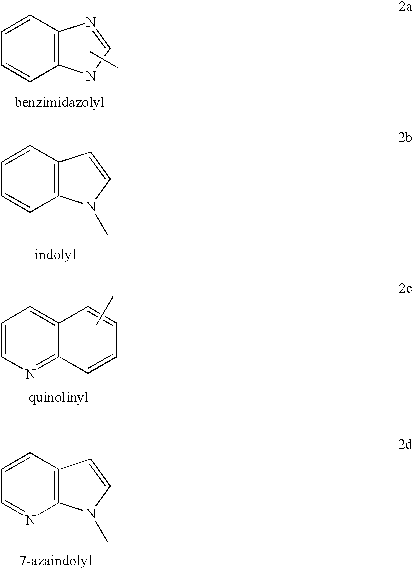

Preferably a compound of general formula (1B) exhibits intense luminescence, which may be photoluminescence and/or electroluminescence.

In preferred embodiments of compounds of the general formula (1B), at least three of the six ortho positions relative to the boron-carbon (or boron-heteroatom) bond are substituted with a non-hydrogen substituent. In certain preferred embodiments, three of the six ortho substituents are non-hydrogen. In other preferred embodiments, four of the six ortho substituents are non-hydrogen. In other preferred embodiments, five of the six ortho substituents are non-hydrogen. In other preferred embodiments, six of the six ortho substituents are non-hydrogen. In a particularly preferred embodiment, Ar¹ and Ar² are phenyl, and Z¹ and Z² are mesityl.

In other preferred embodiments of compounds of the general formula (1B), a heteroatom of Q may be, for example, N, S or O. In particularly preferred embodiments, the heteroatom is N. In preferred embodiments of compounds of the general formula (1B), the heteroatom of the Q ring is the atom through which the boron portion of the molecule is connected to Q. If we examine the bond between Ar² and the heteroatom of Q, most preferred embodiments of compounds of the general formula (1B) do not have a C₂ axis of symmetry lying along the Ar²-Q bond.

A C₂ axis of symmetry is also known as a two-fold rotational axis because if its 180° rotation is performed twice, all of the atoms return to their initial positions. A test for whether Q has a C₂ axis of symmetry is to place an imaginary axis along the Ar²-Q bond and rotate Q 180°. If all of the atoms of Q are indistinguishable from the those of the pre-rotated position, there is a two-fold axis of symmetry (Huheey, 1978).

Synthetic schemes depicting the preparation of compounds 103, 104 and 106, which are compounds of the general formula (1B) are pictured in FIG. 12. Working examples of detailed synthetic procedures for these compounds are provided in Examples 6, 7 and 8, respectively.

In another aspect of the invention, a stable organic compound of the general formula (1C) is provided: 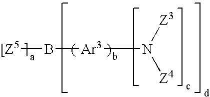
(1C)
where
a is 0, 1 or 2;
b is 1, 2, 3, 4, 5 or 6;
c is 1, 2, 3, 4 or 5;
d is 1, 2 or 3;
wherein the sum of a plus d equals three;
wherein when a is 0, Z³ does not equal Z⁴;
Ar³, Z³, Z⁴ and Z⁵ are each independently a substituted or unsubstituted aryl moiety selected from the group consisting of phenyl, biphenyl, naphthyl, anthryl, phenanthryl, pyrenyl, pyridyl, bipyridyl, xylyl, mesityl, duryl, indolyl, thienyl, and quinolinyl (preferred aryl moieties 1a to 1o are pictured above);
wherein a substituent of Ar³ or Z⁵ is selected from the group consisting of an aryl group, F, NR₂, a nitrile group, —CF₃, OR, and R, where R is a substituted or unsubstituted aliphatic group having 1-24 carbon atoms which may be straight, branched or cyclic; and
wherein a substituent of Z³ or Z⁴ is selected from the group consisting of an aryl group, a hydroxy group, nitro, halo, amino, NR₂, OR, a nitrile group, —CF₃ and R, where R is a substituted or unsubstituted aliphatic group having 1-24 carbon atoms which may be straight, branched or cyclic.

Preferably a compound of general formula (1C) exhibits intense luminescence, which may be photoluminescence and/or electroluminescence.

In preferred embodiments of compounds of the general formula (1C), Z³ and Z⁴ are different from each other. In other preferred embodiments, at least one of Z³ and Z⁴ is heteroaromatic. In further embodiments, Z³ and Z⁴ are different from each other and at least one of Z³ and Z⁴ is heteroaromatic.

Preferred embodiments of compounds of the general formula (1C) have at least three non-hydrogen substituents in the six ortho positions relative to the boron-carbon (or boron-heteroatom) bonds. Certain preferred embodiments of compounds of the general formula (1C) have three non-hydrogen substituents in the six ortho positions relative to the boron-carbon (or boron-heteroatom) bonds. More preferred embodiments have four of the six ortho positions substituted with non-hydrogen substituents. Still other embodiments have five of the six ortho positions substituted with non-hydrogen substituents. Other embodiments have six of the six ortho positions substituted with non-hydrogen substituents. Most preferred embodiments of compounds of the general formula (1C) have at least three non-hydrogen substituents in the six ortho positions, and (i) Z³ and Z⁴ are not identical or (ii) at least one of Z³ and Z⁴ is heteroaromatic.

Synthetic schemes for the preparation of compounds 202 and 203, which are compounds of the general formula (1C), are depicted in FIGS. 31 and 30, respectively. Working examples of detailed synthetic procedures for these compounds are provided in Examples 15.

In another aspect of the invention, a stable organic compound of the general formula (1D) is provided: 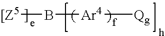
(1D)
where
e is 0, 1 or 2;
f is 1, 2, 3, 4, 5 or 6;
g is 1, 2, 3, 4 or 5;
h is 1, 2 or 3;
Ar⁴ and Zs are each independently a substituted or unsubstituted aryl moiety selected from the group consisting of phenyl, biphenyl, naphthyl, anthryl, phenanthryl, pyrenyl, pyridyl, bipyridyl, xylyl, mesityl, duryl, indolyl, thienyl, and quinolinyl (preferred aryl moieties 1a to 1o are pictured above);
Q is a substituted or unsubstituted heteroaryl moiety, for example, pyridyl, quinolinyl, indolyl, 7-azaindolyl and benzimidazolyl (preferred Q groups 2a to 2d are pictured above);
wherein the sum of e plus h equals three;
wherein a substituent of Ar¹ or Z⁵ is selected from the group consisting of an aryl group, F, NR₂, a nitrile group, —CF₃, OR, and R, where R is a substituted or unsubstituted aliphatic group having 1-24 carbon atoms which may be straight, branched or cyclic; and
wherein a substituent of Q is selected from the group consisting of an aryl group, a hydroxy group, nitro, halo, amino, NR₂, OR, a nitrile group, —CF₃ and R, where R is a substituted or unsubstituted aliphatic group having 1-24 carbon atoms which may be straight, branched or cyclic.

Preferably a compound of general formula (1D) exhibits intense luminescence, which may be photoluminescence and/or electroluminescence.

Preferred embodiments of compounds of the general formula (1D) have at least three non-hydrogen substituents in the six ortho positions relative to the boron-carbon (or boron-heteroatom) bonds. Certain preferred embodiments of compounds of the general formula (1D) have three of the six ortho positions substituted with non-hydrogen substituents. More preferred embodiments have four of the six ortho positions substituted with non-hydrogen substituents. Still other embodiments have five of the six ortho positions substituted with non-hydrogen substituents. Other embodiments have six of the six ortho positions substituted with non-hydrogen substituents.

In certain preferred embodiments of compounds of the general formula (1D), a heteroatom of Q may be, for example, N, S or O. Preferably, the heteroatom is N. In preferred embodiments, the heteroatom of the Q ring is the atom through which the boron portion of the molecule is connected to Q. If we examine the bond between Ar⁴ and the heteroatom of Q, most preferred embodiments of compounds of the general formula (1D) do not have a C₂ axis of symmetry lying along the Ar-Q bond. Most preferred embodiments of compounds of the general formula (1D) have at least three non-hydrogen substituents in the six ortho positions relative to the boron-carbon (or boron-heteroatom) bonds, do not have a two-fold axis of symmetry along the Q-Ar⁴ bond, and have a heteroatom as the atom of Q that is bonded to Ar⁴.

In another aspect of the invention, a stable organic compound of the general formula (1E) is provided: 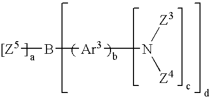
(1E)
where
a is 0, 1 or 2;
b is 1, 2, 3, 4, 5 or 6;
c is 1, 2, 3, 4 or 5;
d is 1, 2 or 3;
wherein the sum of a plus d equals three;
Ar¹, Z³, Z⁴ and Z⁵ are each independently a substituted or unsubstituted aryl moiety selected from the group consisting of phenyl, biphenyl, naphthyl, anthryl, phenanthryl, pyrenyl, xylyl, mesityl, duryl, indolyl, thienyl, and quinolinyl (preferred aryl moieties 1a to 1o are pictured above);
wherein a substituent of Ar³ or Z⁵ is selected from the group consisting of an aryl group, F, NR₂, a nitrile group, —CF₃, OR, and R, where R is a substituted or unsubstituted aliphatic group having 1-24 carbon atoms which may be straight, branched or cyclic; and
wherein a substituent of Z³ or Z⁴ is selected from the group consisting of an aryl group, a hydroxy group, nitro, halo, amino, NR₂, OR, a nitrile group, —CF₃ and R, where R is a substituted or unsubstituted aliphatic group having 1-24 carbon atoms which may be straight, branched or cyclic.

Preferably a compound of general formula (1E) exhibits intense luminescence, which may be photoluminescence and/or electroluminescence.

In preferred embodiments of compounds of the general formula (1E), Z³ and Z⁴ are different from each other. In other preferred embodiments, at least one of Z³ and Z⁴ is heteroaromatic. In further embodiments, Z³ and Z⁴ are different from each other and at least one of Z³ and Z⁴ is heteroaromatic.

Preferred embodiments of compounds of the general formula (1E) have at least three non-hydrogen substituents in the six ortho positions relative to the boron-carbon (or boron-heteroatom) bonds. Certain preferred embodiments of compounds of the general formula (1E) have three non-hydrogen substituents in the six ortho positions relative to the boron-carbon (or boron-heteroatom) bonds. More preferred embodiments have four of the six ortho positions substituted with non-hydrogen substituents. Still other embodiments have five of the six ortho positions substituted with non-hydrogen substituents. Other embodiments have six of the six ortho positions substituted with non-hydrogen substituents. Most preferred embodiments of compounds of the general formula (1E) have at least three non-hydrogen substituents in the six ortho positions, and (i) Z³ and Z⁴ are not identical or (ii) at least one of Z³ and Z⁴ is heteroaromatic. Other preferred compounds of the general formula (1E) have methyl-substituted phenyl moieties bonded to the boron such that the charge density is stabilized.

As used herein “aliphatic” includes alkyl, alkenyl and alkynyl. An aliphatic group may be substituted or unsubstituted. It may be straight chain, branched chain or cyclic.

As used herein “aryl” includes heteroaryl and may be substituted or unsubstituted.

As used herein “unsubstituted” refers to any open valence of an atom being occupied by hydrogen.

As used herein “substituted” refers to the structure having one or more substituents.

As used herein “heteroatom” refers to non-carbon atoms, such as, for example, O, S, and N.

The invention provides, for example, compounds:
p-(1-naphthylphenylamino)-4,4′-biphenyldimesitylborane (BNPB);
p-(2,2′-dipyridylamino)phenyldimesitylborane (101);
p-(2,2′-dipyridylamino)biphenyldimesitylborane (102);
p-(7-azaindolyl)phenyldimesitylborane (103);
p-(7-azaindolyl)biphenyldimesitylborane (104);
3,5-bis(2,2′-dipyridylamino)phenyldimesitylborane (105);
3,5-bis(7-azaindolyl)phenyldimesitylborane (106);
p-[3,5-bis(2,2′-dipyridylamino)phenyl]phenyldimesitylborane (107);
5-[p-(2,2′-dipyridylamino)phenyl]-2-thienyldimesitylborane (108);
4-(1-naphthylphenylamino)-4′-biphenylduryidimesitylborane (201);
Tris[p-(1-naphthylphenylamino)phenylduryl]borane (202); and
Tris[p-(1-naphthylphenylamino)biphenylduryl]borane (203), which have the following structures: 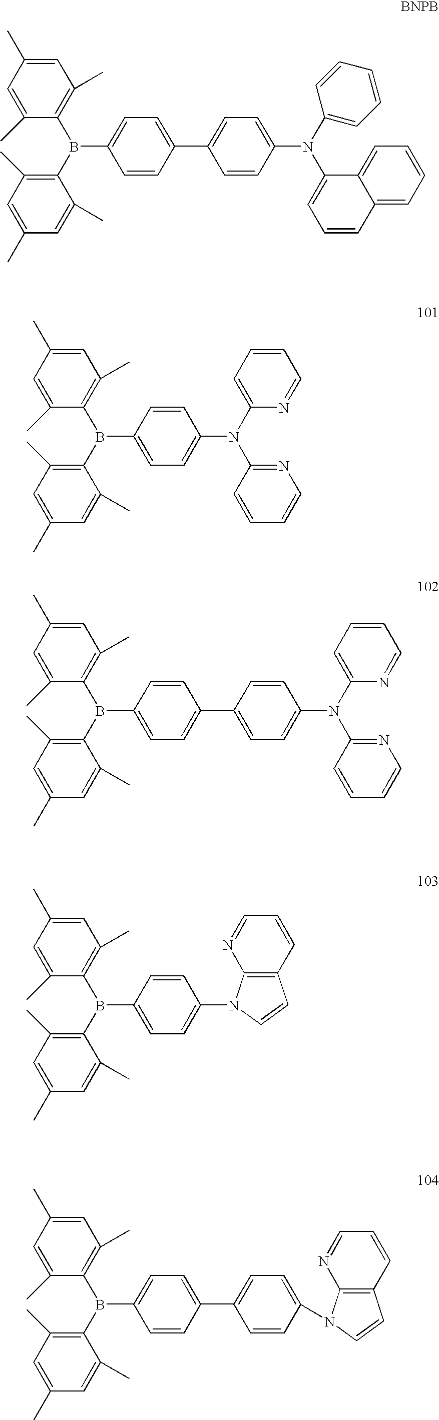 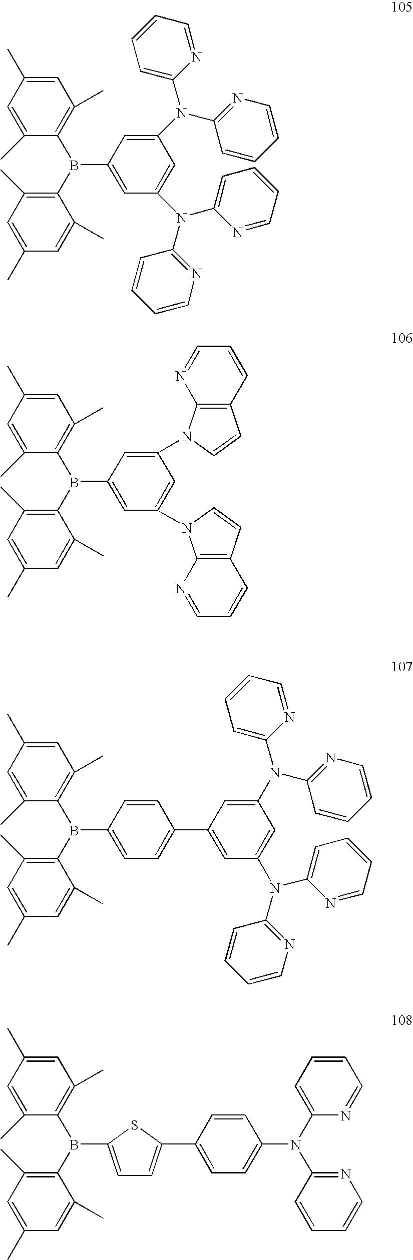 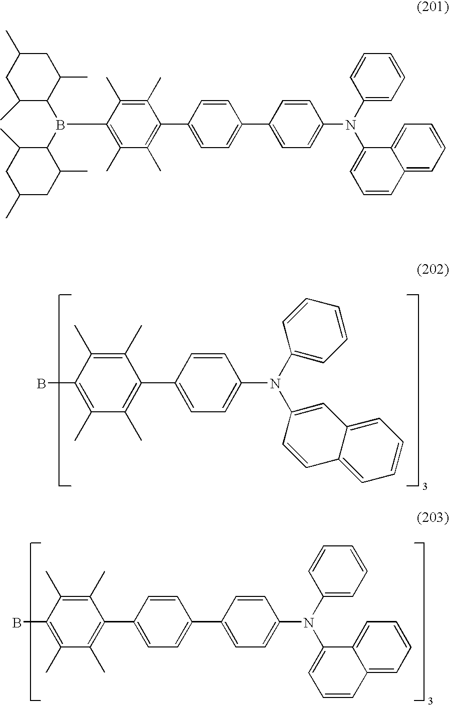
   Note that the substituent 2,2′-dipyridylamine (dpa), is called deprotonated di-2-pyridylamine in U.S. Pat. No. 6,500,569 and No. 6,312,835 by some of the present inventors.)

The three-coordinated organoboron compounds of general structures (1A), (1B), (1C), (1D) and (1E) are excellent candidates for OLEDs due to the electronic and optical properties of these molecules. The empty and relatively low-lying 2pₙ orbital on the boron center makes these compounds good electron acceptors. The ability of the compounds to reversibly bind an electron donor (Lewis base) makes them candidates for electron transport materials in OLEDs. The presence of an internal electron donor group produces a polarized donor-acceptor electronic transition, useful for non-linear optical applications. The presence of a luminescent chromophore makes it possible to use these compounds as emitters in OLEDs and as fluorescent sensors as well, for example as fluorescent sensors for the detection of Lewis bases. When the electron-deficient boron center of these three-coordinated boron compounds is protected by substituent groups, the boron compounds have sufficient chemical stability for OLEDs and other practical applications. As described below, certain such compounds also function as hole transporters and/or hole injectors.

The invention provides compounds that are photoluminescent and, in at least some embodiments of the invention, electroluminescent; they can produce intense light.

The invention also provides a method of producing photoluminescence comprising the steps of: providing a photoluminescent compound of the invention having a formula as set out above; and irradiating said photoluminescent compound with radiation of a wavelength suitable for exciting the compound to photoluminescence.

The invention further provides a method of producing electroluminescence comprising the steps of: providing an electroluminescent compound of the invention having a formula as set out above; and applying a voltage across said electroluminescent compound.

The invention further provides an electroluminescent device for use with an applied voltage, comprising: a first electrode, an emitter (e.g., phosphor) which is an electroluminescent compound of the invention, and a second, transparent electrode, wherein a voltage is applied between the two electrodes to produce an electric field across the emitter. The emitter consequently electroluminesces. In some embodiments of the invention, the device includes one or more charge transport layers interposed between the emitter and one or both of the electrodes. For example, spacing of a preferred embodiment of the device, called for the purposes of the present application a “three layer EL device”, is: first electrode, first charge transport layer, emitter, second charge transport layer, and second, transparent electrode.

The invention also provides for a dual emission electroluminescent device for use with an applied voltage, comprising two emitters. An emitter may be a compound of the invention, or a compound of the invention may be used as a spacer in between two emitting layers. It follows that a compound of the invention may be used in a multiple emission electroluminescent device with multiple emitting layers. A compound of the invention may be used as one of the emitters or as a spacer in between two or more of the emitting layers.

In certain embodiments of the invention, the device includes one or more compounds of the invention acting as one or more charge transport layers, charge injection layers, and/or emitters interposed between the electrodes.

In other embodiments of the invention, the device includes one or more compounds of the invention acting as a hole injection layer interposed between the anode and the remaining layer(s) of the device.

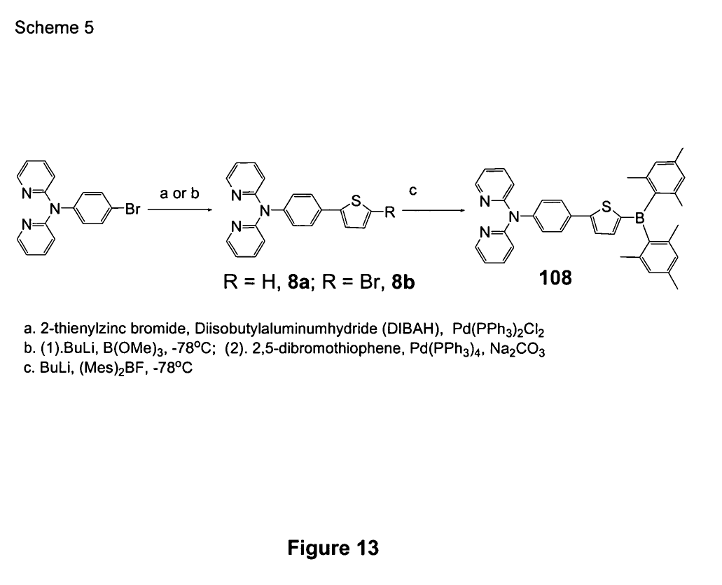

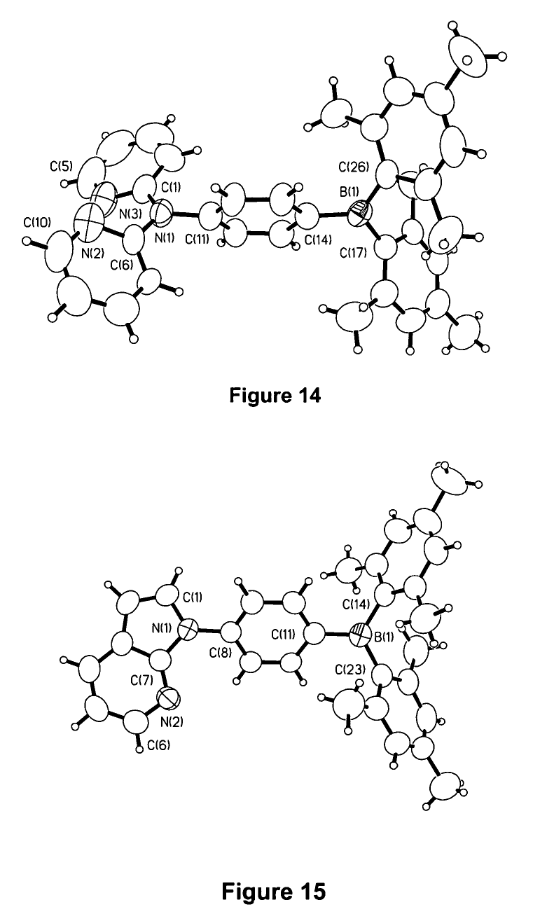

In one embodiment of the invention, called for the purposes of the present application a “two layer EL device”, the spacing is: first electrode, charge transport layer, emitter/second charge transport layer, and second electrode. Working examples of two layer EL devices “B” and “C” are described in Examples 2E and 2F, referring to FIGS. 8 and 9. Here, compound BNPB acted in device B as both the emitter and the charge (electron) transport layer and in device C, BNPB acted as both the emitter and the charge (hole) transport layer.

Example 2H below describes a two layer EL device which demonstrates a further unexpected and useful property of BNPB, hole injection. A two-layer device E was prepared where BNPB was used as a hole injector, NPB was used as a hole transporter, Alq₃ was used as the emitter and electron transporter, and LiF was added to improve contact between the electron transport layer and the cathode. See FIGS. 28 and 29.

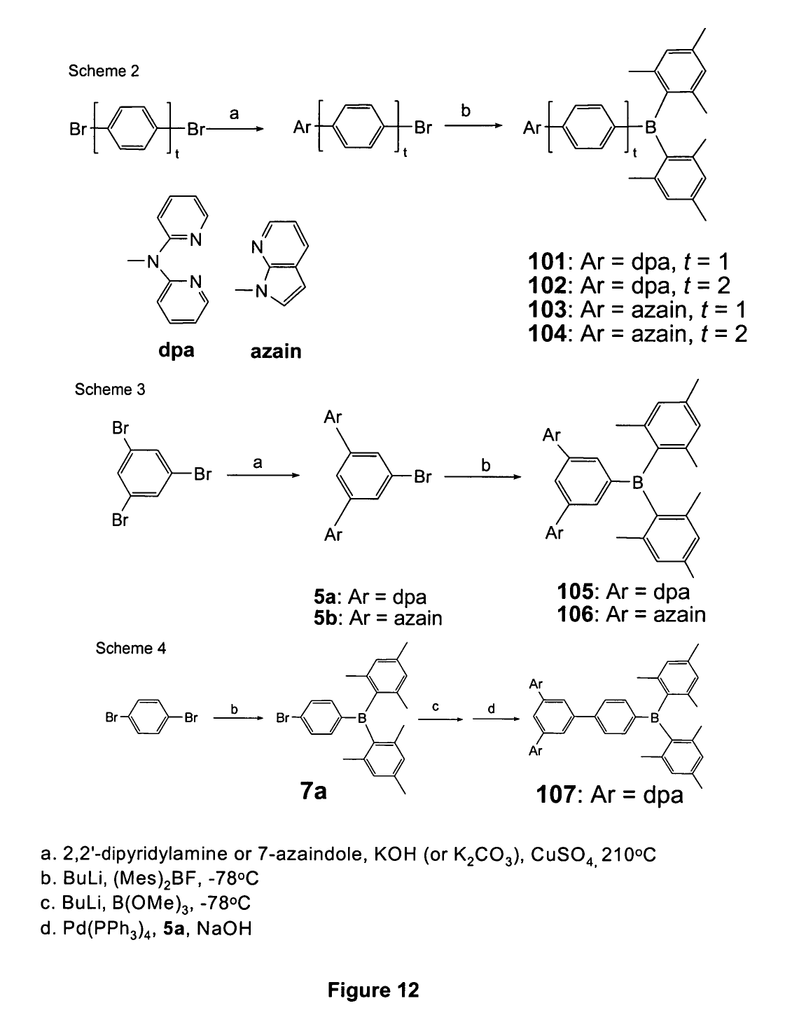

In another embodiment of the invention, called for the purposes of the present application a “one layer EL device”, the spacing is: first electrode, first charge transport layer/emitter/second charge transport layer, second electrode. A working example of a one layer EL device “A” is described in Example 2C, and its luminance and current density are shown graphically in FIG. 7. Here, compound BNPB acted in device A as all of the emitter, electron transport layer and hole transport layer.

Thus, BNPB has several advantageous properties: It conveniently forms transparent films that can bind to an ITO substrate. BNPB demonstrates the ability to transport holes, and to inject holes. As noted above, currently CuPc is the only effective and available material for use as a HIL in OLEDs (Mori et al., 2002, Lee et al., 2003). However CuPc has the disadvantage of an absorption band in the red spectrum which limits its use, whereas an ideal HIL should be transparent across the entire visible spectrum. Since BNPB is a colourless film with its absorption band in the 300-400 nm region, it has ideal optical properties for acting as a hole injection layer. According to one broad aspect, the invention provides an element for an electroluminescent device which contains BNPB; preferably this element is a layer. In a particularly preferred embodiment, the BNPB acts as at least two of an emitter, a hole transporter, an electron transporter and a hole injector. In a further particularly preferred embodiment, BNPB acts as three of these.

The inventors expect that closely related compounds to BNPB are likely to have multiple such properties and, without wishing to be bound by theory, provide the following interpretation of certain characteristics of such compounds.

It is believed that the asymmetry of the substituents about the nitrogen center contributes to the good film-forming characteristics of BNPB and its equivalents, because the asymmetry makes it difficult for crystals to form in the solid phase. The inventors expect that the greater the degree of difference that exists between the aryl groups on the nitrogen, the greater the degree of disorder in the solid phase; thus preferred differences include a different number of conjugated rings in the respective aryl groups. However, even the asymmetry offered by phenyl and toluene would likely lead to good film forming.

The inventors further believe that increasing the number of aryl groups separating boron from nitrogen contributes to disorder of the solid phase, thus lessening the likelihood of crystal formation while enhancing film forming. The number of aryl (e.g., phenyl) groups separating the boron from the nitrogen in equivalents of BNPB can be 1-4, preferably 2. It should be noted that in embodiments where there are more than one “NPB” arm bonded to the boron (e.g., two or three), the boron's fourth coordination site should preferably be protected from attack by an electron-donating group as discussed above. This can be achieved by substituents around the boron, preferably four substituents.

The inventors expect that three-coordinated boron compounds with two or three (1- or 2-naphthyl)phenylamino functionalized aryl groups with a minimum of four substituents protecting the boron centre will demonstrate good hole injection. An example of such a compound is pictured below.

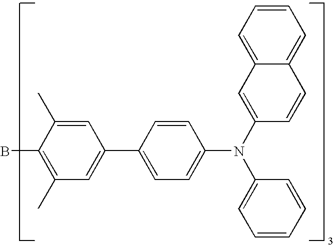

The use of organoboron compounds as charge transporters in OLEDs is discussed in Ueda, 2001. The synthesis of two compounds and subsequent testing of them in OLED devices as hole transporters and as electron transporters is described. These devices employed industry standard emitters and industry standard charge injectors. Although the structure of BNPB is pictured in this document, there is no teaching of any synthesis, and accordingly BNPB was not tested in any OLED. Ueda does not teach or even suggest that BNPB can act as all three of emitter, electron transporter and hole transporter, or any two of emitter/hole transporter and emitter/electron transporter. Ueda does not teach or even suggest that BNPB can act as a hole injector.

A further advantage of preferred compounds of the invention is that they are highly soluble in common organic solvents such as toluene, diethyl ether, tetrahydrofuran (THF), and dichloromethane. This permits the compounds to be blended easily and conveniently with organic polymers. The role of the organic polymer in such a mixture is at least two-fold: First, a polymer can provide protection for the compound from air degradation. Second, a polymer host matrix permits the use of a spin-coating or dip-coating process as an alternative way to make films. Although spin-coating and dip-coating processes may not produce as high quality films as those produced by chemical vapor deposition or vacuum deposition, they are often much faster and more economical.

Accordingly, the invention further provides methods of applying compounds as described above to a surface. These methods include solvent cast from solution, electrochemical deposition, vacuum vapor deposition, chemical vapor deposition, spin coating and dip coating. The compounds may be applied alone or with a carrier. In some embodiments of the invention, they are applied in a composition including an organic polymer. Such compositions are also encompassed by the invention.

As an example of this application, compounds of the invention (e.g., BNPB) are expected to form a clear transparent solution with the weakly-luminescent polymer poly(N-vinylcarbazole) (PVK) in CH₂Cl₂/C₆H₅Cl. This can be converted to a transparent film by evaporating the toluene solvent via either a dip-coating or spin-coating process. Films obtained in this way are stable. Certain polymers such as, for example, PVK, are expected to further enhance the luminescence of an emitter in the film.

The invention provides a method of producing electroluminescence comprising the steps of: providing an electroluminescent compound of the invention having the general formula (1A) (1B), (1C), (1D) or (1E), as set out above; and applying a voltage across said electroluminescent compound so that the compound electroluminesces.

According to the invention, electroluminescent devices for use with an applied voltage are provided. In general, such a device has a first electrode, an emitter which is an electroluminescent compound of the invention, and a second, transparent electrode, wherein a voltage is applied between the two electrodes to produce an electric field across the emitter of sufficient strength to cause the emitter to electroluminesce. Preferably, the first electrode is of a metal, such as, for example, aluminum, which reflects light emitted by the compound; whereas the second, transparent electrode permits passage of emitted light therethrough. The transparent electrode is preferably of indium tin oxide or an equivalent known in the art. Here, the first electrode is the cathode and the second electrode is the anode.

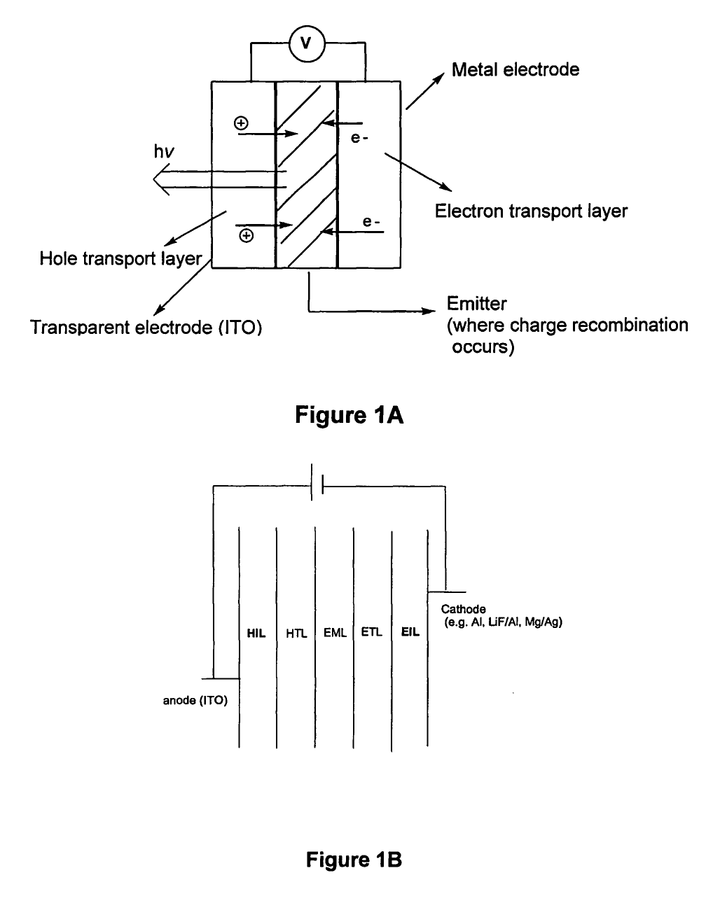

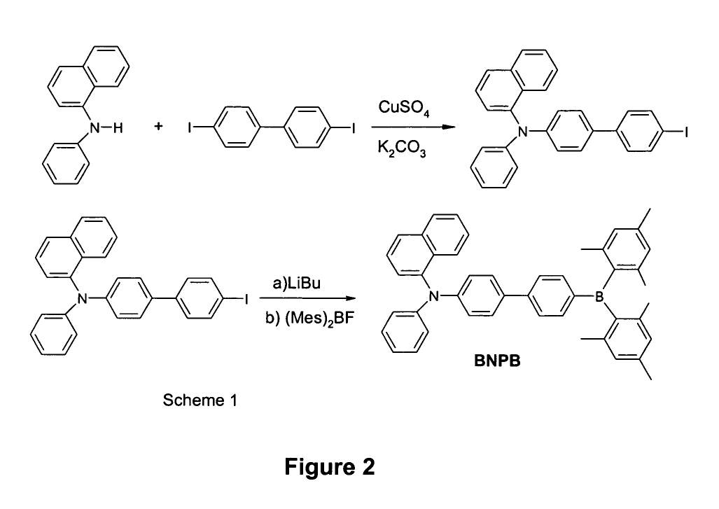

Referring to FIG. 1A, a preferred embodiment of an electroluminescent device of the invention is shown. The emitter is interposed between an electron transport layer (e.g., tris-(8-hydroxyquinoline)aluminum or “Alq₃”, a well-known example of a bifunctional molecule whose application in OLEDs is limited by its intense emission band in the green region, or 2-(biphenyl-4-yl)-5-(4-tert-butyl phenyl)-1,3,4-oxadiazole (PBD)) adjacent the first metal electrode and a hole transport layer (e.g., N,N′-di-1-naphthyl-N,N/-diphenylbenzidiine (NPB)) adjacent the second, transparent electrode. The choice of the materials employed as charge transport layers will depend upon the specific properties of the particular emitter employed. The hole transport layer or the electron transport layer may also function as a supporting layer. The device is connected to a voltage source such that an electric field of sufficient strength is applied across the emitter. Light, preferably blue light, consequently emitted from the compound of the invention passes through the transparent electrode. Some emitters of the invention may additionally function as an electron transport material and/or as a hole transport material in the device. Some of the compounds of the invention may act in all three capacities. Furthermore, a compound of the invention may act as a charge transport material or a charge injection material for another emitter which may or may not also be a compound of the invention.

In a particularly preferred embodiment of the invention, BNPB acts as a hole injection material; BNPB may optionally also perform as an emitter, hole transporter and/or electron transporter in the same device. Thus, the invention encompasses both devices wherein BNPB is a hole transporter and methods of transporting holes (which may be thought of as positive charges thus balancing electrons) using BNPB.

In some embodiments of the invention, the device includes one or more charge transport layers interposed between the emitter and one or both of the electrodes. Such charge transport layer(s) are employed in prior art systems with inorganic salt emitters to reduce the voltage drop across the emitter. In a first example of such a device, a three layer device, the layers are arranged in a sandwich fashion in the following order: first electrode, charge transport layer, emitter, second charge transport layer, and second, transparent electrode. In a preferred embodiment of this type, a substrate of glass, quartz or the like is employed. A reflective metal layer (corresponding to the first electrode) is deposited on one side of the substrate, and an insulating charge transport layer is deposited on the other side. The emitter layer which is a compound of the invention is deposited on the charge transport layer, preferably by vacuum vapor deposition, though other methods may be equally effective. A transparent conducting electrode (e.g., ITO) is then deposited on the emitter layer. An effective voltage is applied to produce electroluminescence of the emitter.

In a second example of an EL device of the invention, a charge transport layer is employed with an emitter which is bifunctional in that it is an emitting layer and a charge transport layer. In such a two layer device the sandwich layers are arranged in the following order: first electrode, charge transport layer, emitter/charge transport layer and second, transparent electrode.

In a third example of an EL device of the invention, an emitter is employed which is multifunctional in that it is all three layers in one, an emitting layer, an electron transport layer and a hole transport layer. In such a one layer device, the sandwich layers are arranged in the following order: first electrode, electron transport layer/emitter/hole transport layer and second electrode.

Electroluminescent devices of the invention may include one or more of the three-coordinated boron compounds described herein, preferably blue light-emitting. In some embodiments of the invention, an electroluminescent device such as a flat panel display device may include not only a blue-emitting phosphor as described herein, but may be a multiple-colour display device including one or more other phosphors. The other phosphors may emit in other light ranges, e.g., red, green, and/or be “stacked” relative to each other. Convenient materials, structures and uses of electroluminescent display devices are described in Rack et al., 1996.

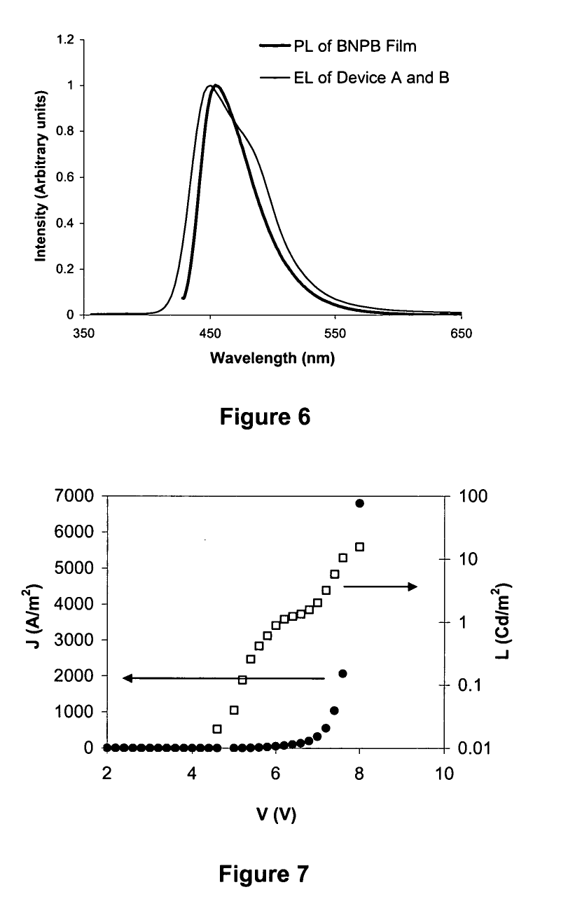

For photoluminescence, the compounds absorb energy from ultraviolet radiation and emit visible light near the ultraviolet end of the visible spectrum e.g., in the blue region. For electroluminescence, the absorbed energy is from an applied electric field. It is expected that the luminescence of compounds of the invention can be altered or quenched by the addition of acid, organic molecules such as solvents (see FIG. 4) or metal cations (see FIG. 27) such as Zn²⁺, Cu²⁺, Ni²⁺, Cd²⁺, Hg²⁺, Ag⁺ and H⁺ (Pang et al., 2001, Yang et al., 2001).

The invention further provides methods employing compounds of the invention to harvest photons, and corresponding devices for such use. Spectroscopic studies have demonstrated that compounds of the invention have high efficiency to harvest photons and produce highly polarized electronic transitions. In general, when such compounds are excited by light, a charge separation occurs within the molecule; a first portion of the molecule has a negative charge and a second portion has a positive charge. Thus the first portion acts as an electron donor and the second portion as an electron acceptor. If recombination of the charge separation occurs, a photon is produced and luminescence is observed. In photovoltaic devices, recombination of the charge separation does not occur; instead the charges move toward an anode and a cathode to produce a potential difference, from which current can be produced.

Molecules with the ability to separate charges upon light initiation are useful for applications such as photocopiers, photovoltaic devices and photoreceptors. Organic photoconductors provided by the present invention are expected to be useful in such applications, due to their stability and ability to be spread into thin films. Related methods are encompassed by the invention.

Organic semiconducting materials can be used in the manufacture of photovoltaic cells that harvest light by photoinduced charge separation. To realize an efficient photovoltaic device, a large interfacial area at which effective dissociation of excitons occurs must be created; thus an electron donor material is mixed with an electron acceptor material. (Here, an exciton is a mobile combination of an electron and a hole in an excited crystal, e.g., a semiconductor.) Organic luminescent compounds as semiconductors are advantageous due to their long lifetime, efficiency, low operating voltage and low cost.

Photocopiers use a light-initiated charge separation to attract positively-charged molecules of toner powder onto a drum that is negatively charged.

The invention further provides methods employing compounds of the invention to detect metal ions (see FIG. 27). The change in the luminescence upon coordination of metal ions may be useful for detection of gunpowder residue, bomb making activity, and/or environmental contamination such as heavy metal contamination of food or soil or water, as well as for detection of sites of meteor impact and even interplanetary exploration.

The invention also provides methods employing compounds of the invention to detect organic molecules, for example, organic solvents. The change in the luminescence upon intermolecular binding of organic molecules may be useful for detection of organic molecules in environmental contamination of food or soil or water. The change of emission of compounds according to the invention may be used to detect contamination of soil or water by organic solvents such as, for example, benzene, chlorinated benzenes, PCBs (polychlorinated biphenyls), hexanes, toluene, tetrahydrofuran, dichloromethane and acetonitrile.

The invention further provides methods employing compounds of the invention to detect acid. This aspect of the invention is expected to be useful for a variety of applications, including, without limitation, pH sensors, as well as detection of contamination, particularly environmental contamination (e.g., acidity of lakes, soil, etc.).

The invention further provides molecular switches employing compounds as described above, and methods of use thereof.

Information processing systems of current computers are based on semiconductor logic gates or switches (Tang et al., 1987). By reducing the switching elements to a molecular level, the processing capability and memory density of computers could be increased by several orders of magnitude and the power input could be decreased significantly (Leung et al., 2000). Candidates for this purpose (e.g., compounds of the invention as described herein) are molecules that are capable of undergoing reversible transformations in response to chemical, electrical and/or optical stimulation, and producing readily detectable optical signals in the process.

Example 1 below provides a detailed description of the synthesis of the compound BNPB. Examples 2 and 3 describe the electronic and electroluminescent properties of BNPB. Examples 4 to 12 describe the syntheses of compounds 101 to 111. Examples 13 and 14 describe the X-ray studies and EL devices of compounds 101 to 111. Example 15 describes the syntheses of compounds 201 to 203. Examples 16 to 19 describe X-ray studies and EL devices of compounds 201 to 203. As would be apparent to a person of ordinary skill in the art, other functionalities may be included in derivatives according to the invention. Alternatively, starting materials may be modified to include, but are not limited to, functionalities such as ether, epoxide, ester, amide or the like. Such functionalities may in some cases confer desirable physical or chemical properties, such as increased stability or luminescence.

### WORKING EXAMPLES

All starting materials were purchased from Aldrich Chemical Company, Milwaukee, Wis., U.S.A., and used without further purification. Aromatic bromides, p-(2,2′-dipyridylamino)bromobenzene (Kang et al., 2002), p-(2,2′-dipyridylamino)bromobiphenyl (Kang et al., 2002), p-(7-azaindolyl)bromobenzene (Kang et al., 2002), p-(7-azaindolyl)bromobiphenyl (Kang et al., 2002), 3,5-bis(7-azaindolyl)bromobenzene (Wu et al., 2001 and p-(2,2′-dipyridylamino)phenylboronic acid (Jia et al., 2003) were synthesized according to previously reported procedures. Solvents were freshly distilled over appropriate drying reagents. All experiments were carried out under a dry nitrogen atmosphere using standard Schlenk techniques unless otherwise stated. Thin layer chromatography was carried out on silica gel (SiliCycle Inc., Quebec City, Quebec, Canada). Flash chromatography was carried out on silica (silica gel 60, 70-230 mesh) (SiliCycle Inc., Quebec City, Quebec, Canada). ¹H and ¹³C NMR spectra were recorded on either a Bruker Avance 300 or a Bruker Avance 500 MHz spectrometer (Bruker, Toronto, Ontario, Canada). Excitation and emission spectra were recorded on a Photon Technologies International (London, Ontario, Canada) QuantaMaster Model 2 spectrometer. Elemental analyses were performed by Canadian Microanalytical Service Ltd., Delta, British Columbia, Canada. The melting point was determined on a Fisher-Johns melting point apparatus (LABEQUIP, Markham, Ontario, Canada). All Differential Scanning Calorimetry (DSC) measurements were performed on a Perkin Elmer Pyris DSC 6 (PerkinElmer, Woodbridge, Ontario, Canada). Cyclic voltammetry was performed using a BAS CV-50W analyzer with scan rates of 100 mV s⁻¹ (BAS, Inc., West Lafayette, Ind., U.S.A.). The electrolytic cell used was a conventional three compartment cell, in which a Pt working electrode, a Pt auxiliary electrode, and Ag/AgCl reference electrode were employed. The cyclic voltammetry measurements were performed at room temperature using 0.10 M tetrabutylammonium hexafluorophosphate (TBAP) as the supporting electrolyte. Ferrocenium/ferrocene was used as the internal standard.

### Example 1

### Synthesis of p-(1-naphthylphenylamino)-4,4′-biphenyldimesitylborane (BNPB)

The starting material 4-iodo-4′-(1-naphthylphenylamino)biphenyl was synthesized by a coupling reaction of 4,4′-diodobiphenyl with 1-naphtylphenylamine using Ullmann condensation methods (Belfield et al., 2000, Goodbrand et al., 1999, Paine et al., 1987, Fanta et al., 1974, Koene et al., 1998). To a solution of 4-iodo-4′-(1-naphthylphenylamino)biphenyl (0.497 g, 1 mmol) in diethyl ether (60 mL) was added a hexane solution of n-BuLi (1.6M, 0.69 mL, 1.1 mmol) at −78° C., and the mixture was stirred for 1 h at this temperature. A solution of dimesitylboron fluoride (0.33 g, 90%, 1.1 mmol) in diethyl ether (20 mL) was then added and the reaction mixture was stirred for another hour at −78° C. The reaction mixture was then allowed to come to room temperature slowly and was stirred overnight. The solvents were removed under reduced pressure. The residue was subjected to column chromatography on silica gel (CH₂Cl₂/hexane, 1:10) to afford colourless compound BNPB in 89% yield. T_{g}: 105° C. ¹H NMR in CD₃Cl (δ, ppm, 25° C.): 8.01 (d, J=8.5, 1H), 7.95 (d, J=8.0, 1H), 7.84 (d, J=8.0, 1H), 7.59-7.63 (m, 4H), 7.50-7.55 (m, 4H), 7.42 (m, 2H), 7.26-7.30 (m, 2H), 7.17 (dd, J=8.5, 1.0, 2H), 7.12 (dd, J=9.0, 1.5), 7.04 (qt, J=7.0, 1.5, 1H), 6.90 (s, 4H), 2.38 (s, 6H), 2.11 (s, 12H). ¹³C NMR in CDCl₃ (δ, ppm, 25° C.): 148.8, 148.5, 144.3, 143.7, 142.3, 141.3, 138.9, 137.6, 135.8, 133.7, 131.7, 129.6, 128.9, 128.6, 128.2, 127.7, 127.1, 126.9, 126.8, 126.6, 126.2, 126.0, 124.7, 122.9, 122.7, 121.8, 23.9, 21.7. Anal. Calcd. for C₄₆H₄₂BN: C, 89.18; H, 6.79; N, 2.26. Found: C, 89.26; H, 6.73; N, 2.19. Absorption and Luminescence Data for BNPB are found in Table 2.

### Example 2

### Fabrication of Electroluminescent Devices for Evaluation of BNPB

BNPB is an amorphous solid at ambient temperature. BNPB is highly soluble in organic solvents including hexane, benzene, THF, CH₂Cl₂, ethanol and DMF. A solution of BNPB readily forms uniform transparent films on glass surfaces and metal oxide surfaces by either dropping the solution directly on the surface, vacuum deposition or spin coating. BNPB can form films readily, hence in the preparation of OLEDs, simple spin casting is possible.

The unique film forming capabilities of BNPB combined with its ability to be a hole transporter make it an ideal candidate for a hole injection layer (HIL) in an EL device. A hole injection layer which forms a good interface with the ITO increases the efficiency of the device. Most organic molecules do not adequately bind to the inorganic oxide ITO. When the layer that is next to the ITO is not well bonded to it, the EL device may undergo formation of a void in this area during device operation. Such a void may lead to poor thermal stability of the device. A standard HIL, CuPc, forms a reasonably good interface with ITO, which may be due to its very high glass transition temperature. One of the disadvantages of CuPc is that it is coloured (it has an absorption band in the red spectrum). This property limits its application to devices where the colour emitted from the CuPc layer does not interfere with the colour emitted by the overall EL device. Such interference would be unacceptable, for example, in a monochrome device. For full-colour devices, the HIL must be transparent across the visible spectrum. BNPB is a colourless molecule with absorption bands in the 300400 nm region. Thus BNPB is likely to be a very desirable molecule for an HIL layer since it has optical characteristics for which the OLED industry is currently looking.

Several EL devices were fabricated using a K. J. Lesker (Clairton, Pa., U.S.A.) OLED cluster tool on 2″×2″ ITO coated glass substrates. In each case, the ITO surface was cleaned by ultrasonication in each of acetone, methanol and de-ionized water, and a final UV ozone treatment. All the OLEDs had an active area of 5×1 mm². The base pressures of the organic and metallization chambers were 5.9×10⁻⁹ Torr and 3.9×10⁻⁸ Torr, respectively. The pressures during the deposition process in the two chambers were lower than 7.0×10⁻⁷ Torr. The growth rates were −2 Å/s for organic materials, 0.1 Å/s for LiF, and −1.5 Å/s for metals (Al and Ag). Luminance-current density-voltage (L-J-V) characteristics were determined at ambient atmosphere using a HP 4140B pA meter and a Minolta LS-110 meter. The dwell time for each testing point was 2 seconds to ensure the device had reached a stable optoelectronical process. Electroluminescence (EL) spectra were recorded using a USB2000-UV-VIS Miniature Fiber Optic Spectrometer.

### Example 2A

### Preparation of a Single-Layer BNPB Electroluminescence Device by Spin Coating

Several single layer EL devices of BNPB were prepared via spin coating a solution of BNPB directly onto an ITO substrate, followed by vacuum evaporation of an Al cathode layer on top of the BNPB layer. Various thickness of BNPB were used. Although weak blue EL was observed for these devices, they all showed a very high turn-on voltage (−30 V), and as a consequence, the devices only survived for a short time after they were turned on.

### Example 2B

### Preparation of Single-Layer NPB-BNPB Electroluminescence Devices

Several single-layer EL devices of NPB codeposited with BNPB were prepared by using a variety of ratios of NPB to BNPB and by spin coating the solution mixture. These films lacked homogeneity due to a tendency of NPB to form a solid. As a result, the performance of single-layer NPB-BNPB devices was similar to that of the single-layer BNPB devices.

### Example 2C

### Preparation of Single-Layer EL Device “A” by Vacuum Deposition

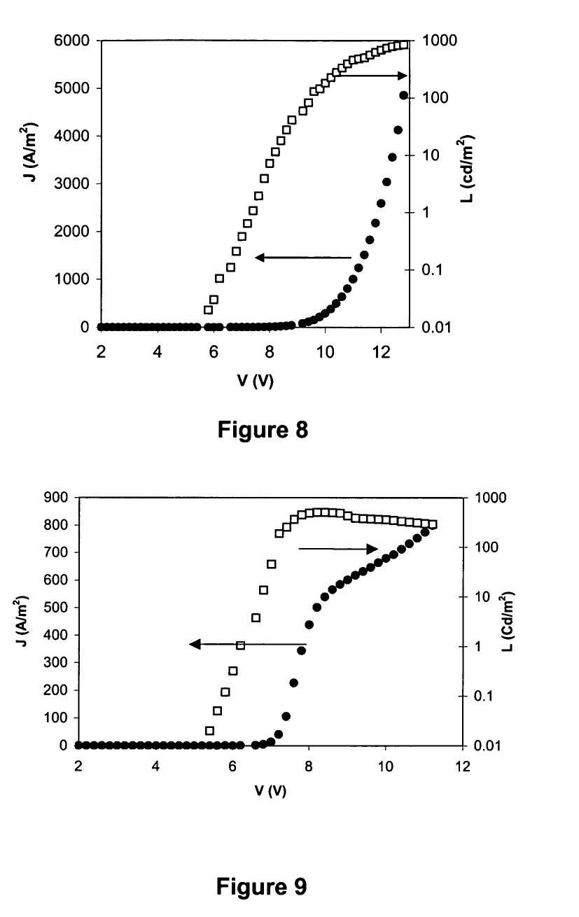

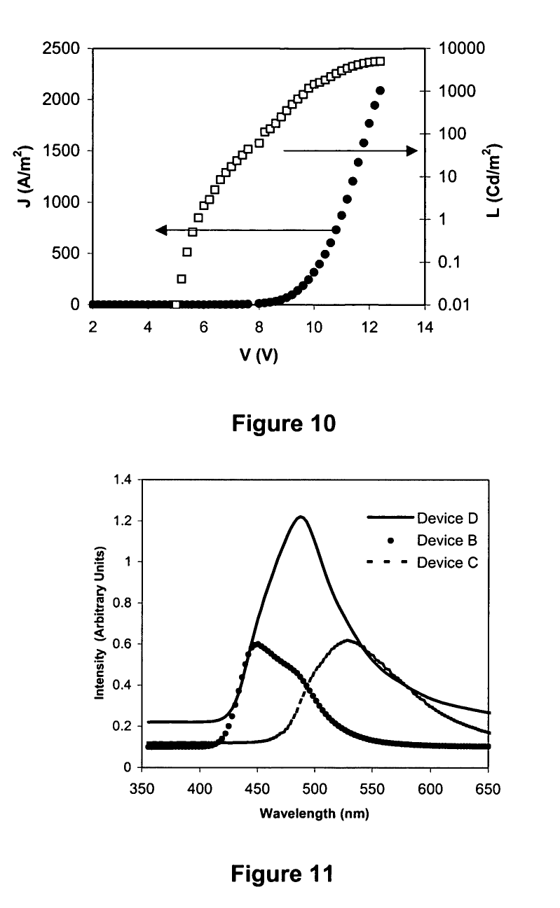

Using vacuum deposition, a single-layer EL device A (see FIG. 5A) was fabricated wherein BNPB was the hole transporter/emitter/electron transporter and LiF was added to improve contact between the film and the cathode. Device A had the following configuration: ITO/BNPB (90 nm)/LiF (0.5 nm)/Al. The device produced a blue electroluminescence (EL) that matched the photoluminescence (PL) spectrum of BNPB film (see FIG. 6). The turn-on voltage was 6.2 V. The brightness of this device can be seen graphically in the luminance (L)-Voltage (V) and Current (I)—V diagrams shown in FIG. 7. Device A demonstrates that BNPB is capable of functioning as all three of: electron transport molecule, hole transport molecule and emitter in EL devices. This ability to act in three roles is attributed to the co-existence of the tri-coordinated boron center (an electron acceptor which transports electrons), the amino center (an electron donor which transports holes) and the high photoluminescent efficiency of BNPB. The stability of device A may be limited by several factors such as the poor interfacial stability between BNPB and LiF/Al layers. The low EL efficiency of device A is likely due to the poor matching of energy levels of BNPB with those of the cathode and the anode, and the lack of an electron blocking layer. The data for EL devices A-D are summarized in Table 1A.

### Example 2D

### Preparation of Two-Layer Device with BNPB and an Al Cathode

A two-layer EL device was prepared which used NPB as the hole transport layer, BNPB as both the emitter and the electron transport layer, and LiF was added to improve contact between the electron transport layer and the cathode. The configuration of this device was ITO/NPB (60 nm)/BNPB (90 nm)/LiF(0.5 nm)/Al. This device lacked long term stability. We believe that there was possibly a chemical reaction between the BNPB and the LiF/Al layers, which caused this instability. This behavior of BNPB was unexpected based on past successful experience in preparing EL devices with LiF/Al cathodes and related tri-coordinated boron compounds.

### Example 2E

### Preparation of Two-Layer EL Device “B” with BNPB and an Ag Cathode

A stable two-layer device B was prepared which used NPB as the hole transport layer, BNPB as both the emitter and the electron transport layer and had an Ag metal cathode instead of a LiF/Al cathode layer. Device B had the following configuration: ITO/NPB (60 nm)/BNPB (90 nm)/Ag. Although the work function of the Ag layer was a poorer match for the LUMO of BNPB, device B produced fairly bright blue emission. The EL spectrum of device B was the same as that of the single layer device A. The efficiency of B is several orders of magnitude higher than that of A as shown by FIGS. 7 and 8. The turn-on voltage of B was 7.4 V. The maximum luminance at 12 V was 840 Cd/m², and the maximum efficiency was 1.0 Cd/A (at 9 V). The enhancement of efficiency of device B is thought to be due to the fact that the HOMO level of NPB is mid-way between that of BNPB and ITO, thus enhancing hole transport. In addition, the NPB layer may act as an electron blocking layer, preventing electrons from reaching the anode prior the production of excitons. Device B demonstrated that bright blue EL devices can be produced using a simple double-layer structure where BNPB is used as both the emitter and the electron transport layer.

### Example 2F

### Preparation of Two-Layer EL Device “C”

To evaluate the utility of BNPB as a hole transport material, a two-layer device C was prepared which used BNPB as the hole transport layer and Alq₃ as the electron transport layer, and LiF was added to improve contact between the electron transport layer and the cathode.

Its configuration was as follows: ITO/BNPB (60 nm)/Alq₃ (45 nm)/LiF (0.5 nm)/Al. Device C produced a green emission with an EL spectrum typical of Alq₃, an indication that the emission zone of device C is confined in the Alq₃ layer. This is not surprising since Alq₃ is the best known bifunctional molecule, being highly effective in both electron transport and light emission. Device C was bright and efficient as shown by the experimental data in FIG. 9. The maximum efficiency was 4.5 Cd/A at 7 V. Device C demonstrated that BNPB can indeed function as a hole transport material in OLEDs.

The maximum efficiency of device C was comparable to that of a standard two-layer device of the following configuration: ITO/NPB (60 nm)/Alq₃ (45 nm)/LiF(0.5 nm)/Al which has been fabricated and characterized under the same conditions as device C. However, at high voltage (>7.5 V), the luminance of device C started to decrease. This is an indication of poor stability of the device at a relatively high voltage.

No BNPB emission was observed in device C, which may be attributed to the lack of an NPB layer. As shown by device A, in the absence of NPB, BNPB was not as efficient an emitter in an EL device. Furthermore, the lack of the NPB layer in device C might have allowed electrons to migrate directly from the BNPB layer to the anode without exciton formation and photon emission.

### Example 2G

### Preparation of Three-Layer Device “D”

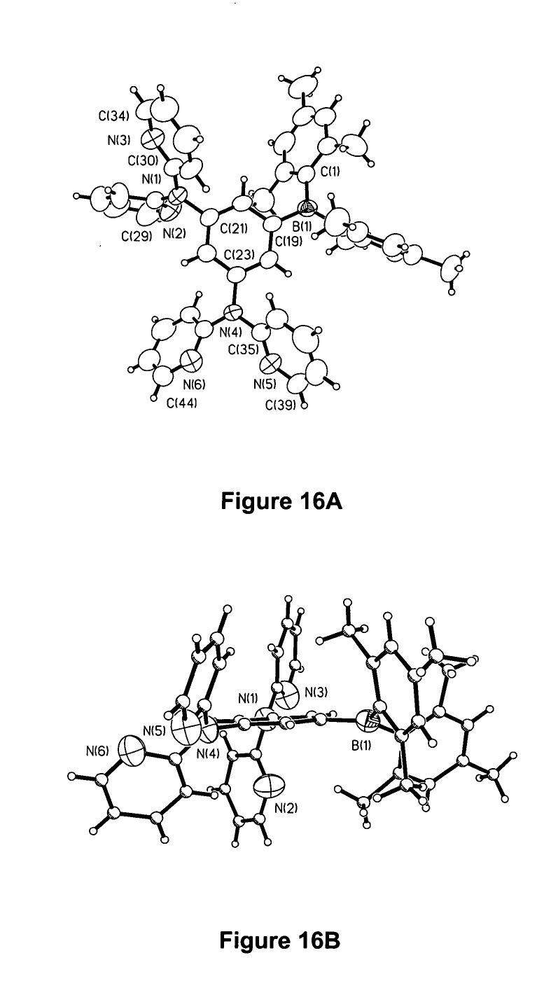

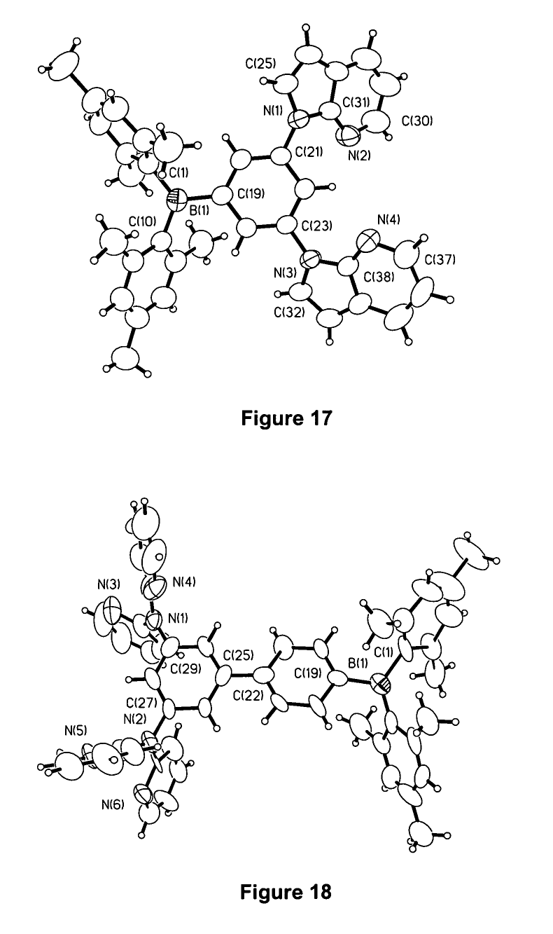

A three-layer device D was prepared with NPB as the hole transporter, BNPB as the emitter and Alq₃ as the electron transporter, and LiF was added to improve contact between the electron transport layer and the cathode. The device had the following configuration: ITO/NPB (60 nm)/BNPB (60 nm)/Alq₃ (45 nm)/LiF(0.5 nm)/Al). Device D was very bright and highly efficient, as seen in FIG. 10. The turn-on voltage of D was 5.8 V and the maximum brightness at 12 V was 5053 Cd/m². The maximum efficiency at 8 V was 6.0 Cd/A, i.e., this was a very bright EL device. For comparison purpose, the device structures of A-D are shown in FIG. 5. Device D emitted a whitish blue colour. The EL spectrum of device D was a broad emission band covering the entire 420-600 nm region with λₘₐₓ at 490 nm. This emission band was clearly not due to exciplex emission at either the NBP/BNPB interface or the BNPB/Alq₃ interface since a similar emission band was not observed for the corresponding double layer devices B and C. Based on the EL spectra of devices A-C, we believe that the most plausible explanation for the broad EL spectrum of device D is that it is the result of dual emission bands, one from BNPB and the other from Alq₃. Indeed, as shown by the overlying EL spectra in FIG. 11, the broad emission band of device D appears to comprise two components, an EL band from device B and an EL band from device C. This unusual dual emission phenomenon is likely a consequence of BNPB's properties: (1) its ability to transfer electrons, hence allowing electron migration from the Alq₃ layer to the BNPB layer; (2) its ability to emit photons effectively, hence allowing charge recombination and exciton production to occur partially in the BNPB zone; and (3) its ability to transfer holes from the Alq₃ layer, hence facilitating partial exciton and photon production within the Alq₃ layer.

### Example 2H

### Comparison of Hole Injection Properties of BNPB to Industry Standard

A two-layer device E was prepared where BNPB was used as a hole injector, NPB was used as a hole transporter, Alq₃ was used as the emitter and electron transporter, and LiF was added to improve contact between the electron transport layer and the cathode. Device E had the following configuration: ITO/BNPB (20 nm)/NPB(45 nm)/Alq₃(50 nm)/LiF(1.5 nm)/Al. The properties of device E were compared to those of a device prepared with the industry standard hole injector. This comparison device was made using very pure CuPc as the hole injector, NPB as a hole transporter, and Alq₃. as an emitter/electron transporter The CuPc used in the comparison device was purified by multiple sublimation process is the highest mass production grade material supplied by Nippon Steel Chemical, Tokyo, Japan. The comparison device had the following configuration: ITO/CuPc (20 nm)/NPB (45 nm)/Alq₃ (50 nm)/LiF (1.5 nm)/Al. A comparison of device E to the CuPc device can be seen graphically in the Luminance versus Voltage, and Current efficiency versus Luminance diagrams of FIGS. 28 and 29, respectively.

The BNPB used to prepare device E had not been processed by sublimation. It is expected that an OLED with high purity BNPB would exhibit a lower driving voltage and higher device efficiency, similar to that of the CuPc device. BNPB, with its excellent film forming characteristics is expected to be a good hole injector for OLED display, in particular for colour display because of its clear transmission to all visible light.

### Example 3

### Investigation of the Electronic Properties of BNPB

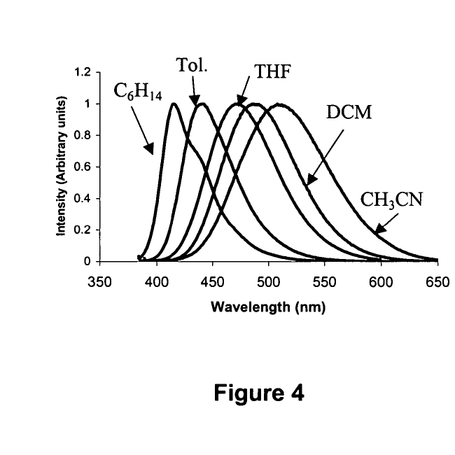

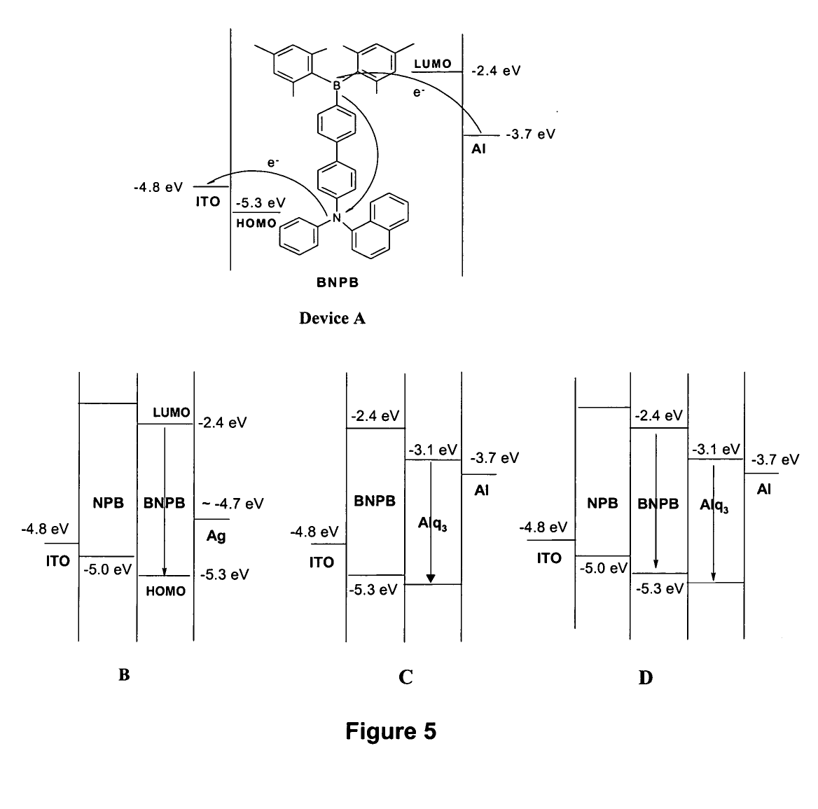

The electrochemical properties of BNPB were investigated by cydovoltammetry. BNPB displayed a reversible oxidation peak in CH₂Cl₂ at 1.03 V (versus AgCl/Ag) (see FIG. 3A). A single reversible oxidation peak was observed for BNPB, because it has just one amino center. Under the same experimental conditions, NPB exhibited two reversible oxidation peaks at 0.75 V and 1.05 V, which are attributed to the sequential oxidation of its two amino centers. The oxidation potential of BNPB is higher than the first oxidation potential of NPB, and is similar to the second oxidation potential of NPB. The reduction potential for BNPB was measured in a tetrahydrofuran solution. A pseudo-reversible reduction peak at −1.88 V was observed, which can be attributed to the reduction of the boron center. Using the reduction and oxidation potentials of BNPB, the HOMO and LUMO energy level of BNPB were calculated to be −5.30 eV and −2.44 eV, respectively, and the bandgap was estimated to be 2.86 eV (see Table 3). The absorption edge of the UV-Vis spectrum of BNPB in CH₂Cl₂ is −430 nm, which corresponds to a bandgap of 2.88 eV, similar to that obtained from the redox potentials. The low LUMO energy level of BNPB is most likely due to the availability of the empty pₙ orbital on the boron center. This value provided preliminary evidence that BNPB would be able to transport electrons in OLEDs.

BNPB emits a blue colour in the solid state (as powders and films) when irradiated by UV light, with emission maximum at 451 nm. In solution, BNPB shows a strongly solvent-dependent emission band. The absorption and excitation spectra of BNPB in various solvents are similar (excitation λₘₐₓ=377 nm). However, the emission spectrum of BNPB shifts toward a longer wavelength with increasing polarity of the solvents. As shown by FIG. 4, the shift of the BNPB emission maximum with solvents is quite dramatic. For example, in the non-polar solvent hexane, the emission λₘₐₓ of BNPB was 418 nm, while in CH₃CN, the emission λₘₐₓ became 513 nm. It is thought that use of the change of emission of BNPB may provide an excellent method of detection of organic molecules, for example, in cases of contamination of soil or water by organic solvents such as benzene, chlorinated benzenes, PCBs (polychlorinated biphenyls), hexanes, toluene, tetrahydrofuran, dichloromethane, acetonitrile, etc. Solvent-dependent emission has been frequently observed for tri-coordinated organoboron compounds and has been attributed to the presence of a highly polarized excited state. Previous studies of related tri-coordinated boron compounds showed that the LUMO is dominated by the empty pₙ orbital of boron and the HOMO is dominated by the π orbitals of the diarylamino group (Jia et al., 2004). The excitation process therefore involves charge transfer from the amino portion to the boron center, resulting in a highly polarized excited state. BNPB is a very bright emitter in both solution and solid state. The quantum yield of BNPB in THF has been determined to be 95% (relative to that of 9,10-diphenylanthracence).

OLEDs that have multiple emission zones are often referred to as tandem OLEDs. Tandem OLEDs or dual emission OLEDs are highly sought-after for achieving highly efficient broadband emission or white light emission. This is typically realized through the insertion of an intermediate conducting layer between two emission layers and the doping of two different colour emitters into separate hosting layers. Device D is a rare example of a dual emission OLED that does not require the doping method and the insertion of a conducting layer. The tri-functionality of BNPB is believed to have made fabrication of the tandem device D possible. BNPB used in combination with emitters other than Alq₃ may allow broadband or white light OLEDs to be fabricated.

### Example 4

### Synthesis of p-(2,2′-dipyridylamino)phenyldimesitylborane (101)

To a solution of p-(2,2′-dipyridylamino)bromobenzene (0.652 g, 2 mmol) in THF (20 mL) was added a hexane solution of n-BuLi (1.6 M, 1.3 mL, 2.08 mmol) at −78° C., and the mixture was stirred for 1 h at that temperature. To the mixture was added a solution of dimesitylboron fluoride (0.595 g, 90%, 2.0 mmol) in Et₂O (20 mL). The reaction mixture was stirred for 1 h at −78° C., allowed to slowly reach room temperature and stirred overnight. The solvents were removed under reduced pressure. The residue was subjected to column chromatography on silica gel (THF/Hexane, 1:2) to afford colourless compound 101 in 87% yield. Mp: 196-198° C.

¹H NMR in CDCl₃(δ, ppm, 25° C.): 8.45 (d, J=3.6, 2H), 7.63 (ddd, J=8.1, 7.5, 1.8, 2H), 7.53 (d, J=8.4, 2H), 7.11 (d, J=8.4, 2H), 7.00-7.05 (m, 4H), 6.84 (s, 4H), 2.32 (s, 6H), 2.08 (s, 12H). ¹³C NMR in CDCl₃ (δ, ppm, 25° C.): 158.2, 149.1, 142.3, 141.4, 139.2, 139.0, 138.9, 138.7, 128.8, 125.1, 119.7, 118.6, 105.8, 24.2, 21.8. Anal. Calcd. for C₃₄H₃₄BN₃: C, 82.46; H, 6.87; N, 8.49. Found: C, 82.26; H, 7.00; N, 8.32. Absorption and Luminescence Data for compound 101 may be found in Table 2.

### Example 5

### Synthesis of p-(2,2′-dipyrldylamino)biphenyldimesitylborane (102)

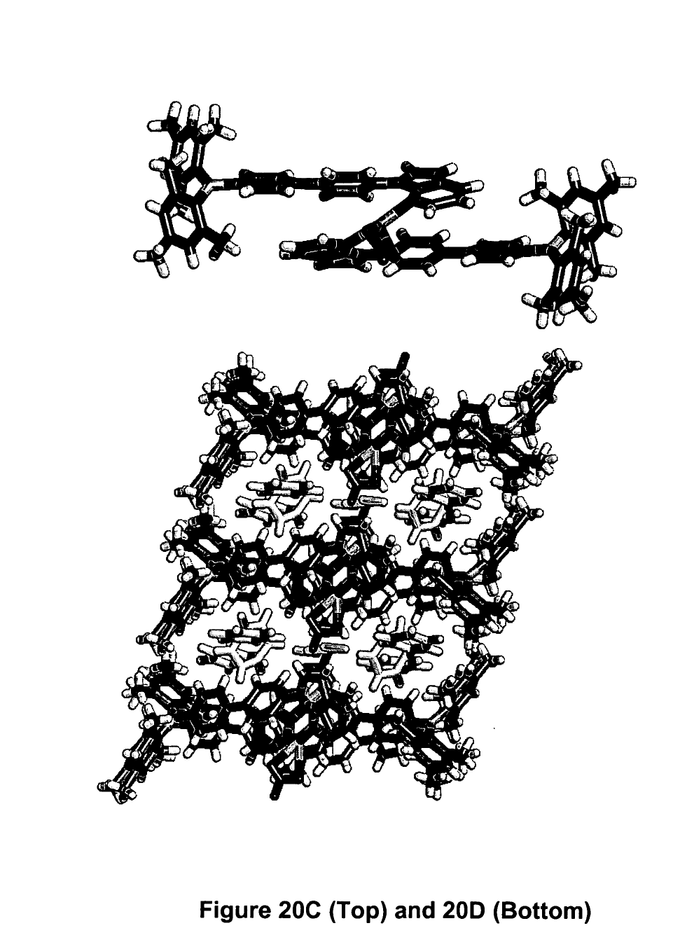

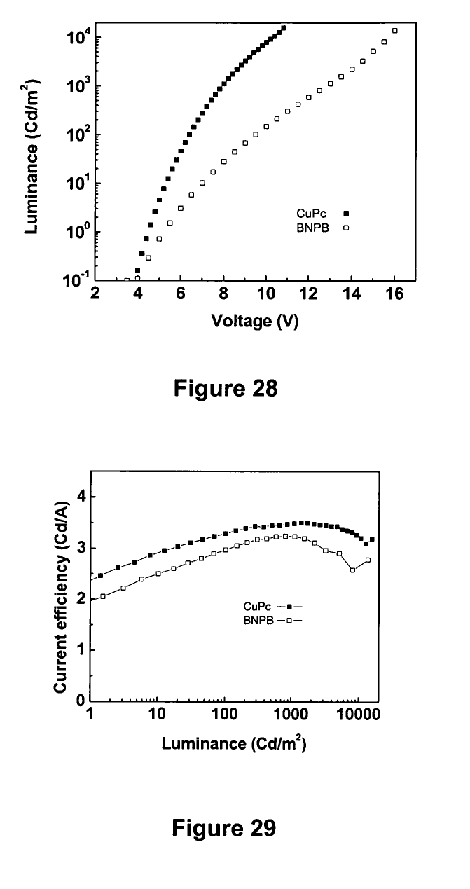

To a solution of p-(2,2′-dipyridylamino)bromobibiphenyl (0.652 g, 2 mmol) in THF (20 mL) was added a hexane solution of n-BuLi (1.6 M, 1.3 mL, 2.08 mmol) at −78° C., and the mixture was stirred for 1 h at that temperature. To the mixture was added a solution of dimesitylboron fluoride (0.595 g, 90%, 2.0 mmol) in Et₂O (20 mL). The reaction mixture was stirred for 1 h at −78° C., allowed to slowly reach room temperature and stirred overnight. The solvents were removed under reduced pressure. The residue was subjected to column chromatography on silica gel (THF/Hexane, 1:2) to afford colourless compound 102 in 90% yield. Mp: 260-261° C. ¹H NMR in CDCl₃ (5, ppm, 25° C.): 8.43 (d, J=3.3, 2H), 7.69 (d, J=8.4, 2H), 7.60-7.65 (m, 6H), 7.29 (d, J=8.4, 2H), 6.98-7.05 (m, 4H), 6.86 (s, 4H), 2.34 (s, 6H), 2.06 (s, 12H). ¹³C NMR in CDCl₃ (5, ppm, 25° C.): 158.7, 149.0, 145.7, 145.0, 144.2, 142.2, 141.3, 139.3, 138.0, 137.9, 137.6, 128.7, 127.8, 126.9, 126.1, 118.9, 117.7, 23.2, 21.5. Anal. Calcd. for C₄₀H₃₈BN3.0.5CH₂Cl₂: C, 79.22; H, 6.36; N, 6.85. Found: C, 79.46; H, 6.68; N, 6.59. Absorption and Luminescence Data for compound 102 may be found in Table 2. The crystal structure of compound 102 is shown in FIG. 14. The absorption and emission photoluminescence spectra of compound 102 are shown in FIG. 19. Photoluminescence and electroluminescence spectra for compound 102 are shown in FIGS. 21-23.

### Example 6

### Synthesis of p-(7-azaindolyl)phenyldimesitylborane (103)

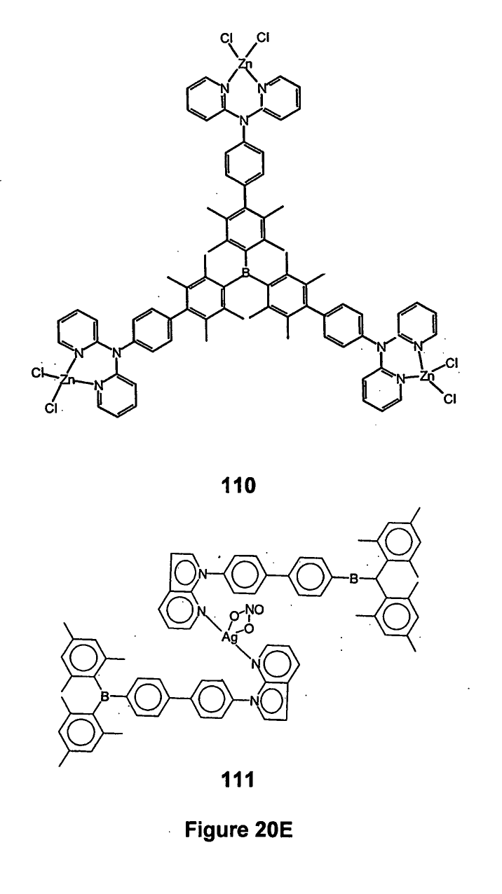

To a solution of p-(7-azaindyl)bromobenzene (0.4 g, 1.47 mmol) in THF (20 mL) was added a hexane solution of n-BuLi (1.6 M, 0.92 mL, 1.47 mmol) at −78° C., and the mixture was stirred for 1 h at that temperature. To the mixture was added a solution of dimesitylboron fluoride (0.436 g, 90%, 1.47 mmol) in Et₂O (20 mL). The reaction mixture was stirred for 1 h at −78° C. and allowed to slowly reach room temperature and stirred overnight. The solvents were removed under reduced pressure. The residue was subjected to column chromatography on silica gel (CH₂COOEt/Hexane, 1:3) to afford colourless compound 103 in 85% yield. Mp: 161-162° C. ¹H NMR in CDCl₃(δ, ppm, 25° C.): 8.42 (d, J=4.8, 1H), 8.01 (dd, J=7.8, 1.5, 1H), 7.89 (d, J=8.1, 2H), 7.71 (d, J=8.1, 2H), 7.63 (d, J=3.6, 1H), 7.18 (dd, J=7.8, 4.8, 1H), 6.86 (s, 4H), 6.68 (d, J=3.6, 1H), 2.35 (s, 6H), 2.08 (s, 12H). ¹³C NMR in CDCl₃ (δ, ppm, 25° C.): 147.6, 143.7, 143.1, 141.8, 141.0, 138.8, 138.1, 129.4, 128.6, 128.4, 128.1, 127.6, 122.4, 117.1, 102.7, 23.7, 21.4. Anal. Calcd. for C₃₁H₃₁BN₂: C, 84.20; H, 7.02; N, 6.34. Found: C, 84.12; H, 7.04; N, 6.30. Absorption and Luminescence Data for compound 103 may be found in Table 2. The crystal structure of compound 103 is shown in FIG. 15.

### Example 7

### Synthesis of p-(7-azaindolyl)blphenyldimesitylborane (104)

To a solution of p-(7-azaindyl)bromobiphenyl (0.5 g, 1.43 mmol) in THF (20 mL) was added a hexane solution of n-BuLi (1.6 M, 0.9 mL, 1.44 mmol) at −78° C., and the mixture was stirred for 1 h at that temperature. To the mixture was added a solution of dimesitylboron fluoride (0.45 g, 90%, 1.5 mmol) in Et₂O (20 mL). The reaction mixture was stirred for 1 h at −78° C., allowed to slowly reach room temperature and stirred overnight. The solvents were removed under reduced pressure. The residue was subjected to column chromatography on silica gel (THF/Hexane, 1:2) to afford colourless compound 104 in 78% yield. Mp: 184-186° C. ¹H NMR in CDCl₃ (δ, ppm, 25° C.): 8.44 (dd, J=4.8, 1.5, 1H), 8.03 (dd, J=7.8, 1.5, 1H), 7.90 (dd, J=6.6, 2.1, 2H), 7.83 (dd, J=6.6, 2.1, 2H), 7.63-7.67 (m, 4H), 7.59 (d, J=3.6, 1H), 7.19 (dd, J=7.8, 4.8, 1H), 6.87 (s, 4H), 6.70 (d, J=3.6, 1H), 2.35 (s, 6H), 2.08 (s, 12H). ¹³C NMR in CDCl₃(δ, ppm, 25° C.): 147.8, 144.2, 144.0, 142.5, 141.2, 139.5, 139.3, 138.6, 137.8, 130.2, 129.0, 128.9, 128.8, 128.5, 127.2, 124.8, 122.6, 117.5, 102.7, 24.2, 21.9. Anal. Calcd. for C₃₇H₃₅BN₂: C, 85.71; H, 6.76; N, 5.40. Found: C, 85.37; H, 6.96; N, 4.88. Absorption and Luminescence Data for compound 104 may be found in Table 2.

### Example 8

### Synthesis of 3,5-bis(2,2′-dipyridylamino)phenyldimesitylborane (105) and 3,5-bis(7-azaindolyl)phenyldimesitylborane (106)

Part 1 of Example 8: Synthesis of 3,5-bis(2,2′-dipyridylamino)bromobenzene (5a)

A mixture of 2,2′-dipyridylamine (2.4 g, 14.1 mmol), 1,3,5-tribromobenzene (2.2 g, 7.0 mmol), CuSO₄.5H₂O (0.17 g) and K₂CO₃ (2.9 g, 21.0 mmol) was heated under N₂ at 206° C. for 8 h. The mixture was extracted with CH₂Cl₂ (3×25 mL) and the solvent was removed in vacuo. The residue was passed through a column on silica gel using ethyl acetate/Hexane (6:1) as the eluent. The first collection was 1,3-dibromo-5-(2,2′-dipyridylamino)benzene (11% yield), The second collection was the target compound 3,5-bis(2,2′-dipyridylamino)bromobenzene (43% yield). The third collection was 1,3,5-tris(2,2′-dipyridylamino)benzene (14% yield). ¹H NMR of 3,5-bis(2,2′-dipyridylamino)bromobenzene in CDCl₃(δ, ppm, 25° C.): 8.37 (dd, J=5.1, 1.2, 4H), 7.62 (ddd, J=8.4, 7.5, 1.8, 4H), 7.12 (d, J=1.8, 2H), 7.06 (dt, J=8.4, 0.9, 4H), 6.99 (ddd, J=7.2, 5.1, 0.9, 4H), 6.92 (t, J=1.8, 1H). ¹H NMR of 1,3-dibromo-5-(2,2′-dipyridylamino)benzene in CDCl₃(δ, ppm, 25° C.): 8.39 (d, J=3.7, 2H), 7.65 (ddd, J=8.1, 7.5, 1.9, 2H), 7.48 (t, J=1.8, 1H), 7.25 (d, J=1.8, 2H), 7.00-7.06 (m, 4H).

Part 2 of Example 8: Synthesis of 3,5-bis(2,2′-dipyridylamino)phenyldimesityl-borane (105)

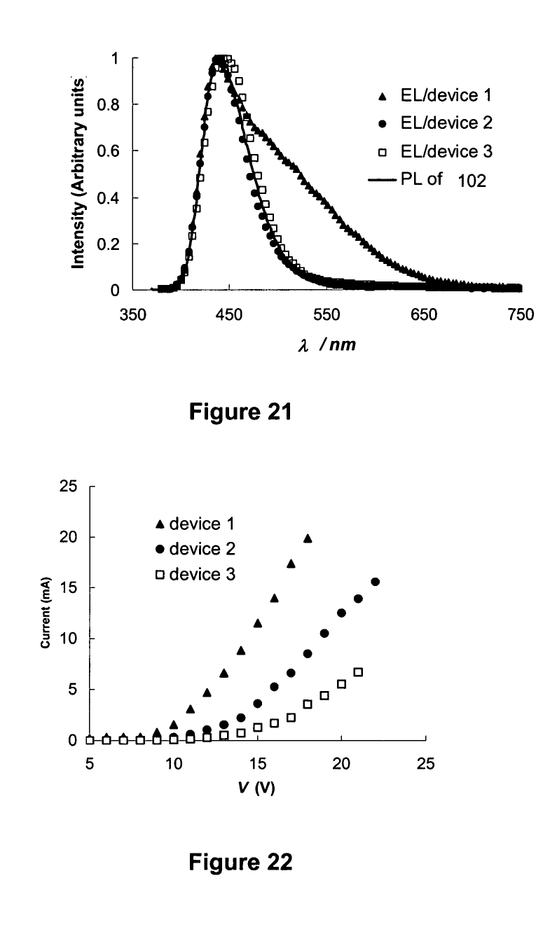

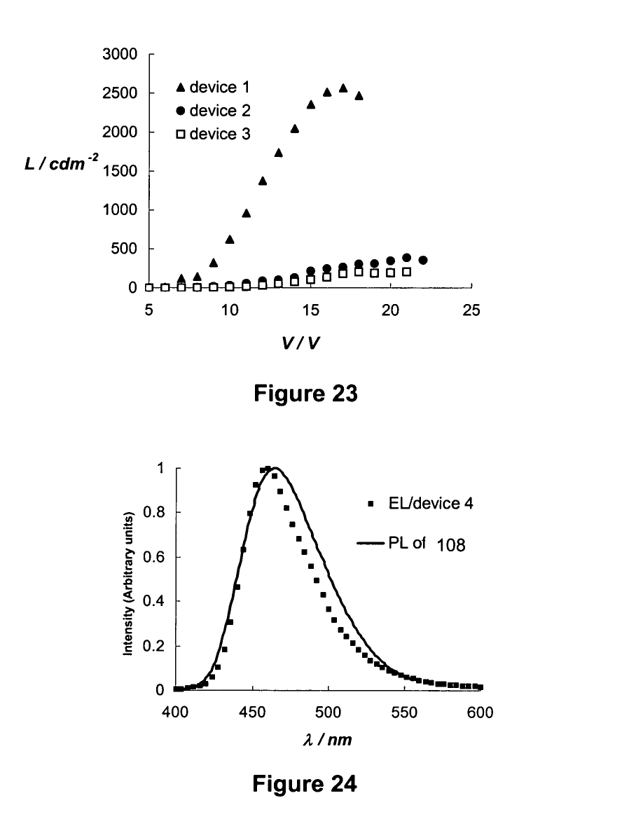

To a solution of 3,5-bis(2,2′-dipyridylamino)bromobenzene (5a) (0.31 g, 0.63 mmol) in THF (20 mL) was added a hexane solution of n-BuLi (1.6 M, 0.4 mL, 0.64 mmol) at −78° C., and the mixture was stirred for 1 h at that temperature. To the mixture was added a solution of dimesitylboron fluoride (0.2 g, 90%, 0.67 mmol) in Et₂O (20 mL). The reaction mixture was stirred for 1 h at −78° C., allowed to slowly reach room temperature and stirred overnight. The solvents were removed under reduced pressure. The residue was subjected to column chromatography on silica gel (THF/Hexane, 1:2) to afford colourless compound 105 in 58% yield. Mp: 224-226° C. ¹H NMR in CDCl₃(δ, ppm, 25° C.): 8.30 (dd, J=4.8; 1.2, 4H), 7.53 (ddd, J=8.4, 6.6, 1.8, 4H), 7.14 (t, J=2.1, 1H), 7.11 (d, J=2.1, 2H), 6.98 (d, J=8.4, 4H), 6.90 (dd, J=6.6, 5.1, 4H), 6.72 (s, 4H), 2.25 (s, 6H), 2.04 (s, 12H). ¹³C NMR in CDCl₃ (δ, ppm, 25° C.): 158.3, 149.6, 148.8, 146.2, 142.0, 141.4, 139.5, 138.2, 131.9, 129.6, 128.8, 118.9, 117.6, 24.1, 21.8. Anal. Calcd. for C₄₄H₄₁BN₆: C, 79.54; H, 6.18; N, 12.65. Found: C, 78.85; H, 6.11; N, 12.51. Absorption and Luminescence Data for compound 105 may be found in Table 2. The crystal structure of compound 105 is shown in FIGS. 16a and 16b.

Part 3 of Example 8: Synthesis of 3,5-bis(7-azaindolyl)phenyldimesitylborane (106)

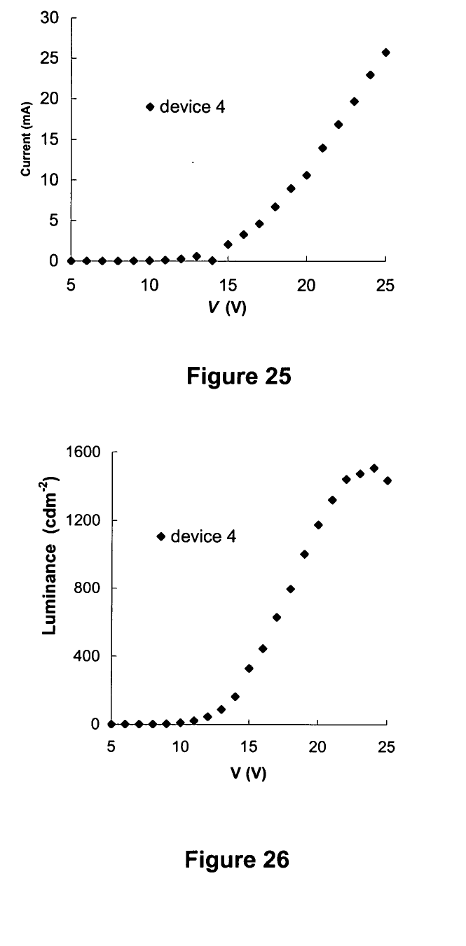

To a solution of 3,5-bis(7-azaindyl)bromobenzene (5b) (Wu et al., 2001) (0.278 g, 0.72 mmol) in THF (20 mL) was added a hexane solution of n-BuLi (1.6 M, 0.45 mL, 0.72 mmol) at −78° C., and the mixture was stirred for 1 h at that temperature. To the mixture was added a solution of dimesitylboron fluoride (0.22 g, 90%, 0.74 mmol) in Et₂O (20 mL). The reaction mixture was stirred for 1 h at −78° C., allowed to slowly reach room temperature and stirred overnight. The solvents were removed under reduced pressure. The residue was subjected to column chromatography on silica gel (CH₃COOEt/Hexane, 1:3) to afford colourless compound 106 in 67% yield. Mp: 196-198° C. ¹H NMR in CDCl₃(δ, ppm, 25° C.): 8.83 (t, J=2.1, 1H), 8.34 (dd, J=4.8, 1.5, 2H), 7.98 (dd, J=7.8, 1.5, 2H), 7.73 (d, J=2.1, 2H), 7.54 (d, J=3.6, 2H), 7.13 (dd, J=7.8, 4.8, 2H), 6.87 (s, 4H), 6.63 (d, 3.6, 2H), 2.34 (s, 6H) 2.15 (s, 12H). ¹³C NMR in CDCl₃(δ, ppm, 25° C.): 148.2, 144.2, 141.8, 141.7, 139.9, 139.8, 129.7, 129.2, 129.1, 128.9, 128.7, 124.0, 122.3, 117.4, 102.4, 24.4, 22.0. Absorption and Luminescence Data for compound 106 may be found in Table 2. Anal. Calcd. for C₃₈H₃₅BN₄.0.5CH₂Cl₂: C, 76.97; H, 6.00; N, 9.33. Found: C, 76.97; H, 6.17; N, 9.19. The crystal structure of compound 106 is shown in FIG. 17.

### Example 9

### Synthesis of p-[3,5.bis(2,2′-dipyridylamino)phenyl]phenyldimesitylborane (107)

Part 1 of Example 9: Synthesis of p-bromophenyldimesitylborane (7a)

To a solution of 1,4-dibromobenzene (0.47 g, 2 mmol) in Et₂O (50 mL) was added a hexane solution of n-BuLi (1.6 M, 1.3 mL, 2.08 mmol) at −78° C., and the mixture was stirred for 1 h at that temperature. To the mixture was added a solution of dimesitylboron fluoride (0.595 g, 90%, 2.0 mmol) in Et₂O (20 mL). The reaction mixture was stirred for 1 h at −78° C., allowed to slowly reach room temperature and stirred overnight. The solvents were removed under reduced pressure. The residue was subjected to column chromatography on silica gel (THF/Hexane, 1:2) to afford colourless compound 7a in 81% yield. ¹H NMR in CDCl₃(δ, ppm, 25° C.): 7.51 (d, J=4.2, 2H), 7.40 (d, J=4.2, 2H), 6.84 (s, 4H), 2.33 (s, 6H), 2.01 (s, 12H).

Part 2 of Example 9: Synthesis of p-[3,5-bis(2,2′-dipyridylamino)phenyl]phenyl-dimesitylborane (107)

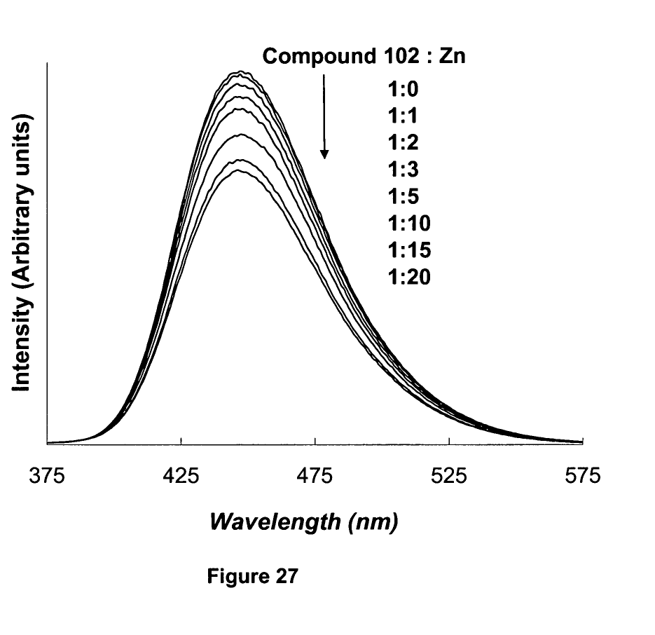

To a THF (20 mL) solution of p-bromophenyldimestylborane (7a) (0.410 g, 1.0 mmol) was added a hexane solution of nBuLi (1.6 M, 0.73 mL, 1.2 mmol) at −78° C. After being stirred for 1 h at this temperature, the cold mixture was cannulated into a solution of B(OMe)₃ (0.3 mL, 3.6 mmol) in THF (20 mL) at −78° C. After the mixture was stirred for another 1 h at −78° C., it was warmed to ambient temperature and stirred overnight. The solution was partitioned between saturated aqueous NH₄Cl (30 mL) and CH₂Cl₂ (30 mL). The aqueous layer was extracted further with CH₂Cl₂ (2×30 mL) and the combined organic layers were dried over MgSO₄. The product was purified by flash chromatography (THF:hexane, 1:2) to provide the boronic acid in 60% yield. A mixture of 3,5-bis(2,2′-dipyridylamino)bromobenzene (0.125 g, 0.25 mmol), Pd(PPh₃)₄ (0.025 g, 0.022 mmol), and toluene (40 mL) was stirred for 10 min. The above boronic acid (185 mg, 0.5 mmol) in 20 mL of EtOH and NaOH (0.8 g) in 20 mL of H₂O were subsequently added. The mixture was stirred and refluxed for 40 h and allowed to cool to room temperature. The water layer was separated and extracted with CH₂Cl₂ (3×30 mL). The combined organic layers were dried over MgSO₄, and the solvents were evaporated under reduced pressure. Purification of the crude product by column chromatography (THF:hexane, 2:1) afforded 107 as a colourless solid in 21% yield. Mp: 141-143° C. ¹H NMR in CDCl₃(δ, ppm, 25° C.): 8.35 (d, J=3.3, 4H), 7.59 (t, J=7.2, 4H), 7.51 (d, J=8.1, 2H), 7.44 (d, J=8.1, 2H), 7.29 (d, J=1.8, 2H), 7.13 (d, J=8.1, 4H), 7.00 (t, J=1.8, 1H), 6.96 (t, J=6.0, 4H), 6.82 (s, 4H), 2.32 (s, 6H), 2.00 (s, 12H) ¹³C NMR in CDCl₃(δ, ppm, 25° C.): 158.2 148.9, 146.7, 145.3, 143.8, 143.6, 142.1, 141.2, 139.0, 138.1, 137.2, 128.6, 127.0, 124.8, 122.5, 118.9, 117.85, 23.8, 23.6 Anal. Calcd. for C₅₀H₄₅BN₆.0.3CH₂Cl₂ C, 78.85; H, 5.98; N, 10.97. Found: C, 79.07; H, 5.83; N, 10.87. Absorption and Luminescence Data for compound 107 may be found in Table 2. The crystal structure of compound 107 is shown in FIG. 18.

### Example 10

### Synthesis of 5-[p-(2,2′-dipyridylamino)phenyl]-2-thienyldimesitylborane (108)

Part 1 of Example 10: Synthesis of p-(2,2′-dipyridylamino)-2-thienylbenzene (8a)

To a THF (10 mL) solution of Pd(PPh₃)₂Cl₂ (0.11 g, 0.157 mmol) was added diisobutylaluminum hydride (1.0 M in hexane, 0.32 mL, 0.32 mmol). After the solution being stirred for 10 min. p-(2,2′-dipyridylamino)bromobenzene (1.31 g, 4 mmol) in 10 mL of THF was added. After additional 10 min. stirring, 2-thienylzinc bromide (0.50 M in THF, 9 mL, 4.5 mmol) was slowly added by syringe and the mixture refluxed for 6 h. The mixture was cooled to room temperature and poured into a saturated aqueous solution of Na₂CO₃. The aqueous phase was extracted with CH₂Cl₂ (3×20 mL), and the organic extracts were concentrated to give a brown residue which was purified by column using THF/Hexanes (2:3) as the eluent to obtain 8a (yield 63%). ¹H NMR in CDCl₃ (δ, ppm, 25° C.): 8.39 (dd, J=5.1, 1.2, 2H), 7.57-7.64 (m, 4H), 7.29 (dd, J=3.6, 2.1, 2H), 7.22 (dt, J=8.4, 1.8, 2H), 7.09 (dd, J=5.1, 3.6, 1H), 7.05 (d, J=8.4, 2H), 6.98 (ddd, J=7.2, 5.1, 0.9, 2H).

Part 2 of Example 10: Synthesis of p-(2,2′-dipyridylamino)phenyl-2-bromo-5-thiophene (8b)

2,5-dibromothiophene (0.70 g, 2.89 mmol), Pd(PPh₃)₄ (0.016 g, 0.014 mmol) and 40 mL toluene was stirred for 10 min, then p-(2,2′-dipyridylamino)phenylboronic acid (0.88 g, 2.75 mmol) in 15 mL of EtOH and Na₂CO₃ (0.60 g) in 20 mL of water were added. The mixture was refluxed for 24 h. After cooled to room temperature, the aqueous phase was extracted with CH₂Cl₂ (25 mL×3). The extracts were concentrated to give a yellow residue which was purified by column chromatograph using THF/Hexanes (1:1) as the eluent to obtain 0.90 g of 8b (80% yield). ¹H NMR in CDCl₃(δ, ppm, 25° C.): 8.36 (dd, J=4.8, 1.2, 2H), 7.50-7.64 (m, 4H), 7.29 (d, J=9.9, 1H), 7.21 (ddd, J=8.7, 4.5, 2.1, 2H), 7.02-7.10 (m, 3H), 6.96 (ddd, J=7.2, 4.8, 0.9, 2H).

Part 3 of Example 10: Synthesis of 5-[p-(2,2′-dipyridylamino)phenyl]-2-thienyldimesitylborane (108)

From 8a: To a solution of 8a (0.342 g, 0.98 mmol) in THF (20 mL) was added a hexane solution of n-BuLi (1.6 M, 0.65 mL, 1.04 mmol) at −78° C., allowed slowly to reach room temperature and stirred for 1 h at room temperature. To the mixture was added a solution of dimesitylboron fluoride (0.32 g, 90%, 1.08 mmol) in Et₂O (20 mL). The reaction mixture was stirred overnight. The solvents were removed under reduced pressure. The residue was subjected to column chromatography on silica gel (THF/Hexane, 1:2) to afford pale yellow compound 108 in 25% yield.

From 8b: To a solution of 8b (0.4 g, 0.98 mmol) in THF (20 mL) was added a hexane solution of n-BuLi (1.6 M, 0.67 mL, 1.08 mmol) at −78° C., and the mixture was stirred for 1 h at that temperature. To the mixture was added a solution of dimesitylboron fluoride (0.32 g, 90%, 1.08 mmol) in Et₂O (20 mL). The reaction mixture was stirred for 1 h at −78° C., allowed to slowly reach room temperature and stirred overnight. The solvents were removed under reduced pressure. The residue was subjected to column chromatography on silica gel (THF/Hexane, 1:2) to afford yellow-green compound 108 in 62% yield.

108: Mp: 193-194° C. ¹H NMR in CDCl₃(δ, ppm, 25° C.): 8.38 (d, J=3.6, 2H), 7.68 (d, J=8.4, 2H), 7.60 (ddd, J=8.1, 7.2, 1.8, 2H), 7.43-7.46 (m, 2H), 7.20 (d, J=8.4, 2H), 7.05 (d, J=8.1, 2H), 6.98 (dd, J=7.2, 2.1, 2H), 6.89 (s, 4H), 2.39 (s, 6H), 2.18 (s, 12H). ¹³C NMR in CDCl₃ (δ, ppm, 25° C.): 158.5, 157.3, 150.0, 149.3, 145.8, 142.4, 141.9, 141.5, 139.2, 138.4, 131.8, 128.9, 128.1, 127.7, 125.9, 119.2, 117.9, 24.1, 21.9. Anal. Calcd. for C₃₈H₃₈BSN₃.0.5CH₂Cl₂: C, 74.57; H, 5.97; N, 6.78. Found: C, 74.70; H, 6.48; N, 6.24. Absorption and Luminescence Data for compound 108 may be found in Table 2. Photoluminecence and electroluminescence spectra of compound 108 are shown in FIGS. 24-26.

### Example 11

### Synthesis of (p-(2,2 dipyridylamino)biphenyldimesitylborane){Zn(CF₃COO)₂} (110)

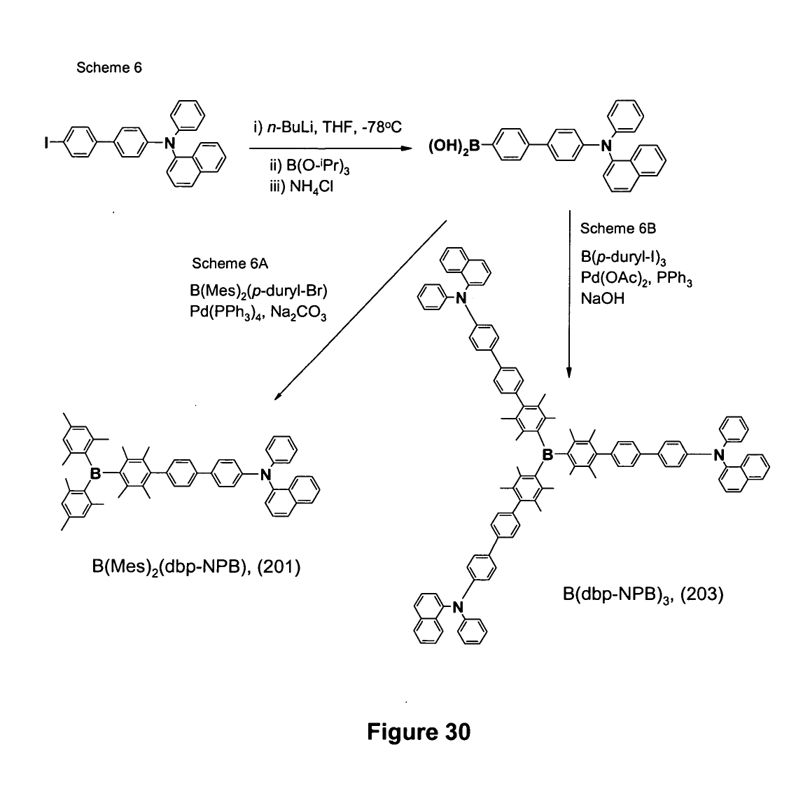

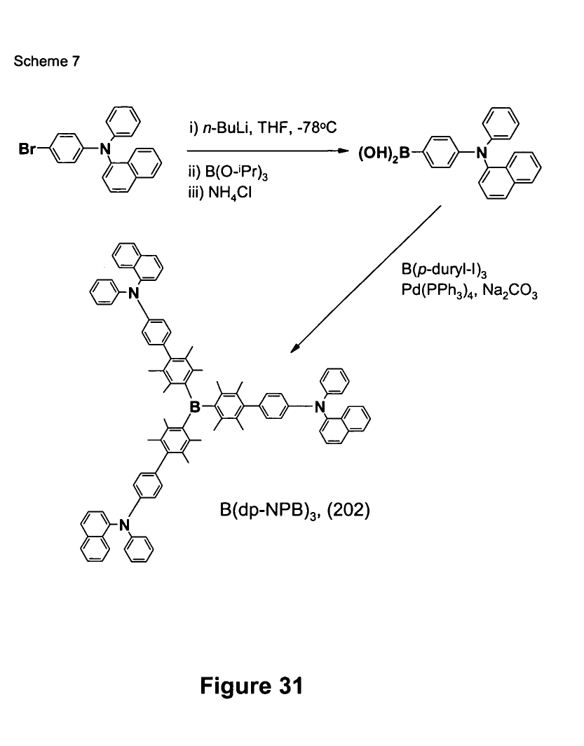

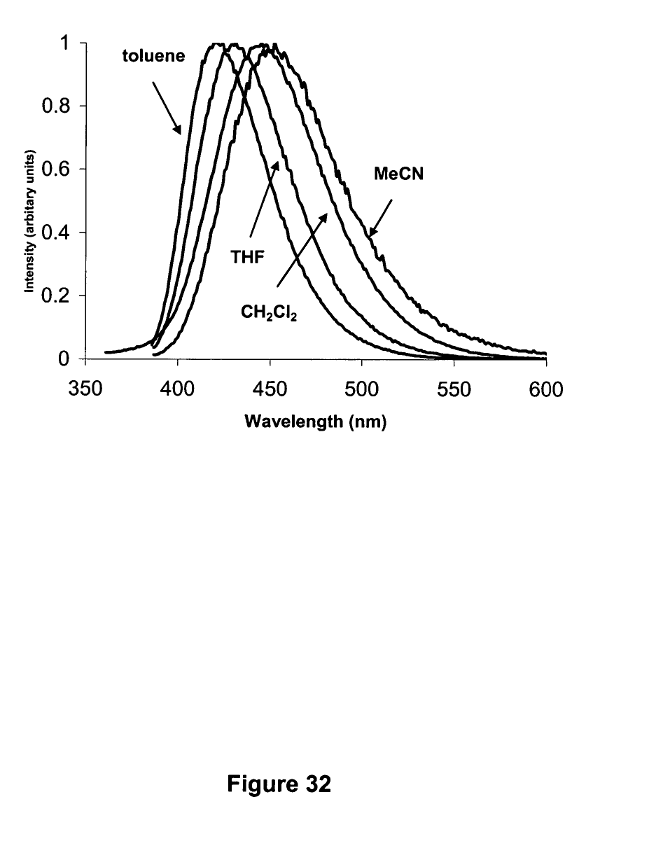

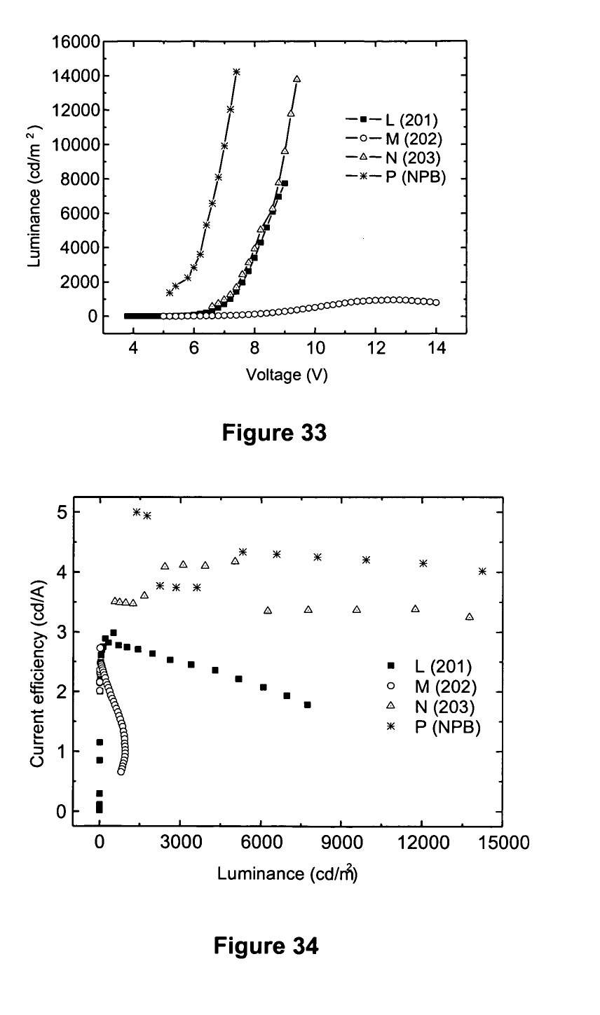

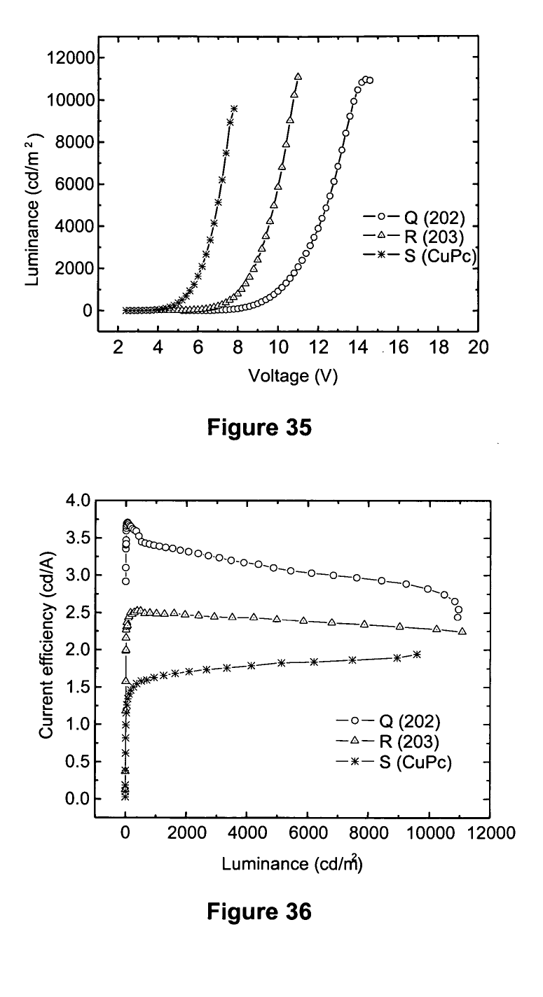

A mixture of compound 102 (20 mg, 0.035 mmol) and Zn(CF₃COO)₂.3H₂O (0.0108 g, 0.037 mmol) were dissolved in a minimum THF, then a few drops of benzene was layered. After the solution was allowed to stand for a few days, a colourless crystal of compound 110 (see structure in FIG. 20E) was obtained in 59% yield. Mp: 158-160° C. ¹H NMR in CD₂Cl₂(δ, ppm, 25° C.): 8.67 (d, J=4.2, 2H), 8.00 (d, J=8.4, 2H), 7.83 (ddd, J=9.0, 7.2, 1.8, 2H), 7.73 (d, J=8.1, 2H), 7.64 (m, 4H), 7.31 (t, J=6.0, 2H), 6.96 (d, 9.0, 2H), 6.89 (s, 4H). ¹³C NMR in CDCl₃(δ, ppm, 25° C.): 155.4, 146.8, 142.2, 141.5, 140.8, 140.3, 139.6, 139, 138.4, 136.6, 130.1, 129.8, 128.6, 127.8, 126.2, 118.8, 116.6. “F NMR (δ, ppm, 25° C.): −75.71. Anal. Calcd. for C₄₄H₃₈BF₆N₃O₄Zn.C₆H₆: C, 63.83; H, 4.68; N, 4.47. Found: C, 63.82; H, 4.79; N, 4.45. The crystal structure of compound 110 is shown in FIG. 20A and its unit packing cell is shown in FIG. 20B. The solvent molecules trapped in this unit cell provides evidence of the ability of this molecule to trap and detect organic molecules.

### Example 12

### Synthesis of {p-(7-azaindolyl)biphenyldimesitylborane}₂(AgNO₃) (111)

A minimal amount of dichloromethane was used to dissolve 50 mg (0.0964 mmol) of compound 104. One molar equivalent (18 mg) of AgNO₃ was dissolved in a minimal amount of methanol. The two solutions were mixed and layered with benzene. Light yellow crystals of 111 (see structure in FIG. 20E) formed after the solution was kept at ambient temperature for one week (37% yield). ¹H NMR in CDCl₃ (5, ppm, 25° C.): 8.23 (dd, J=4.95, 1.27 Hz, 1H), 7.85 (dd, J=7.75, 1.25 Hz, 1H), 7.59 (m, 4H), 7.50 (d, J=8.50 Hz, 2H), 7.40 (m, 3H), 6.94 (dd, J=7.85, 5.25 Hz, 1H), 6.896 (s, 4H), 6.66 (d, J=3.5 Hz, 1H), 2.37 (s, 6H), 2.10 (s, 12H). ¹³C NMR (δ, ppm, 25° C.): 145.9, 145.7, 145.4, 142.3, 142.1, 141.2, 140.4, 139.2, 137.3, 135.5, 131.4, 129.5, 128.7, 126.7, 125.1, 123.0, 117.4, 23.9, 21.7. Anal. Calcd. for C₇₄H₇₀B₂N₅O₃Ag.0.5C₆H₆: C, 74.22; H, 5.62; N, 5.62. Found: C, 74.03; H, 5.91; N, 5.32. The crystal structure of compound 111 is shown in FIG. 20C and its unit packing cell is shown in FIG. 20D. The solvent molecules trapped in this unit cell provides evidence of the ability of this molecule to trap and detect organic molecules.

### Example 13

### X-Ray Crystallographic Analysis

Single crystals of 101, 103, 105-107 were obtained from solutions of CH₂Cl₂ and hexane. Attempts to grow single crystals of 102 and 104 by the same procedure were unsuccessful. Crystals of 110 and 111 were obtained from slow diffusion of benzene/hexane into THF solutions. All crystals were mounted on glass fibers for data collection. Data were collected on a Siemens P4 single-crystal X-ray diffractometer with a CCD-1000 detector and graphite-monochromated Mo Ka radiation, operating at 50 kV and 30 mA. Except the data of compound 111 which was collected at 180 K, all data collection was carried out at ambient temperature. Details of the X-ray crystallographic analysis of compounds 101-111 can be found in Jia, 2004 which is hereby incorporated by reference.

### Example 14

### Fabrication of Electroluminescent Devices of Compounds 101-108

Compound 102 was chosen as the representative example of compounds 101-107 for the study of EL properties since compound 102 had the highest melting point, the highest Tg (132° C.) and it was the brightest emitter of these compounds with an emission maximum at 450 nm in CH₂Cl₂ and at 440 nm in the solid state, the ideal blue emission region. Details of the HOMO and LUMO levels of the compounds 101-108 are presented in Table 3. These features make compound 102 the best candidate as a blue emitter for OLEDs among compounds 101-107. The data for EL devices 14 are summarized in Table 1A.

EL devices using 102 or 108 as the emitting layer and the electron transport layer were fabricated on an indium-tin oxide (ITO) substrate. Organic layers were deposited on the substrate by conventional vapor vacuum deposition. Prior to the deposition, all organic materials were purified via a train sublimation method.

### Example 14A

### Preparation of Two-Layer EL Device 1

A two-layer EL device was prepared which used NPB as the hole transport layer and compound 102 as both the emitter and the electron transpoort layer. The configuration of this device was ITO/NPB (40 nm)/102 (40 nm)/LiF (2 nm)/Al. This device produced a bright whitish-blue emission with the EL maximum at 436 nm. The turn-on voltage of device 1 was 5 V and the maximum luminance was 2566 cd/m² at 17 V, indicating that device 1 was efficient and bright (see FIG. 21-23). The fact that no electron transport material was used for device 1 supports that the boron compound 102 can function as an emitter and an electron transport material as well. The broad shoulder in the 500-700 nm region of the EL spectrum of device 1 is believed to originate from exciplex emission between the NPB and compound 102.

### Example 14B

### Preparation of Two-Layer EL Device 2

To address and remove the exciplex emission of device 1, device 2 was constructed where a hole blocking layer, bicarbazole, was inserted between the NPB layer and compound 102 (ITO/NPB (40 nm)/Bicarb (20 nm)/102 (40 nm)/LiF (1 nm)/Al). As shown in FIG. 21, the EL spectrum of device 2 matches very well with the PL spectrum of 102, confirming that the broad shoulder emission in device 1 is indeed from exciplex between NPB and compound 102. The turn-on voltage for device 2 was 6 V and the maximum brightness is 388 cd/m² at 21 V.

### Example 14C

### Preparation of Three-Layer EL Device 3

To further improve the efficiency of the device, an electron transport layer, PBD (2-(4-biphenyl)-5-(4-tert-butylphenyl)-1,3,4-oxadiazole), was added in device 3 (ITO/NPB (40 nm)/Bicarb (20 nm)/102 (40 nm)/PBD (20 nm)/LiF (1 nm)/Al. The EL spectrum of device 3 is the same as the EL spectrum of device 2. Compared to device 2, device 3 is much less efficient (turn-on voltage, 7 V, maximum brightness, 208 ca/m² at 21V). This could be due to the fact that the LUMO level (−2.4 eV) of PBD is slightly above that (−2.5 eV) of 102, which makes PBD an ineffective electron transport material for the boron compound.

### Example 14D

### Preparation of Two-Layer EL Device 4

Based on the EL information obtained for compound 102, one type of EL devices (device 4) for compound 108 was fabricated. Device 4 consists of ITO/NPB (40 nm)/bicarb (20 nm)/108 (40 nm)/LiF (1 nm)/Al. Device 4 produced a bright blue emission with the EL maximum at 460 nm. The EL spectrum of device 4 and the PL spectrum of 108 match very well (FIG. 24). The turn-on voltage of device 4 is 7 V (FIG. 25-26). The maximum brightness is 1510 cd/m² at 24 V.

### Example 15

### Synthesis of 4-(1-naphthylphenylamino)-4′-biphenylduryidimesitylborane (201), Tris[p-(1-naphthylphenylamino)phenylduryl]borane (202), and Tris[p-(1-naphthylphenylamino)biphenylduryl]borane (203)

Schemes for the synthesis of compounds 201-203 are shown in FIGS. 30 and 31 and were performed using Suzuki coupling methods. Tri(p-iododuryl)borane (Yamaguchi et al., 2000), (p-bromoduryl)dimesitylborane (Yamaguchi et al., 2000), 4-iodo-4′-(1-naphthylphenylamino)-biphenyl (Koene et al., 1998), and 4-(1-naphthylphenylamino)-bromobenzene (Koene et al., 1998) were synthesized by modified literature methods.

### Example 15A

### Synthesis of 4-(1-naphthylphenylamino)-4′-biphenylduryidimesityl-borane (201)

To a THF (50 mL) solution of 4-iodo-4′-(1-naphthylphenylamino)biphenyl (0.994 g, 2.0 mmol) was added a hexane solution of n-BuLi (1.6 M, 1.38 mL, 2.2 mmol) at −78° C. After being stirred for 1 h at −78° C., the mixture was transferred into a −78° C. solution of B(OPrⁱ)₃ (0.76 mL, 3,3 mmol) in tetrahydrofuran (20 mL). After the mixture was stirred for 1 h at −78° C., it was allowed to warm to ambient temperature and was stirred overnight. The solution was partitioned between saturated aqueous NH₄Cl (50 mL) and CH₂Cl₂ (30 mL). The aqueous layer was extracted with dichloromethane (2×30 mL) and the combined organic layers were dried over MgSO₄. The solvents were removed under reduced pressure. 0.750 g of the boronic acid was obtained in 90% yield. A mixture of (p-bromoduryl)dimesitylborane (0.400 g, 0.87 mmol), Pd(PPh₃)₄ (0.030 g, 0.026 mmol), and toluene (50 mL) was stirred for 10 min. The above boronic acid (0.400 g, 0.96 mmol) in 6 mL of EtOH and Na₂CO₃ (1.06 g) in 10 mL of H₂O were subsequently added. The mixture was stirred and refluxed for 24 h and then allowed to cool to room temperature. The aqueous layer was separated and extracted with CH₂Cl₂ (3×30 mL). The combined organic layers were dried over MgSO₄, and the solvents were evaporated under reduced pressure. Purification of the crude product by column chromatography (CH₂Cl₂/hexane, 1:4) afforded 201 as a colorless solid in 77% yield. T_{g}: 110° C. ¹H NMR in CDCl₃ (8, ppm, 25° C.): 8.01 (d, J=8.5, 1H), 7.93 (d, J=8.5, 1H), 7.82 (d, J=8.5, 1H), 7.63 (d, J=8.0, 2H), 7.56-7.50 (m, 4H), 7.42-7.40 (m, 2H), 7.27-7.24 (m, 2H), 7.17 (d, J=8.0, 2H), 7.14-7.12 (m, 4H), 7.00 (t, J=7.5, 1H), 6.79 (s, 4H), 2.31 (s, 6H), 2.08 (s, 6H), 2.06 (s, 6H), 2.02 (s, 6H), 1.89 (s, 6H). ¹³C NMR in CD₃Cl (δ, ppm, 25° C.): 148.76, 148.12, 147.90, 145.21, 143.91, 143.15, 142.16, 141.21, 139.50, 138.71, 135.74, 135.55, 134.42, 131.66, 130.36, 129.56, 129.20 (two different carbon atoms), 129.08, 128.83, 127.93, 127.64, 126.93, 126.84, 126.78 (two different carbon atoms), 126.60, 124.76, 122.56, 122.29 (three different carbon atoms). Anal. Calcd. for C₅₆H₅₄BN: C, 89.50; H, 7.19; N, 1.86. Found: C, 89.17; H, 7.43; N, 1.89.

### Example 15B

### Synthesis of Tris[p-(1-naphthylphenylamino)phenylduryl]borane (202)

This compound was obtained by the same procedure as described for 201. From 4-(1-naphthylphenylamino)bromobenzene, 4-(1-naphthylphenylamino)phenylboronic acid was obtained in 96% yield. From the reaction of tri(p-iododuryl)borane (0.600 g, 0.76 mmol), Pd(PPh₃)₄ (0.087 g, 0.075 mmol), 4-(1-naphthylphenylamino)phenylboronic acid (0.850 g, 2.51 mmol) and Na₂CO₃ (0.530 g, 5 mmol), compound 202 was obtained in 80% yield. T_{g}: 171° C. ¹H NMR in CDCl₃(δ, ppm, 25° C.): 8.02 (d, J=8.5, 3H), 7.91(d. J=8.0, 3H), 7.80 (d, J=8.0, 3H), 7.50-7.46 (m, 6H), 7.43-7.37 (m, 6H), 7.25-7.21 (m, 6H), 7.11-7.08 (m, 12H), 6.97-6.93 (m, 9H), 2.06 (m, 18H), 1.91 (m, 18H). ¹³C NMR in CDCl₃(δ, ppm, 25° C.): 149.24, 149.09, 146.86, 144.21, 143.15, 137.39, 136.08, 135.73, 131.84, 131.69, 130.65, 129.45, 128.77, 127.51, 126.77, 126.68, 126.60, 126.48, 124.86, 122.25, 121.96, 121.72, 20.61, 18.39. Anal. Calcd. for C₉₆H₈₄BN₃: C, 89.37; H, 6.52; N, 3.26. Found: C, 89.05; H, 6.66; N, 3.19.

### Example 15C

### Synthesis of Tris[p-(1-naphthylphenylamino)biphenylduryl]-borane (203)

This compound was obtained by the same procedure as described for 201. From the reaction of tri(iododuryl)borane (0.538 g, 0.746 mmol), Pd(OAc)₂ (0.025 g, 0.11 mmol), PPh₃ (0.060 g, 0.23 mmol), p-(1-naphthylphenylamino)biphenylboronic acid (1.020 g, 2.46 mmol) and NaOH(1.600 g, 4.00 mmol), compound 203 was obtained as a colorless solid in 57% yield. T_{g}: 173° C. ¹H NMR in CDCl₃ (δ, ppm, 25° C.): 8.00 (d, J=8.5, 3H), 7.93 (d, J=8.0, 3H), 7.81 (d, J=8.0, 3H), 7.63 (d, J=8.0, 6H), 7.56-7.48 (m, 12H), 7.41-7.38 (m, 6H), 7.26-7.23 (m, 6H), 7.19 (d, J=8.0, 6H), 7.13 (m, 12H), 6.99 (t, J=7.5, 3H), 2.12 (s, 18H), 1.92 (s, 18H). ¹³C NMR in CDCl₃ (δ, ppm, 25° C.): 149.37, 148.75, 148.11, 143.90, 143.22, 142.31, 138.67, 136.15, 135.73, 134.42, 131.67, 131.66, 130.34, 129.56, 128.81, 127.92, 127.63, 127.42, 126.91, 126.82, 126.77, 126.56, 124.72, 122.54, 122.28, 122.11. Anal. Calcd. for C₁₁₄H₉₆BN₃.1/7CH₂Cl₂: C, 89.65; H, 6.29; N, 2.75. Found: C, 89.36; H, 6.23; N, 2.68.

### Example 16

### X-Ray and NMR Studies of Compounds 201-203

Efforts to obtain single crystals of compounds 201-203 that were suitable for X-ray diffraction analysis were unsuccessful. Compounds 201-203 are amorphous solids and no melting points were observed, which may be due to the coexistence of structural isomers in the solid state. The ortho methyl groups in 201-203 prevent the free rotation of the aryl groups around the boron center and, as a consequence, the environment around the boron center in each compound is chiral. Since the nitrogens of compounds 201-203 are bonded to two different substituents, phenyl and 1-naphthyl, which can have two different orientations, structural isomers of these compounds may co-exist in the solid state. In solution, the free rotation around the biphenyl C—C bond will of course interconvert these two isomers rapidly.

NMR studies indicate that the enantiomers of compound 201 undergo relatively slow interconversion in solution at ambient temperature. The behavior of 201 in solution is in sharp contrast to that of BNPB, where the two ortho methyl chemical shifts are indistinguishable at temperatures above 213 K. Compounds 202 and 203 are believed to have a similar rotation barrier as that in 201 since they have the same number of ortho methyl groups around the boron center as 201 does, although the ortho methyl groups in 202 and 203 are indistinguishable in ¹H NMR spectra due to the presence of the C₃ symmetry.

Compounds 201-203 are soluble in common organic solvents. Like BNPB, they readily form clear and transparent films on a substrate when cast from solution.

### Example 17

### Electronic and Luminescent Properties of Compounds 201-203

The electrochemical properties of compounds 201-203 were investigated by cyclic voltammetry. All three compounds displays a reversible oxidation peak in CH₂Cl₂ at 0.96 V, 1.00 V, and 0.96 V, respectively (versus AgCl/Ag). For NPB under the same experimental conditions, two reversible oxidation peaks at 0.75 V and 1.05 V were observed, which can be attributed to the sequential oxidation of the two amino centers in NPB. The oxidation potentials of the boron compounds 201-203 are higher than the first oxidation potential of NPB, but close to the second oxidation potential of NPB. They are also similar to that of BNPB. For compound 201, only one amino center is present. Therefore, it is not surprising to observe only one oxidation wave. However, for compounds 202 and 203, there are three amino centers in the molecule. If any electronic communication were present between the three amino centers in compounds 202 and 203, more than one oxidation wave would be observed. The fact that only one oxidation wave was observed for compounds 202 and 203 indicates that the three (1-naphthyl)phenylamino centers behave as three independent units. Compounds 201-203 have several intense absorption bands in the UV region (Table 2), which show little dependence on solvents. The low energy absorption band at −340 nm is attributed to charge transfer transition between the amino group and the boron center. This charge transfer absorption band is about 35 nm blue shifted, compared to that of BNPB. Using absorption edge, the optical bandgap of compounds 201-203 was estimated to be 3.18 eV, 3.18 eV and 3.13 eV, respectively, which is considerably bigger than that of BNPB (2.90 eV). The relatively large bandgap of compounds 201-203 is consistent with the diminished π conjugation between the aminoaryl group and the boron center due to the presence of the duryl group, which is absent in BNPB. The HOMO energy of compounds 201-203 was obtained by using the oxidation potential and the LUMO energy was obtained by using the HOMO energy and the optical bandgap. As shown in Table 3, the HOMO level of compounds 201-203 is similar to that of BNPB, but the LUMO level is much above that of BNPB.

Upon excitation by UV light, compounds 201-203 emit a blue color in the solid state with λₘₐₓ at −425 nm which is about 25 nm blue shifted compared to that of BNPB. In solution, for a given solvent, the emission maximum of 201-203 is also considerably blue-shifted, compared to BNPB. The emission energy blue shift of 201-203 in comparison to BNPB is consistent with their relative large bandgap. Like BNPB, the emission band of 201-203 is strongly solvent-dependent and shifts toward a longer wavelength with increasing polarity of the solvents. For example, in toluene, the emission λₘₐₓ of 201 is 424 nm, while in CH₂Cl₂ and CH₃CN, the emission λₘₐₓ become 445 nm and 452 nm, respectively (see FIG. 32). This solvent-dependent emission is consistent with the presence of a highly polarized excited state. However, the magnitude of the red shift of emission energy with increasing solvent polarity displayed by 201 is much less than that of BNPB (see FIG. 4) (λₑₘ=442 nm in toluene, 492 nm in CH₂Cl₂, 512 nm in CH₃CN), an indication that 201 is much less polarized than BNPB at the excited state, which can be attributed to the diminished conjugation between the aminoaryl group and the boron center.

One striking difference between BNPB and compounds 201-203 is the emission quantum efficiency. BNPB is a very bright emitter in solution (+=0.67 in CH₂Cl₂, using 9,10-diphenylanthracene as the standard) and in the solid state (φ=0.31). In contrast, the photoluminescent efficiency of 201-203 in CH₂Cl₂ is 0.22, 0.27 and 0.23, respectively, determined by using 9,10-diphenylanthracene as the standard. Again, the decreased conjugation between the aminoaryl group and the boron center caused by the duryl group in 201-203 may be responsible for the low quantum efficiency. The relatively low quantum efficiency of 201-203 is an indication that they may not be as effective emitters as BNPB in EL devices.

### Example 18

### Fabrication of Electroluminescent Devices of Compounds 201-203

EL devices of compounds 201-203 were fabricated using a K. J. Lesker OLED duster tool with six high vacuum process chambers. For the current experiments, 2″×2″ ITO coated glass substrates were used. The patterned ITO surface was sequentially cleaned in acetone, methanol, de-ionized water, and UV ozone treatment. All the testing devices had an active area of 2×1 mm². The base pressures of the organic and metallization chambers were 5.9×10⁻⁹ Torr and 3.9×10⁻⁸ Torr, respectively. The pressure during the deposition process in the two chambers was lower than 7.0×10⁻⁷ Torr. The growth rate was −2 Å/s for organic materials, 0.1 Å/s for LiF, and −1.5 Å/s for metals (Al and Ag). Luminance-current density-voltage (L-J-V) characteristics for the devices of compounds 201-203 were determined in ambient atmosphere using a Hewlett-Packard 4140B pA meter and a Minolta LS-110 meter. The dwell time for each testing point was 2 seconds. Electroluminescence (EL) spectra were recorded using an USB2000-UV-VIS Miniature Fiber Optic Spectrometer.

### Example 19

### Electroluminescent Properties of Compounds 201-203

To evaluate the potential use of compounds 201-203 in EL devices, three series of EL devices were fabricated by vacuum deposition. The EL devices of series I allowed for the evaluation of compounds 201-203 as bifunctional emitters/electron transport materials. The EL devices of series 11 allowed for the evaluation of compounds 201-203 as hole transport materials. The EL devices of series III allowed for the evaluation of compounds 202-203 as hole injection materials.

EL device series 1. To evaluate compounds 201-203 as bifunctional emitters/electron transport materials, three types of EL devices were fabricated. The first type were single-layer devices with the structure of ITO/boron compound (100 nm)/LiF (1 nm)/Al (120 nm). The second type were double-layer devices with the structure of ITO/NPB (60 nm)/boron compound (40 nm)/LiF (1 nm)/Al (120 nm) where the boron compounds were bifunctional emitters/electron transport layers. Either no EL or very weak EL (less than 10 cd/m²) was observed for the first type of device for all three compounds. Although EL was detected from the second type of devices, the emission was very weak for all three compounds. The third type were triple-layer devices with the structure of ITO/NPB (60 nm)/boron compound (60 nm)/Alq₃ (45 nm)/LiF (1 nm)/Al (120 nm). The inclusion of the Alq₃ layer was intended to lower the electron injection barrier. However, all three triple-layer devices produced green EL that is characteristic of Alq₃ emission.

EL device series II. To evaluate compounds 201-203 as hole transport materials, four double-layer devices of boron compounds 201-203 and NPB were fabricated, namely devices L, M, N, and P, respectively. The device structures for devices L, M, and N, were ITO/boron compound (60 nm)/Alq₃ (40 nm)/LiF(1 nm)/Al (120 nm) and the device structure for device P was ITO/NPB (60 nm)/Alq₃ (40 nm)/LiF(1 nm)/Al (120 nm). In these devices, the boron compound or NPB is the hole transport layer and Alq₃ is the emitter and the electron transport layer. Device performance was quantified and the results are shown in Table 1B. Devices L, M, N, and P produced a bright green color that is characteristic of the emission of Alq₃. However, the brightness and current efficiency of the four devices varied. As shown by the Luminance-Voltage characteristics in FIG. 33, at a given voltage, the NPB device P had the highest brightness. To achieve a given brightness, the operating voltage of devices L, M, and N was higher than the NPB device P. Among the three devices of the boron compounds, the performance of device N where compound 203 was used as the hole transport layer, was the best. These results indicate that compounds 201 and 203 can function as effective hole transporting materials in EL devices. Although the operating voltage of device N was higher than that of P, compound 203 is a promising candidate as a hole transport material because its T_{g} is about 80° C. higher than that of NPB; hence its use may improve the long term stability of an EL device.

EL device series III. To evaluate compounds 202 and 203 as hole injection materials, three triple-layer devices were fabricated. Compound 201 was not evaluated for its use as a hole injection material due to its relatively low T_{g}. To compare the results of compounds 202 and 203, a device was made using CuPc. The device structures of devices Q and R for compounds 202 and 203, respectively, were ITO/boron compound (25 nm)/NPB (45 nm)/Alq₃ (40 nm)/LiF (1 nm)/Al (150 nm). The device structure of device S for CuPc was ITO/CuPc (25 nm)/NPB (45 nm)/Alq₃ (40 nm)/LiF (1 nm)/Al (150 nm). In these devices, the boron compound or CuPc was the hole injection layer. Devices Q, R, and S all produced a bright green color, characteristic of Alq₃. The Luminance-Voltage and Current efficiency—Luminance characteristics for these devices are shown in FIGS. 35 and 36. Among the boron devices, the performance of device R where 203 was used as the hole injection layer was the best. For a given brightness, the operating voltage of device R was about 2 V higher than that of S. However, as shown in FIG. 36, the Current efficiency of device R was much higher than that of S. Device Q where 202 was the hole injection layer had the highest current efficiency, but its operating voltage was higher than devices R and S. The EL data indicate that compound 203 is very promising as a hole injection material in EL devices. The fact that 203 is transparent in the visible region makes it an attractive replacement for the highly colored, albeit very effective, hole injection material CuPc. Among compounds 201-203, compound 203 is the most promising hole transport material or hole injection material for applications in EL devices. The main advantage of 203 is its high T_{g} and its high transparency in the visible spectrum.

All scientific and patent publications cited herein are hereby incorporated in their entirety by reference. Although this invention is described in detail with reference to preferred embodiments thereof, these embodiments are offered to illustrate but not to limit the invention. It is possible to make other embodiments that employ the principles of the invention and that fall within its spirit and scope as defined by the claims appended hereto.

### REFERENCES

Belfield, K. D.; Schafer, K. J.; Mourad, W.; Reinhardt, B. A. “Synthesis of new two-photon absorbing fluorene derivatives via Cu-mediated Ullmann condensations.” J. Org. Chem. (2000) 65(15): 4475-4481.
Chen, C. H.; Shi, J. “Metal Chelates as Emitting Materials for Organic Electroluminescence.” Coord. Chem. Rev. (1998) 171: 161-174.
Doi, H.; Kinoshita, M.; Okumoto, K.; Shirota, Y. uA Novel Class of Emitting Amorphous Molecular Materials with Bipolar Character for Electroluminescence.” Chem. Mater. (2003) 15(5): 1080-1089.
Fanta, P. E. “Ullmann Synthesis of Biaryls”. Synthesis (1974) 1: 9-21.
Goodbrand, H. B.; Hu, N. X. “Ligand Accelerated Catalysis of the Ullmann Condensation: Application to Hole Conducting Triarylamines”. Journal of Organic Chemistry (1999) 64: 670-674.
Huheey, J. E. “Inorganic Chemistry Principles of Structure and Reactivity, 2nd ed.” Harper & Row, New York (1978).
Jia, W.-L.; Bai, D.-R.; McCormick, T.; Liu, Q.-D.; Motala, M.; Wang, R.-Y.; Seward, C.; Tao, Y.; Wang, S. “Three-Coordinate Organoboron Compounds BAr₂R (Ar=mesityl, R=7 azaindolyl- or 2,2′-dipyridylamino-functionalized aryl or thienyl) for Electroluminescent Devices and Supramolecular Assembly.” Chem. Euro. J. (2004) 10(4): 994-1006.
Jia, W.-L.; Datong, S.; Wang, S. “Blue Luminescent Three-Coordinate Organoboron Compounds with 2,2′-Dipyridylamino Functional Group.” Journal of Organic Chemistry (2003) 68: 701-705.
Kang, Y.; Wang, S. “Syntheses and Photophysical Properties of Rigid-rod Conjugated Compounds Based on N-7-Azaindole and 2,2′-dipyridylamine”. Tetrahedron Letters (2002) 43: 3711-3713.
Kang, Y.; Song, D.; Schmider, H.; Wang, S. “Novel Blue Phosphorescent Group 15 Compounds MR3 (M=P, Sb, Bi; R=p-(N-7-Azaindolyl)phenyl)”. Organometallics (2002) 21: 2413-2421.
Kinoshita, M.; Kita, H.; Shirota, Y. “A Novel Family of Boron-Containing Hole-Blocking Amorphous Molecular Materials for Blue- and Blue-Violet-Emitting Organic Electroluminescent Devices.” Adv. Funct Mater. (2002) 12 (11-12): 780-786.
Koene, B.; Loy, D.; Thompson, M. “Unsymmetrical Triaryldiamines as Thermally Stable Hole Transporting Layers for Organic Light-Emitting Devices.” Chemistry of Materials. (1998) 10(8): 2235-2250.
Lee, R. H.; Yeh, H. C.; Chan, L. H.; Chen, C. T. “Optimization of Tetraphenylsilane-Based Blue Organic Light-Emitting Devices with Copper Phthalocyanine,” Synthetic Metals, (2003) 137: 1035.
Leung, L. M.; Lo, W. Y.; So, S. K.; Lee, K. M.; and Choi, W. K. J. “A High-Efficiency Blue Emitter for Small Molecule-Based Organic Light-Emitting Diode.” J. Am. Chem. Soc. (2000) 122: 5640-5641.
Lindley, J. “Copper-assisted Nucleophilic Substitution of Aryl Halogen”. Tetrahedron (1984) 40:1433-1456.
Liu, S.; Wu, Q.; Schmider, H. L.; Aziz, H.; Hu, N.; Popovic, Z.; Wang, S. “Syntheses, Structures, and Electroluminescence of New Blue/Green Luminescent Chelate Compounds: Zn(2-py-in)₂(THF), BPh₂(2-py-in), Be(2-py-in)₂, and BPh₂(2-py-aza), 2-py-in =2-(2-pyridyl)indole, 2-py-aza=2-(2-pyridyl)-7-azaindole.” J. Am. Chem. Soc. (2000) 122: 3671-3678.
Matsuura, M.; Yamada, T.; Kinoshita, M.; Kita, H. “Organic Electroluminescence Element and Display.” U.S. Patent Application Publication No. U.S. 2003/0157366, published Aug. 21, 2003.
Mori, T.; Mitsuoka, T.; Ishii, M.; Fujikawa, H.; Taga, Y. “Improving the Thermal Stability of Organic Light-Emitting Diodes by Using a Modified Phthalocyanine Layer,” Applied Physics Letters (2002) 80: 3895.
Noda, T.; Shirota, Y. “5,5′-Bis(dimesitylboryl)-2,2′-bithiophene and 5,5″-Bis(dimesitylboryl)-2,2′:5′,2″-terthiophene as a Novel Family of Electron-Transporting Amorphous Molecular Materials.” J. Am. Chem. Soc. (1998) 120(37): 9714-9175.
Noda, T.; Ogawa, H.; Shirota, Y. “A Blue-Emiting Organic Electroluminescent Device Using a Novel Emitting Amorphous Molecular Material, 5,5′-bis(dimesitylboryl)-2,2′-bithiophene.” Adv. Mater. (1999) 11(4): 283-285.
Noda, T.; Shirota, Y. “A Blue-Emitting Organic Electroluminescent Device Using a Novel Emitting Amorphous Molecular Material.” J. Lumin. (2000) 87-89: 1168-1170.
Paine, A. J. “Mechanisms and Models for Copper Mediated Nucleophilic Aromatic Substitution. 2. Single Catalytic Species from Three Different Oxidation States of Copper in an Ullmann Synthesis of Triarylamines.” J. Am. Chem. Soc. (1987) 109:1496-1506.
Pang, J.; Marcotte, E. J.-P.; Seward, C.; Brown, R. S.; Wang, S. “A Blue Luminescent Star-Shaped Zn^{II} Complex that can Detect Benzene.” Angew. Chem. Int. Ed. (2001) 40: 4021-4042.
Rack, P. D.; Naman, A.; Holloway, P. H.; Sun, S.-S.; Tuenge, R. T. “Materials Used in Electroluminescent Displays.” MRS Bulletin (1996) 21(3): 49-58.
Rothberg, L. J.; Lovinger, A. J. “Status of and Prospects for Organic Electroluminescence.” J. Mater. Res. (1996) 11: 3174.
Shirota, Y. “Organic Materials for Electronic and Optoelectronic Devices.” Journal of Materials Chemistry. (2000) 10(1): 1-25.
Ueda, N., “Organic Electroluminescence Element.” Japanese Patent Application No. 01093670, published 2001-04-06.
Tang, C. W.; Van Slyke, S. A. “Organic Electroluminescent Diodes.” Applied Physics Letters (1987) 51(12): 913-915.
Thompson, M. E.; Burrows, P. E.; Forrest, S. R. “Optoelectronic Properties of Inorganic Compounds.” Roundhill, D. M. Fackler, Jr. J. P. ed., chapter 6, Plenum Press: New York, 1999.
Tsutsui, T. “Progress in Electroluminescent Devices Using Molecular Thin Films.” Mater. Res. Soc. Bull, (1997) 39.
Wang, S.; Liu, A.; Hassan, A. “Luminescent Compounds and Methods of Making and Using Same.” U.S. Pat. No. 6,312,835, issued Nov. 6, 2001.
Wang, S.; Liu, A.; Hassan, A. “Luminescent Compounds and Methods of Making and Using Same.” U.S. Pat. No. 6,500,569, issued Dec. 31, 2002.
Wu, Q.; Lavigne, J. A.; Tao, Y.; D'lorio, M.; Wang, S. “Novel Blue Luminescent/Electroluminescent 7-Azaindole Derivatives: 1,3-Di(N-7-azaindolyl)benzene, 1-Bromo-3,5-Di(N-7-azaindolyl)benzene, 1,3,5-Tri(N-7-azaindolyl)benzene, and 4,4′-Di(N-7-azaindolyl)biphenyl.” Chemistry of Materials (2001) 13(1): 71-77.
Yamaguchi, S.; Shirasaka, T.; Tamao, K. “Tridurylboranes Extended by Three Arylethynyl Groups as a New Family of Boron-Based n-Electron Systems.”, Org. Lett. (2000) 2(26): 4129-4132.

Yang, W.; Chen, L.; Wang, S. “Syntheses, Structures, and Luminescence of Novel Lanthanide Complexes of Tripyridylamine, N,N,N′,N′-Tetra(2-pyridyl)-1,4-phenylenediamine, and N,N,N′,N′-Tetra(2-pyridyl)-biphenyl-4,4′-diamine.” Inorganic Chemistry (2001) 40: 507-515.

TABLE 1A
Data of Electroluminescent Devices

| | Turn-on | EL | Max. | |
|---|---|---|---|---|
| | Voltage | (λmax) | Luminance | Efficiency (Cd/A) |
| Device structure | (V) | nm | (Cd/m²) | at ˜ 300 Cd/m² |
| A: ITO/BNPB (90 nm)/LiF/Al | 6.2 | 453 | 16 at 8 V | |
| B: ITO/NPB (60 nm)/BNPB (90 nm) | 7.4 | 453 | 840 at 12 V | 0.52 at 332 Cd/m² |
| /Ag | | | | |
| C: ITO/BNPB (60 nm)/Alq₃ (45 nm)/ | 6.2 | 536 | 500 at 8 V | 1.6 at 355 Cd/m² |
| LiF/Al | | | | |
| D: ITO/NPB (60 nm)/BNPB (60 nm)/ | 5.8 | 490 | 5053 at 12 V | 5.1 at 352 Cd/m² |
| Alq₃ (45 nm)/LiF/Al | | | | |
| 1: ITO/NPB (40 nm)/102 (40 nm)/ | 5 | 436 | 2566 at 17 V | 1.96 at 322 Cd/m² |
| LiF (2 nm)/Al | | | | |
| 2: ITO/NPB (40 nm)/Bicarbazole (20 | 6 | 436 | 388 at 21 V | 0.18 at 305 Cd/m² |
| nm)/102 (40 nm)/LiF (1 nm)/Al | | | | |
| 3: ITO/NPB (40 nm)/Bicarbazole (20 | 7 | 436 | 208 at 21 V | 0.29 at 207 Cd/m² |
| nm)/102 (40 nm)/PBD (20 mn)/LiF | | | | |
| (1 nm)/Al | | | | |
| 4: ITO/NPB (40 nm)/Bicarbazole (20 | 7 | 460 | 1510 at 24 V | 0.80 at 329 Cd/m² |
| mn)/108 (40 nm)/LiF (1 nm)/Al | | | | |

TABLE 1B
Data of Electroluminescent Devices

| | Luminance | Current |
|---|---|---|
| | at 7 V, | efficiency |
| Device structure | cd/m² | (CD/A) at 7 V |
| L ITO/201 (60 nm)/Alq₃ (40 nm)/ | 698 | 2.77 |
| LiF (1 nm)/Al (120 nm) | | |
| M ITO/202 (60 nm)/Alq₃ (40 nm)/ | 36 | 2.48 |
| LiF (1 nm)/Al (120 nm) | | |
| N ITO/203 (60 nm)/Alq₃ (40 nm)/ | 961 | 3.48 |
| LiF (1 nm)/Al (120 nm) | | |
| P ITO/NPB (60 nm)/Alq₃ (40 nm)/ | 9913 | 4.21 |
| LiF (1 nm)/Al (120 nm) | | |
| Q ITO/202 (25 nm)/NPB (45 nm)/Alq₃ | 20 | 3.69 |
| (40 nm)/LiF (1 nm)/Al (150 nm) | | |
| R ITO/203 (25 nm)/NPB (45 nm)/Alq₃ | 210 | 2.48 |
| (40 nm)/LiF (1 nm)/Al (150 nm) | | |
| S ITO/CuPc (25 nm)/NPB (45 nm)/Alq₃ | 5130 | 1.83 |
| (40 nm)//LiF (1 nm)/Al (150 nm) | | |

TABLE 2
Absorption and Luminescence Data

| | | Excitation | | | |
|---|---|---|---|---|---|
| | UV-Vis absorption (nm) | wavelength | Emission λₘₐₓ | Quantum | Conditions |
| Cmpd | (ε,M⁻¹cm⁻¹)^{a} | (nm) | (nm) | yields (Φ)^{b} | 298 K |
| BNPB | 278 (18524), 380 (25420) | 377 | 451 | 95 | CH₂Cl₂ |
| 101 | 230 (19720), 250 (11760), | 360 | 411 | 99 | CH₂Cl₂ |
| | 320 (12540), 362 (23850) | 384 | 417 | | Solid |
| 102 | 232 (48250), 270 (35660), | 351 | 449 | 63 | CH₂Cl₂ |
| | 336 (40330) | 354 | 440 | | Solid |
| 103 | 230 (22630), 286 (7750), | 338 | 381 | 21 | CH₂Cl₂ |
| | 336 (17670) | 348 | 398 | | Solid |
| 104 | 230 (38621), 256 (17230), | 357 | 413 | 66 | CH₂Cl₂ |
| | 338 (49230) | 349 | 463 | | Solid |
| 105 | 230 (65650), 266 (53630), | 345 | 448 | 17 | CH₂Cl₂ |
| | 302 (64990) | 320 | 449 | | Solid |
| 106 | 230 (75990), 258 (90420), | 345 | 410 | 11 | CH₂Cl₂ |
| | 298 (23630), 336 (23480) | 348 | 418(sh), 456 | | Solid |
| 107 | 304 (very broad, 64102) | 355 | 456 | 6 | CH₂Cl₂ |
| | | 359 | 433 | | Solid |
| 108 | 230 (40720), 310 (20090), | 381 | 465 | 100 | CH₂Cl₂ |
| | 382 (44490) | 418 | 469 | | Solid |
| 201 | 230 (98735), 332 (53175) | 337 | 445 | 22 | CH₂Cl₂ |
| | | 354 | 426 | | Solid/film |
| 202 | 232 (162832), 264 | 339 | 439 | 27 | CH₂Cl₂ |
| | (53709), 304 (68834), 340 | 377 | 421 | | Solid/film |
| | (49269) | | | | |
| 203 | 230 (140177), 260 | 348 | 442 | 23 | CH₂Cl₂ |
| | (44545), 336 (85809) | 388 | 426 | | Solid/film |

^{a}All data were collected for CH₂Cl₂ solution ([M] = 1.0 × 10⁻⁵ − 1.0 × 10⁻⁶) at ambient temperature.
^{b}Relative to 9,10-diphenylanthracene in CH₂Cl₂ at ambient temperature.
^{c}sh = shoulder

TABLE 3
HOMO and LUMO Energy levels

| | HOMO | LUMO | Optical Band |
|---|---|---|---|
| Compound | (eV) | (eV) | gap (eV) |
| BNPB | −5.3 | −2.4 | 2.9 |
| 101 | −5.7 | −2.5 | 3.2 |
| 102 | −5.7 | −2.5 | 3.2 |
| 103 | −6.1 | −2.7 | 3.4 |
| 104 | −5.8 | −2.5 | 3.3 |
| 105 | −5.5 | −2.1 | 3.4 |
| 106 | −6.0 | −2.6 | 3.4 |
| 107 | −5.8 | −2.6 | 3.2 |
| 108 | −5.5 | −2.6 | 2.9 |
| 201 | −5.26 | −2.13 | 3.13 |
| 202 | −5.30 | −2.13 | 3.17 |
| 203 | −5.26 | −2.13 | 3.13 |

1-126. (canceled)

127. A compound having a general formula (1A): 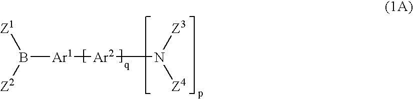
where
p is 1, 2, 3, 4 or 5;
q is 0, 1, 2, 3, 4 or 5;
Ar¹, Ar², Z¹, Z², Z³ and Z⁴ are each independently a substituted or unsubstituted aryl moiety selected from the group consisting of phenyl, biphenyl, naphthyl, anthryl, phenanthryl, pyrenyl, pyridyl, bipyridyl, xylyl, mesityl, duryl, indolyl, thienyl, and quinolinyl such that at least three of the six ortho positions relative to the boron-aryl bonds bear a non-hydrogen substituent and such that (i) Z³ and Z⁴ are not identical or (ii) at least one of Z³ and Z⁴ is heteroaromatic;
wherein a substituent of Ar¹, Z¹ or Z² is selected from the group consisting of an aryl group, F, NR₂, a nitrile group, —CF₃, OR, and R, where R is a substituted or unsubstituted aliphatic group having 1-24 carbon atoms which may be straight, branched or cyclic; and
wherein a substituent of Z³, Z⁴ or Ar² is selected from the group consisting of an aryl group, a hydroxy group, nitro, amino, NR₂, OR, a nitrile group, —CF₃ and R, where R is a substituted or unsubstituted aliphatic group having 1-24 carbon atoms which may be straight, branched or cyclic.

128. A compound having a general formula (1B): 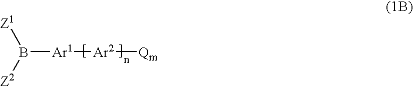
where
n is 0, 1, 2, 3, 4 or 5;
m is 1, 2, 3, 4 or 5;
Ar¹, Ar², Z¹ and Z² are each independently a substituted or unsubstituted aryl moiety selected from the group consisting of phenyl, biphenyl, naphthyl, anthryl, phenanthryl, pyrenyl, pyridyl, bipyridyl, xylyl, mesityl, duryl, indolyl, thienyl, and quinolinyl such that at least three of the six ortho positions relative to the boron-aryl bonds bear a non-hydrogen substituent;
Q is a substituted or unsubstituted heteroaryl moiety selected from the group consisting of pyridyl, quinolinyl, indolyl, 7-azaindolyl (“azain”) and benzimidazolyl such that Q does not have a two-fold axis of symmetry along the Q-Ar² bond and the atom of Q that is bonded to Ar² is a heteroatom;
wherein a substituent of Ar¹, Z¹ or Z² is selected from the group consisting of an aryl group, F, NR₂, a nitrile group, —CF₃, OR, and R, where R is a substituted or unsubstituted aliphatic group having 1-24 carbon atoms which may be straight, branched or cyclic; and
wherein a substituent of Q is selected from the group consisting of an aryl group, a hydroxy group, nitro, halo, amino, NR₂, OR, a nitrile group, —CF₃ and R, where R is a substituted or unsubstituted aliphatic group having 1-24 carbon atoms which may be straight, branched or cyclic.

129. A compound having a general formula (1C): 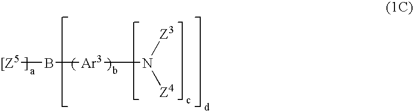
where
a is 0, 1 or 2;
b is 1, 2, 3, 4, 5 or 6;
c is 1, 2, 3, 4 or 5;
d is 1, 2 or 3;
wherein the sum of a plus d equals three;
wherein when a is 0, Z³ does not equal Z⁴;
Ar¹, Z³, Z⁴ and Z⁵ are each independently a substituted or unsubstituted aryl moiety selected from the group consisting of phenyl, biphenyl, naphthyl, anthryl, phenanthryl, pyrenyl, pyridyl, bipyridyl, xylyl, mesityl, duryl, indolyl, thienyl, and quinolinyl such that at least three of the six ortho positions relative to the boron-aryl bonds bear a non-hydrogen substituent and such that (i) Z³ and Z⁴ are not identical or (ii) at least one of Z³ and Z⁴ is heteroaromatic;
wherein a substituent of Ar³ or Z⁵ is selected from the group consisting of an aryl group, F, NR₂, a nitrile group, —CF₃, OR, and R, where R is a substituted or unsubstituted aliphatic group having 1-24 carbon atoms which may be straight, branched or cyclic; and
wherein a substituent of Z³ or Z⁴ is selected from the group consisting of an aryl group, a hydroxy group, nitro, halo, amino, NR₂, OR, a nitrile group, —CF₃ and R, where R is a substituted or unsubstituted aliphatic group having 1-24 carbon atoms which may be straight, branched or cyclic.

130. A compound having a general formula (1D): 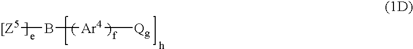
where
e is 0, 1 or 2;
f is 1, 2, 3, 4, 5 or 6;
g is 1, 2, 3, 4 or 5;
h is 1, 2 or 3;
Ar¹ and Z⁵ are each independently a substituted or unsubstituted aryl moiety selected from the group consisting of phenyl, biphenyl, naphthyl, anthryl, phenanthryl, pyrenyl, pyridyl, bipyridyl, xylyl, mesityl, duryl, indolyl, thienyl, and quinolinyl such that at least three of the six ortho positions relative to the boron-aryl bonds bear a non-hydrogen substituent; and
Q is a substituted or unsubstituted heteroaryl moiety selected from the group consisting of pyridyl, quinolinyl, indolyl, 7-azaindolyl and benzimidazolyl such that Q does not have a two-fold axis of symmetry along the Q-Ar⁴ bond and the atom of Q that is bonded to Ar⁴ is a heteroatom;
wherein the sum of e and h equals three;
wherein a substituent of Ar⁴ or Z⁵ is selected from the group consisting of an aryl group, F, NR₂, a nitrile group, —CF₃, OR, and R, where R is a substituted or unsubstituted aliphatic group having 1-24 carbon atoms which may be straight, branched or cyclic; and
wherein a substituent of Q is selected from the group consisting of an aryl group, a hydroxy group, nitro, halo, amino, NR₂, OR, a nitrile group, —CF₃ and R, where R is a substituted or unsubstituted aliphatic group having 1-24 carbon atoms which may be straight, branched or cyclic.

131. A compound having a general formula (1E): 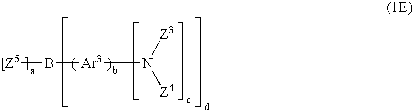
where
a is 0, 1 or 2;
b is 1, 2, 3, 4, 5 or 6;
c is 1, 2, 3, 4 or 5;
d is 1, 2 or 3;
wherein the sum of a plus d equals three;
Ar³, Z³, Z⁴ and Z⁵ are each independently a substituted or unsubstituted aryl moiety selected from the group consisting of phenyl, biphenyl, naphthyl, anthryl, phenanthryl, pyrenyl, xylyl, mesityl, duryl, indolyl, thienyl, and quinolinyl such that at least three of the six ortho positions relative to the boron-aryl bonds bear a non-hydrogen substituent and such that in at least one instance (i) Z³ and Z⁴ are not identical or (ii) at least one of Z³ and Z⁴ is heteroaromatic;
wherein a substituent of Ar³ or Z⁵ is selected from the group consisting of an aryl group, F, NR₂, a nitrile group, —CF₃, OR, and R, where R is a substituted or unsubstituted aliphatic group having 1-24 carbon atoms which may be straight, branched or cyclic; and
wherein a substituent of Z³ or Z⁴ is selected from the group consisting of an aryl group, a hydroxy group, nitro, halo, amino, NR₂, OR, a nitrile group, —CF₃ and R, where R is a substituted or unsubstituted aliphatic group having 1-24 carbon atoms which may be straight, branched or cyclic.

132. p-(1-naphthylphenylamino)-4,4′-biphenyldimesitylborane (BNPB).

133. The compound of claim 127, wherein the at least three of the six ortho positions is four of the six ortho positions.

134. The compound of claim 128, wherein the at least three of the six ortho positions is four of the six ortho positions.

135. The compound of claim 129, wherein the at least three of the six ortho positions is four of the six ortho positions.

136. The compound of claim 130, wherein the at least three of the six ortho positions is four of the six ortho positions.

137. The compound of claim 131, wherein the at least three of the six ortho positions is four of the six ortho positions.

138. A compound having a formula selected from the group consisting of:
p-(2,2′-dipyridylamino)phenyldimesitylborane (101);
p-(2,2′-dipyridylamino)biphenyldimesitylborane (102);
p-(7-azaindolyl)phenyldimesitylborane (103);
p-(7-azaindolyl)biphenyldimesitylborane (104);
3,5-bis(2,2′-dipyridylamino)phenyldimesitylborane (105);
3,5-bis(7-azaindolyl)phenyldimesitylborane (106);
p-[3,5-bis(2,2′-dipyridylamino)phenyl]phenyldimesitylborane (107);
5-[p-(2,2′-dipyridylamino)phenyl]-2-thienyidimesitylborane (108);
4-(1-naphthylphenylamino)-4′-biphenylduryldimesitylborane (201);
Tris[p-(1-naphthylphenylamino)phenylduryl]borane (202); and
Tris[p-(1-naphthylphenylamino)biphenylduryl]borane (203).

139. A photoluminescent product or an electroluminescent product comprising a compound as claimed in claim 127.

140. A photoluminescent product or an electroluminescent product comprising a compound as claimed in claim 128.

141. A photoluminescent product or an electroluminescent product comprising a compound as claimed in claim 129.

142. A photoluminescent product or an electroluminescent product comprising a compound as claimed in claim 130.

143. A photoluminescent product or an electroluminescent product comprising a compound as claimed in claim 131.

144. A photoluminescent product or an electroluminescent product comprising a compound as claimed in claim 132.

145. A photoluminescent product or an electroluminescent product comprising a compound as claimed in claim 138.

146. A method of synthesizing a compound as claimed in claim 132, comprising a step selected from the group consisting of:
4,4′-diodobiphenyl+1-naphthylphenylamine→4-iodo-4′-(1-naphthylphenylamino)biphenyl; and
4-iodo-4′-(1-naphthylphenylamino)biphenyl+n-BuLi+dimesitylboron fluoride→BNPB.

147. A method of producing electroluminescence, comprising the steps of:
providing a compound as claimed in claim 127, and applying a voltage across said compound so that said compound electroluminesces.

148. A method of producing electroluminescence, comprising the steps of:
providing a compound as claimed in claim 128, and applying a voltage across said compound so that said compound electroluminesces.

149. A method of producing electroluminescence, comprising the steps of:
providing a compound as claimed in claim 129, and applying a voltage across said compound so that said compound electroluminesces.

150. A method of producing electroluminescence, comprising the steps of:
providing a compound as claimed in claim 130, and applying a voltage across said compound so that said compound electroluminesces.

151. A method of producing electroluminescence, comprising the steps of:
providing a compound as claimed in claim 131, and applying a voltage across said compound so that said compound electroluminesces.

152. A method of producing electroluminescence, comprising the steps of:
providing a compound as claimed in claim 132, and applying a voltage across said compound so that said compound electroluminesces.

153. A method of producing electroluminescence, comprising the steps of:
providing a compound as claimed in claim 138, and applying a voltage across said compound so that said compound electroluminesces.

154. Use of the compound of claim 127 in an electroluminescent device as one or more of the following: emitter, spacer, hole injector, electron injector, hole transporter, and electron transporter.

155. Use of the compound of claim 128 in an electroluminescent device as one or more of the following: emitter, spacer, hole injector, electron injector, hole transporter, and electron transporter.

156. Use of the compound of claim 129 in an electroluminescent device as one or more of the following: emitter, spacer, hole injector, electron injector, hole transporter, and electron transporter.

157. Use of the compound of claim 130 in an electroluminescent device as one or more of the following: emitter, spacer, hole injector, electron injector, hole transporter, and electron transporter.

158. Use of the compound of claim 131 in an electroluminescent device as one or more of the following: emitter, spacer, hole injector, electron injector, hole transporter, and electron transporter.

159. Use of the compound of claim 132 in an electroluminescent device as one or more of the following: emitter, spacer, hole injector, electron injector, hole transporter, and electron transporter.

160. Use of the compound of claim 138 in an electroluminescent device as one or more of the following: emitter, spacer, hole injector, electron injector, hole transporter, and electron transporter.
